(19) United States
(12) Patent Application Publication
(10) Pub. No.: US 2011/0284118 A1
(43) Pub. Date: Nov. 24, 2011

(54) COIL BINDING APPARATUS

(75) Inventors: Kazuhiko KISHI, Tokyo (JP); Kazuya IGATA, Tokyo (JP)

(73) Assignee: MAX CO., LTD., Tokyo (JP)

(21) Appl. No.: 13/111,207

(22) Filed: May 19, 2011

(30) Foreign Application Priority Data
May 20, 2010 (JP) 2010-116750

(51) Int. Cl. B42B 5/12

(52) U.S. Cl. 140/92.3

(57) ABSTRACT

A coil binding apparatus includes a coil forming mechanism to form a helical coil in different diameters from a wire, a binding mechanism to bind a punched portion of a paper stack with the helical, and a coil introducing mechanism disposed between the coil forming mechanism and the binding mechanism to receive the helical coil drawn out of the coil forming mechanism and to introduce the helical coil to the binding mechanism. The coil introducing mechanism has a center axis shifting unit configured to shift a coil center axis position to a coil rotation axis position. The coil center axis position is a position of a center axis of the helical coil. The coil rotation axis position is a position of a rotation axis of the helical coil when the binding mechanism rotates the helical coil to insert the helical coil into the paper stack.

### CROSS-REFERENCE TO RELATED APPLICATION(S)

The present application claims the benefit of priority of Japanese Patent Application No. 2010-116750, filed on May 20, 2010, the disclosure of which is incorporated herein by reference.

### TECHNICAL FIELD

The present disclosure relates to a coil binding apparatus configured to form a helical coil from a wire and to bind a stack of papers output from copy machines, printers, or the like with the helical coil.

### BACKGROUND

Some copy machines and printers are equipped with finishers which, for example, form punch holes in the copied or printed papers and automatically insert a helical coil into the punch holes of the papers to produce a document.

WO2008/120503A1 discloses a paper processing apparatus related to such binding of a stack of papers using a helical coil. The paper processing apparatus includes a wire feeding unit, a coil forming mechanism to form a helical coil having a desired coil diameter from a wire fed from the wire feeding unit, a binding mechanism to bind a stack of papers with the helical coil, and a cutting unit to cut the helical coil after the binding.

The coil forming mechanism is configured to form a plurality of kinds of helical coils so that a coil diameter can be changed in accordance with the thickness of a stack of papers to be bound. In the coil forming mechanism, in accordance with a change in the coil diameter, a coil center axis position of a helical coil with respect to the bottom side of the helical coil shifts along on a straight line in a direction (a vertical direction) perpendicular to an entrance direction of the wire. The coil center axis position is a position of a center axis of a helical coil drawn out of the coil forming mechanism (see, e.g., FIG. 8A).

### SUMMARY

Illustrative aspects of the present disclosure provide a coil binding apparatus capable of smoothly and consistently insert helical coils of different diameters into punch holes of a paper stack by guiding a coil center axis position of each of the helical coils to a suitable a coil rotation axis position in a binding mechanism. The coil rotation axis position is a position of a rotation axis of the helical coil when the binding mechanism rotates the helical coil to insert the helical coil into the paper stack.

An illustrative aspect of the present disclosure provides a coil binding apparatus including a coil forming mechanism configured to form a helical coil from a wire, a binding mechanism configured to bind a punched portion of a paper stack with the helical coil drawn out of the coil forming mechanism, and a coil introducing mechanism disposed between the coil forming mechanism and the binding mechanism to receive the helical coil drawn out of the coil forming mechanism and to introduce the helical coil to the binding mechanism. The coil introducing mechanism has a center axis shifting unit configured to shift a coil center axis position to a coil rotation axis position.

That is, when the coil introducing mechanism receives a helical coil from the coil forming mechanism and introduces the helical coil to the binding mechanism, the center axis shifting unit of the coil introducing mechanism shifts the coil center axis position of the helical coil to the coil rotation axis position.

Accordingly, the coil introducing mechanism absorbs a positional deviation amount between the coil center axis position of the helical coil drawn out of the coil forming mechanism and the coil rotation axis position of the helical coil in the binding mechanism, without moving one of the coil forming mechanism and the binding mechanism with respect to the other, which may cause a complex structure of the entire apparatus.

### BRIEF DESCRIPTION OF THE DRAWINGS

FIG. 1 is a perspective view of a coil binding apparatus according to an exemplary embodiment of the present disclosure;

FIG. 2 illustrates a process of a binding operation by the coil binding apparatus;

FIG. 3 is a perspective view of a paper stack aligning unit of the coil binding apparatus;

FIG. 4A is a perspective view of a coil forming mechanism of the coil binding apparatus;

FIG. 4B is another perspective view of the coil forming mechanism observed from a different direction;

FIG. 5 is a perspective view illustrating an example of a pitch formation section of the coil forming mechanism;

FIG. 6A is a perspective view of a pitch formation unit of the coil forming mechanism;

FIGS. 6B and 6C are views illustrating operations of the pitch formation unit during coil formation;

FIG. 7A is a view illustrating the coil forming operation;

FIG. 7B is a sectional view taken along the line VII-VII of FIG. 7A;

FIGS. 8A and 8B are diagrams illustrating a relationship between coil diameters of helical coils and insertion positions of the helical coils into a paper stack;

FIG. 9 is a diagram illustrating an example of pitch formation by the pitch formation section;

FIG. 10 is a perspective view of a coil introducing mechanism of the coil binding apparatus;

FIG. 11 is another perspective view of the coil introducing mechanism;

FIG. 12 is a perspective view of the coil introducing mechanism together with its driving source;

FIG. 13 is another perspective view of the coil introducing mechanism and the driving source;

FIG. 14A is a perspective view of a divided structure of a coil accommodating unit,

FIG. 14B is a top view of the divided structure of the coil accommodating unit;

FIG. 15 is a diagram illustrating operations of the coil accommodating units;

FIG. 16 is another diagram illustrating the operations of the coil accommodating units;

FIG. 17 is a perspective view of a coil introducing mechanism according to a first modification;

FIGS. 18A and 18B are front and rear perspective views of a center axis shifting unit of the coil introducing mechanism of FIG. 17;

FIG. 19 is an explanatory view illustrating a function of a guide surface of the center axis shifting unit;

FIGS. 20A and 20B are front and rear perspective views illustrating an operation of the center axis shifting unit;

FIG. 21A is another perspective view illustrating the operation of the center axis shifting unit;

FIG. 21B a side view illustrating the operation of the center axis shifting unit;

FIG. 21C is a front view illustrating the operation of the center axis shifting unit;

FIG. 22 is a perspective view illustrating an example layout of the coil forming mechanism, the coil introducing mechanism and a binding mechanism of the coil binding apparatus;

FIG. 23 is a top view illustrating a coil-fore-end inserting section of the binding mechanism;

FIG. 24A is a side view of the coil-fore-end inserting section;

FIG. 24B is another top view of the coil-fore-end inserting section;

FIG. 25 is a plan view illustrating an example of a position determining function of a metal roller;

FIG. 26 is another plan view illustrating the example of the position determining function of the metal roller;

FIG. 27 is a top view illustrating an example of an operation by the coil-fore-end inserting section;

FIG. 28 is a plan view illustrating a coil-fore-end inserting section according to a second modification;

FIG. 29 is a perspective view illustrating a coil-fore-end inserting section according to a third modification;

FIG. 30 is a conceptual view illustrating the coil-fore-end inserting section as seen from the front side;

FIG. 31 is a plan view illustrating an example of a divided structure of a metal roller 81″;

FIG. 32 is a plan view of the binding mechanism;

FIG. 33A is a perspective view of the binding mechanism, illustrating an example of a driving source of the binding mechanism;

FIG. 33B is another perspective view of the binding mechanism;

FIG. 34 is a perspective view of the binding mechanism in operation;

FIGS. 35A and 35B are diagrams illustrating a coil transferring section according to a fourth modification;

FIGS. 36A and 36B are diagrams illustrating a coil transferring section according to a fifth modification;

FIG. 37A is a perspective view of a paper stack transferring mechanism of the coil binding apparatus;

FIG. 37B is another perspective view of the paper stack transferring mechanism;

FIG. 38 is a front perspective view of an alignment pin mechanism;

FIG. 39 is a rear perspective view of the alignment pin mechanism;

FIG. 40A is a sectional view illustrating a coil inserting example according to the related art as a comparative example;

FIG. 40B is a sectional view illustrating a coil inserting example according to the exemplary embodiment of the present disclosure;

FIG. 41A is a sectional view illustrating an example of clearance of helical coils and punch holes according to the related art;

FIG. 41B is a sectional view illustrating an example of clearance of helical coils and punch holes according to the exemplary embodiment of the present disclosure;

FIG. 42 is a perspective view of an end processing unit of the coil binding apparatus;

FIG. 43A is a perspective view of a dragging unit;

FIG. 43B is a perspective view of another dragging unit;

FIG. 44 is an exploded perspective view illustrating an example of a configuration of an the outlet-side end processing unit and an the inlet-side end processing unit;

FIGS. 45A and 45B are side views illustrating an example of movement of a cutting and bending mechanism along helical coils;

FIGS. 46A and 46B are enlarged views of the insides of circles represented by broken lines in FIGS. 45A and 45B illustrating the example of the movement of the cutting and bending mechanism;

FIGS. 47A and 47B are enlarged views illustrating an example of movement of the cutting and bending mechanism along helical coils;

FIG. 48 is an exploded perspective view illustrating an example of a configuration of the cutting and bending mechanism;

FIGS. 49A to 49D are schematic diagrams illustrating an example of an operation of the cutting and bending mechanism;

FIGS. 50A and 50B are views illustrating a standby state of the cutting and bending mechanism;

FIGS. 51A and 51B are views illustrating a coil maintaining state of the cutting and bending mechanism;

FIGS. 52A and 52B are views illustrating a coil cutting state of the cutting and bending mechanism;

FIGS. 53A and 53B are views illustrating a coil bending state of the cutting and bending mechanism;

FIGS. 54A and 54B are views illustrating a retreat state of the cutting and bending mechanism;

FIGS. 55A to 55E are views illustrating an example of formation of the end portions of the helical coil;

FIG. 56 is a timing chart illustrating an example of an operation by the end processing unit;

FIG. 57 is a perspective view illustrating an assembly example of the coil binding apparatus;

FIG. 58 is another perspective view illustrating the assembly example of the coil binding apparatus;

FIG. 59 is a block diagram illustrating an example of a control system for the paper stack aligning unit;

FIG. 60 is a timing chart illustrating an example of an operation by the paper stack aligning unit;

FIG. 61 is another timing chart illustrating an example of the operation by the paper stack aligning unit;

FIG. 62 is a further timing chart illustrating an example of the operation by the paper stack aligning unit;

FIG. 63 is a block diagram illustrating an example of a control system for the coil forming mechanism;

FIG. 64 is a block diagram illustrating an example of a control system for the coil introducing mechanism, the binding mechanism and the paper stack transferring mechanism;

FIG. 65 is a timing chart illustrating an example of an operation by the coil forming mechanism and the binding mechanism;

FIG. 66 is a timing chart illustrating an example of an operation of the paper stack aligning unit, the binding mechanism and the paper stack transferring mechanism;

FIG. 67 is a block diagram illustrating an example of a control system for the end processing unit;

FIG. 68 is a timing chart illustrating an example of the operation by the end processing unit;

FIG. 69 is a flow chart illustrating an example of control in the coil binding apparatus;

FIG. 70 is another flow chart illustrating an example of control in the coil binding apparatus; and

FIG. 71 is a yet another flow chart illustrating an example of control in the coil binding apparatus.

### DETAILED DESCRIPTION

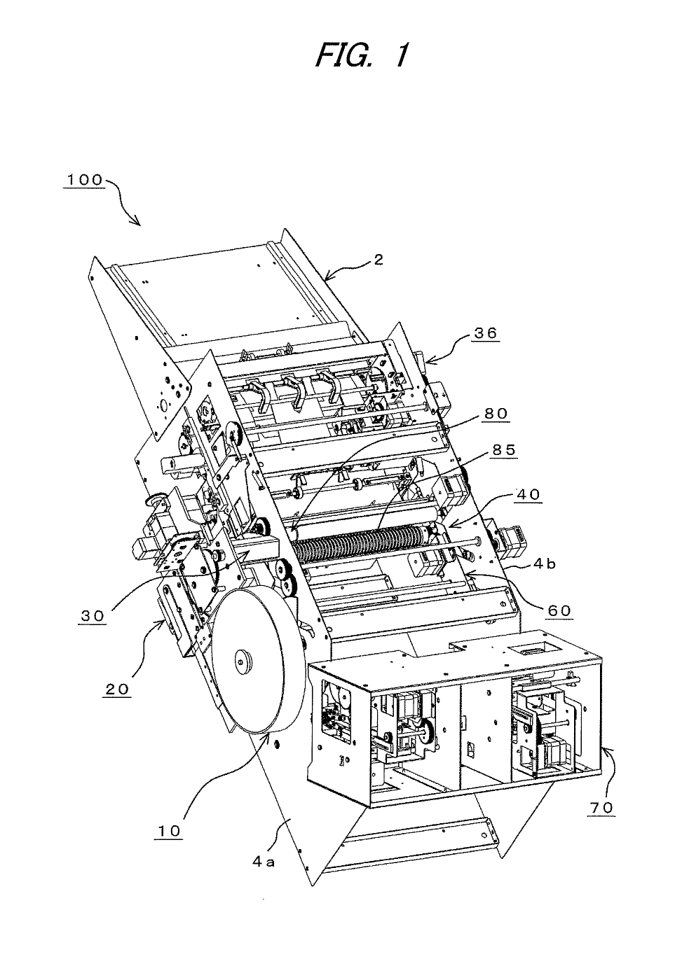

Hereinafter, exemplary embodiments of the present disclosure will be described with reference to the accompanying drawings. As shown in FIG. 1, a coil binding apparatus 100 includes a left plate 4a and a right plate 4b for component attachment, a paper tray 2, a wire cartridge 10, a coil forming mechanism 20, a coil introducing mechanism 30, a paper stack aligning unit 36, a binding mechanism 40, a paper stack transferring mechanism 60, and an end processing unit 70. The coil binding apparatus 100 inserts a formed coil having a helical shape (hereinafter, a helical coil) into punch holes 3a of a paper stack 3 and winds the helical coil along an edge of the paper stack 3 to bind the paper stack 3.

In this example, four kinds of helical coils 11a, 11b, 11c, 11d can be formed. The helical coil 11a is a small-diameter coil having a diameter of 8 mm, the helical coil 11b is a middle-diameter coil having a diameter of 12 mm, the helical coil 11c is a large-diameter coil having a diameter of 16 mm, and the helical coil 11d is a super-large-diameter coil having a diameter of 20 mm.

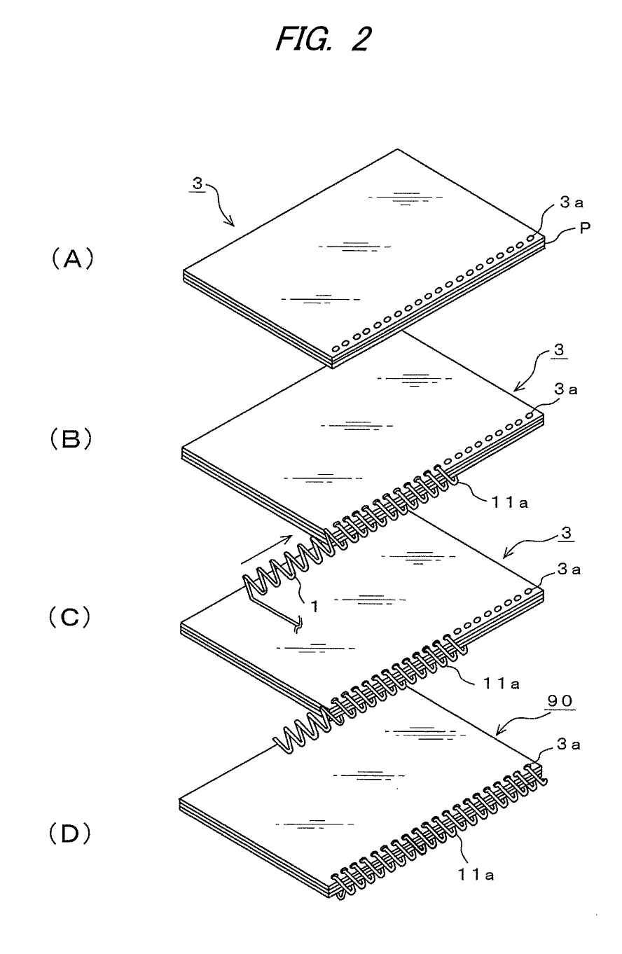

The paper tray 2 is attached to upper portions of the left plate 4a and the right plate 4b and is arranged between the left plate 4a and the right plate 4b. On the paper tray 2, a paper stack 3 having punch holes 3a formed therein as shown in FIG. 2 is fed and mounted. The paper stack 3 is set such that a side formed with the punch holes 3a is arranged on the lower side of the paper tray 2.

When the lower side of the paper tray 2, that is, a side to which paper sheets 3′ are transferred and fed is referred to a downstream side, the paper stack aligning unit 36 is attached on the downstream side of the paper tray 2 and is arranged between the left plate 4a and the right plate 4b. The paper stack aligning unit 36 is operable to align the paper sheets 3′ to be in a stack in order to smoothly insert a helical coil into the punch holes 3a of paper sheets 3′.

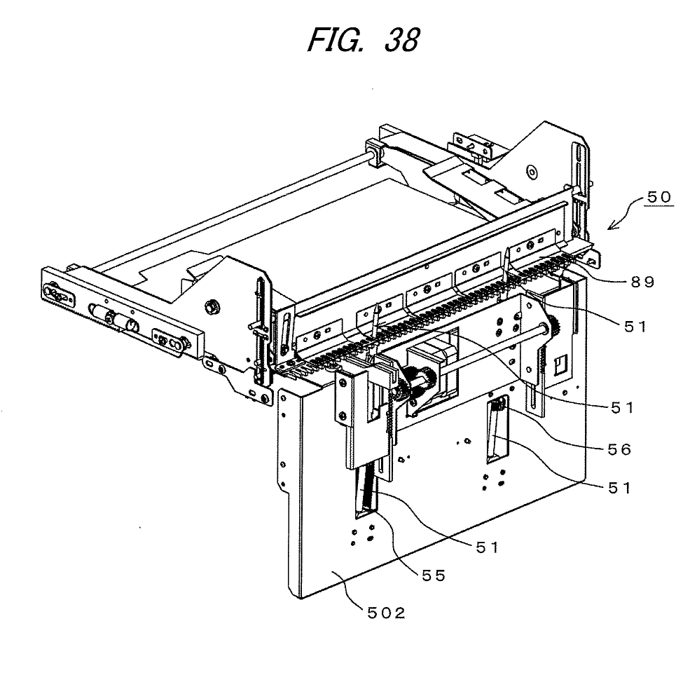

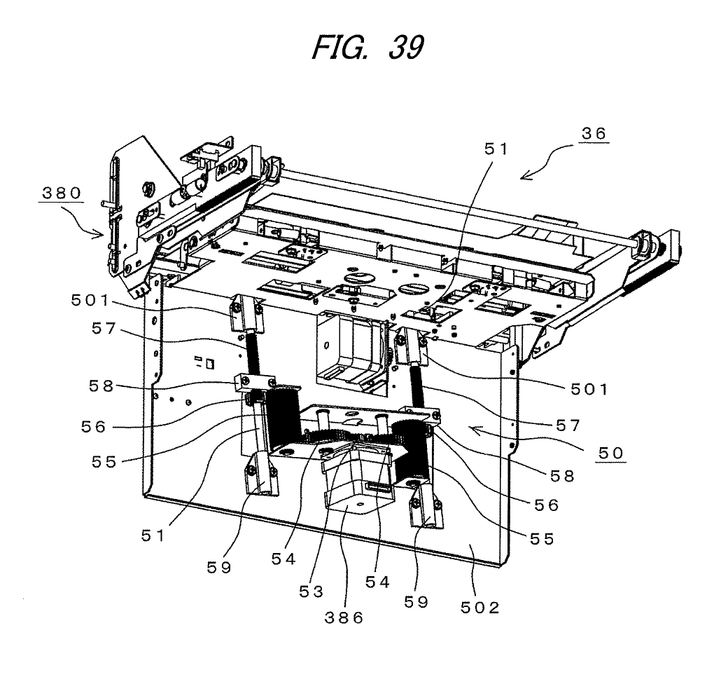

The paper stack aligning unit 36 includes an alignment pin mechanism 50 shown in FIG. 38. The alignment pin mechanism 50 is provided on the rear surface of the paper stack aligning unit 36 (see FIG. 39). The alignment pin mechanism 50 obliquely inserts the alignment pins 51 into the punch holes 3a of the paper stack 3 to align the paper stack 3 such that the punch holes 3a of the paper stack 3 are regulated to be oblique in a coil forwarding direction. By setting the punch holes 3a of the paper stack 3 oblique in the coil forwarding direction, the helical coil can be smoothly inserted.

The coil forming mechanism 20 is attached near the center of the left plate 4a. The wire cartridge 10 is detachably attached below the coil forming mechanism 20 and feeds a wire 1 for forming a helical coil.

The coil forming mechanism 20 forms the wire 1 drawn out of the wire cartridge 10 to draw the helical coil. This example is configured to be capable of selecting one formation guide from among a plurality of formation guides. The formation guides are arc-shaped molds for forming the four kinds of helical coils 11a, 11b, 11c, 11d having diameters of 8 mm, 12 mm, 16 mm, and 20 mm, respectively.

In this example, the coil forming mechanism 20 includes a wire cutting section 25. The wire cutting section 25 cuts the helical coil in a coil length obtained by adding the length of the side of the paper stack 3 having the punch holes 3a formed therein and cutting and bending margins at respective ends of the helical coil (see FIG. 2).

When the right side of the coil forming mechanism 20 shown in FIG. 1, that is, a side on which the helical coil is formed and from which the helical coil is sent out is referred to as a downstream side, the coil introducing mechanism 30 is disposed on the downstream side of the coil forming mechanism 20 and between the coil forming mechanism 20 and the binding mechanism 40. For example, the coil introducing mechanism 30 is rotatably attached on the outer side of the left plate 4a, and is operable to receive the helical coil drawn out of the coil forming mechanism 20 and introduces the helical coil to the binding mechanism 40.

The coil introducing mechanism 30 includes a center axis shifting unit 310 of a rotary-type to shift a coil center axis position to a coil rotation axis position. The coil center axis position is a position of the center axis of the helical coil drawn out of the coil forming mechanism 20. The coil rotation axis position is a position of a rotation axis when the binding mechanism 40 rotates the helical coil to insert the helical coil into the paper stack 3.

The binding mechanism 40 is disposed on the outer side of the paper stack aligning unit 36 and on an inside of the left plate 4a. The binding mechanism 40 is operable to bind the paper stack 3 through the punch holes 3a with the helical coil drawn out of the coil forming mechanism 20. The binding mechanism 40 includes a coil-fore-end inserting section 80 and a coil transferring section 85.

The coil-fore-end inserting section 80 is attached to share the same shaft portion hung near the center between the left plate 4a and the right plate 4b with the coil transferring section 85. The coil transferring section 85 is attached at a position connected to the coil-fore-end inserting section 80. The coil-fore-end inserting section 80 is operable to consistently insert a fore end of the helical coil into the first punch hole 3a of the paper stack 3.

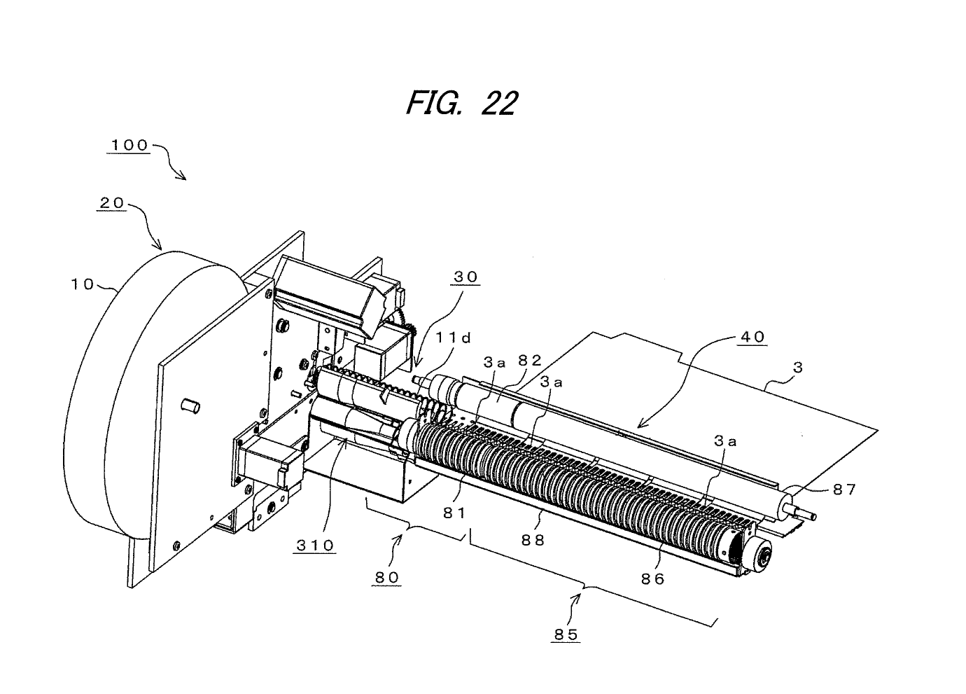

The coil transferring section 85 is disposed at a position adjacent to the coil-fore-end inserting section 80. The coil transferring section 85 includes two roller members, a metal roller 86 and a resin roller 87, brought into contact with the outer circumference of the helical coil and maintaining an insertion posture in the movement direction of the helical coil, and includes one the planar member 88 (see FIG. 22). In this example, the coil transferring section 85 rotates the fore end of the helical coil cut and inserted into the first punch hole 3a of the paper stack 3 to be guided to the last punch hole 3a of the paper stack 3.

In this example, the coil transferring section 85 can consistently insert the fore end of the helical coil up to the last punch hole 3a of the paper stack 3 even after the helical coil loses a formation torque, and stops in a state in which the fore end portion of the helical coil protrudes from the last punch hole 3a. The formation torque of the helical coil is a torque generated when the coil forming mechanism 20 forms the wire for a coil and draws the helical coil.

The paper stack transferring mechanism 60 is provided below the binding mechanism 40 and between the left plate 4a and the right plate 4b. The paper stack transferring mechanism 60 is operable to receive the bound paper stack 3, which has the helical coil inserted into the punch holes 3a of the paper stack 3 and having cutting and bending margins on respective sides, from the binding mechanism 40, and to guide the bound paper stack 3 to the end processing unit 70.

The end processing unit 70 is provided below the paper stack transferring mechanism 60 and between the left plate 4a and the right plate 4b. The end processing unit 70 includes a cutting mechanism, and is operable to receive the bound paper stack 3 from the paper stack transferring mechanism 60, and to cut and bend the end portions of the helical coil. Accordingly, it is possible to consistently bind the paper stack 3 with the helical coil.

Subsequently, a coil binding method according to an exemplary embodiment of the present disclosure will be described. The paper stack 3 shown in (A) of FIG. 2 has punch holes 3a formed at predetermined positions of paper sheets and is applied to the coil binding apparatus 100. During a coil binding process, the positions of the punch holes 3a of the paper stack 3 are aligned to be oblique by the paper stack aligning unit 36 shown in FIG. 1 and the alignment pin mechanism 50 described with reference to FIG. 38, and then binding is performed.

The punch holes 3a are formed with a predetermined pitch by an automatic punching process, however, they may be formed in a predetermined shape with a predetermined pitch by a manual puncher. As long as the arrangement arrangement pitch of the punch holes 3a coincide with a coil pitch and the punch holes 3a has a predetermined shape, the punch holes 3a may be formed by any method.

Subsequently, according to a binding process shown in (B) of FIG. 2, the coil binding apparatus 100 binds the paper stack 3 with the helical coil formed in real time. In this example, the helical coil formed by the coil forming mechanism 20 shown in FIG. 1 is winded by inserting into the punch holes 3a of the paper stack 3 in cooperation with the coil introducing mechanism 30, the coil-fore-end inserting section 80, the binding mechanism 40, and the coil transferring section 85.

For example, the helical coil is inserted into the first half of the punch holes 3a by the formation torque generated when the coil forming mechanism 20 shown in FIG. 1 forms the wire 1 into a helical shape and sends the wire 1. When the helical coil is formed, the wire 1 is then cut by the coil forming mechanism 20. The coil transferring section 85 shown in FIG. 1 receives and rotates the helical coil having lost the formation torque after the cutting shown in (C) of FIG. 2 so as to insert the helical coil into the second half of the punch holes 3a, thereby winding the helical coil on the edge portion of the paper stack 3. Then, the paper stack 3 winded by the helical coil is sent to the end processing unit 70 by the paper stack transferring mechanism 60, and both end portions of the helical coil are cut and both cut end portions are bent. Therefore, a book 90 having the helical coil winded along its side as shown in (D) of FIG. 2 is obtained.

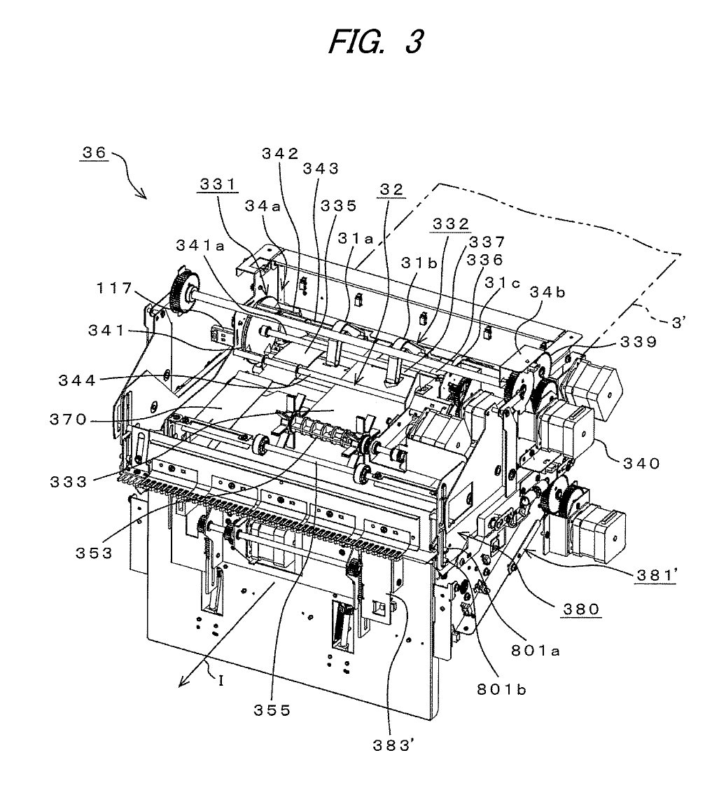

Subsequently, the paper stack aligning unit 36 will be described with reference to FIG. 3. The paper stack aligning unit 36 shown in FIG. 3 is in a state in which a shutter 383′ is open, aligns the paper stack 3 set on the paper tray 2 shown in FIG. 1, and temporarily holds the paper stack 3. The paper stack aligning unit 36 includes a unit frame 381′. A paper curl pressing mechanism 331 and a paper guide press down mechanism 332 are provided near a paper-sheet entrance port in the unit frame 381′.

When receiving a paper sheet 3′ guided by a rear guide sheet (not shown), the paper curl pressing mechanism 331 guides the fore-end side of the paper sheet 3′ to a space between protrusions 342 adjacent to curl fences 34a, 34b. When the paper sheet passes, the paper curl pressing mechanism 331 retreats the protrusions 342 from the lower surface of the paper stack 3 and presses the rear-end side of the paper sheet 3′ with next protrusions 342 at the same time. A metal frame having a resin film attached thereon or fixed thereto by screws is used as the rear guide sheet.

A paper holding unit 32 stocks and temporarily holds the paper stack 3. The curl fences 34a, 34b are provided on the left and right sides of the vicinity of a paper-sheet entrance port of the paper holding unit 32, and form the paper curl pressing mechanism 331. The curl fences 34a, 34b are attached to a power transmission shaft 337 (a curl fence shaft). A motor 340 is attached to one end of the power transmission shaft 337 through a deceleration gear 339. The motor 340 rotates the curl fences 34a, 34b.

The curl fence 34a includes a disk-shaped rotary body 341 and the plurality of protrusions 342. The rotary body 341 includes a shaft portion 341a. The power transmission shaft 337 is attached to the shaft portion 341a. On the circumferential portion of the rotary body 341, for example, four protrusions 342 are disposed at intervals of 90°. Each of the protrusions 342 has a shape protruding in parallel with the shaft portion 341a. If the curl fence 34a is configured as described above, when the paper sheets are aligned and temporarily held, it is possible to press a curly the paper sheet 3′ with the protrusions 342.

For example, whenever a paper sheet is received, the protrusions 342 travel on the paper sheet, thereby capable of maintaining a state in which the protrusions 342 press a curly portion of the paper stack 3 which is being piled up. The structure and function of the curl fence 34b are the same as those of the curl fence 34a and thus a description thereof is omitted.

As described above, according to the curl fences 34a, 34b, when a paper sheet 3′ guided by a rear guide sheet (not shown) is received, the fore-end side of the paper sheet 3′ is guided to the space between the protrusions 342 adjacent to the curl fences 34a, 34b. When the paper sheet passes, the protrusions 342 are retreated from the lower surface of the paper stack 3, and at the same time, the rear-end side of the paper sheet 3′ is pressed by the next protrusions 342.

In the vicinity of a paper discharge port of the paper holding unit 32, the shutter 383′ having a reference surface is provided to close a paper deliver path I when the paper stack 3 is aligned. On the inside (the paper holding unit 32 side) of the shutter 383′, a clamp 801a which is an upper arm on the movable side of a clamp moving mechanism 380 and a clamp 801b which is a lower arm on the fixed side of the clamp moving mechanism 380 are released, and in this state, the paper sheets 3′ are bound. When the paper sheets are discharged, the shutter 383′ is opened, and the paper stack is clamped by the clamps 801a, 801b and is fed to the next process.

The paper guide press down mechanism 332 is provided in parallel to the rotation shaft of the curl fences 34a, 34b of the paper curl pressing mechanism 331, and includes the rear guide sheet (not shown) and curl pressing arms 31a, 31b, 31c. The curl fences 34a, 34b receive power from the power transmission shaft 337 and rotate. For example, the curl pressing arms 31a, 31b, 31c may be formed by injecting a resin into a J-shaped mold.

The rear guide sheet is rotatably joined to a pivot support unit (not shown), and performs an opening/closing operation by rotating counterclockwise, so as to lift the rear-end side of the paper sheet 3′ when the rear end of the paper sheet enters. After the paper sheet 3′ enters, when the rear guide sheet lifts and releases the rear-end side of the paper sheet 3′, the curl pressing arms 31a, 31b, 31c operate to push the rear-end side of the paper sheet 3′ into the lower side of the rear guide sheet. The curl pressing arms 31a, 31b, 31c are attached to a guide support member 343.

The curl pressing arms 31a, 31b, 31c are mounted at positions facing the rear guide sheet. For example, the curl pressing arms 31a, 31b, 31c are pressed into metal rods which have a D-shaped cross section and constitute the guide support member 343, and are fixed. Three curl pressing arms 31a, 31b, 31c are provided in the guide support member 343, thereby obtaining a downward pressing effect on the paper sheet 3′ over the entire width of the paper sheet.

The rear guide sheet provided in the vicinity of the left and right curl fences 34a, 34b guides the fore end portion of the paper stack 3 entering the paper stack aligning unit 36 toward the paper holding unit 32. On the front and rear sides of the power transmission shaft 337 connecting the curl fences 34a, 34b, rear fixing guides 335, 336 are provided. The rear fixing guides 335, 336 guide the paper sheet 3′ guided by the rear guide sheet to the paper holding unit 32.

The rear fixing guides 335, 336 are fixed at positions apart from a paper-sheet alignment surface of the paper holding unit 32. For example, the rear fixing guides 335, 336 are cross-linkably fixed to a set of guide support members 343, 344 disposed on the front and rear sides of the power transmission shaft 337. The rear fixing guides 335, 336 are disposed on the left and right sides of the paper-sheet entrance port.

An upper guide 333 is attached to the guide support member 343 and controls the entrance direction of the fore end portion of the paper sheet 3′ to guide the fore end portion of the paper sheet 3′ to the paper holding unit 32. The rear fixing guides 335, 336 are, for example, injection-molded pieces using a resin, and have bottom portions having arc-shaped R surfaces as seen from above. The rear fixing guides 335, 336 may be made from a metal. The sizes of the rear fixing guides 335, 336 are about 20 mm to 30 mm in width, about 60 mm to 80 mm in length, and about 8 mm to 10 mm in height. If the rear fixing guides 335, 336 are formed as described above, in a case where curly the paper sheet 3′ enters, it is possible to reduce a rising force of the paper sheet 3′ and thus prevent a jam caused by entrance of curly the paper sheet 3′. The curl fence 34b is also configured in the same way as the curl fence 34a and functions in the same way as the curl fence 34a, and thus a description thereof is omitted.

A disk (not shown) having a predetermined shape (four-leaf shape in this example) for sensing curl fence home positions is attached to the other end of the power transmission shaft 337. At positions connected to the disk, home position sensors 112 for curl fences are provided. The sensors 112 detect stop positions of the curl fences 34a, 34b rotating by the motor 340. For example, the sensors 112 may be transmissive optical sensors having light emitting and receiving elements.

On the inside of the paper discharge port of the paper holding unit 32, a multi-oar-type rotatable member (hereinafter, a paddle roller 353) and a side jogger 370 are provided. In order to align the width of the paper stack 3 when aligning the paper stack, left and right side-jogging #1 and #2 (not shown) are brought closer to both sides of the paper stack 3. When the paper sheet 3′ enters, the paddle roller 353 brings the fore end of the paper sheet 3′ into contact with a reference position to align the paper stack 3.

When paper sheets are discharged, the left and right jogging members of the side jogger 370 retreat from both sides of the paper stack 3 in order to give room to paper deliver path I. In the vicinity of an outlet of paper deliver path I, a drawing roller (not shown) and a press roller 355 are provided to operate when giving and receiving the paper stack 3. They constitute the paper stack aligning unit 36.

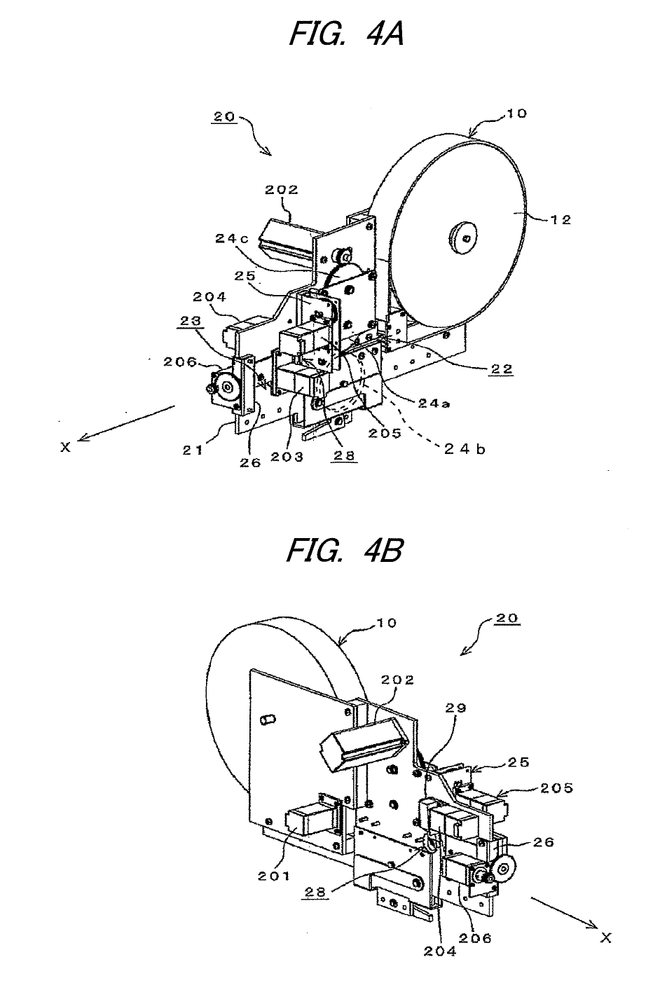

Subsequently, the coil forming mechanism 20 will be described with reference to FIGS. 4A and 4B. The coil forming mechanism 20 forms a helical coil for binding a paper stack. On the coil forming mechanism 20, the wire cartridge 10 is mounted.

The wire cartridge 10 has a drum 12 in which the consumable wire 1 is winded. For example, about 300 m to 1000 m of the wire 1 can be winded in the drum 12. The wire 1 may be a nylon-coated iron-core wire, a vinyl-coated iron-core wire, an aluminum wire, a plated aluminum-core wire, a plated iron-core wire, or the like.

The diameter of the wire 1 is about 0.8 mm to 1.2 mm. When paper sheets to be bound have an A4 size and the number of the punch holes 3a is 47, and when the super-large-diameter coil having the coil diameter of 20 mm is used, consumed amount of the wire 1 is about 3.3 m. When the large-diameter coil having the coil diameter of 16 mm is used, consumed amount of the wire 1 is about 2.7 m. When the middle-diameter coil having the coil diameter of 12 mm is used, consumed amount of the wire 1 is about 2.1 m. When the small-diameter coil having the coil diameter of 8 mm is used, consumed amount of the wire 1 is about 1.4 m.

In this example, the coil forming mechanism 20 is operated by six motors 201 to 206. The motor 201 rotates in response to a driving signal S21 and inserts the fore end of the wire 1 from the wire cartridge 10 into the coil forming mechanism 20 during initial setting.

The coil forming mechanism 20 shown in FIGS. 4A and 4B includes a base 21, a wire transferring section 22, a forming-guide selecting section 23, feed rollers 24a, 24b, a mid gear 24c, a wire cutting section 25, a forming-guide moving section 26, a coil forming section 28, and a pitch formation section 29. The coil forming mechanism 20 forms a helical coil from the wire 1 drawn out of the drum 12.

The wire transferring section 22 is attached to the base 21, adjacent to the wire cartridge 10. The wire transferring section 22 includes a pair of feed rollers 24a, 24b to feed the wire 1 inserted from the wire cartridge 10 to the coil forming section 28. The wire transferring section 22 has the motor 202. The motor 202 is attached to the base 21 and rotates in response to a driving signal S22 to drive the feed rollers 24a, 24b through the mid gear 24c.

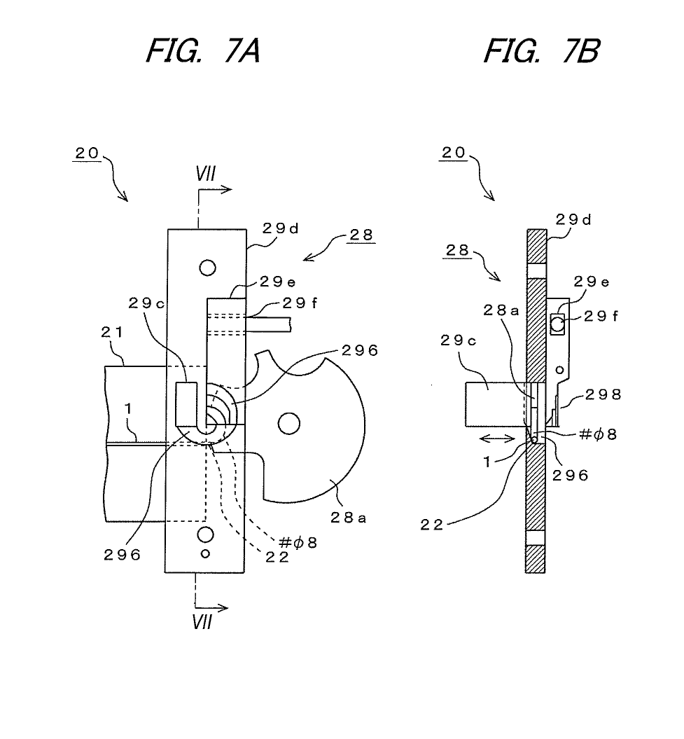

The coil forming section 28, the forming-guide selecting section 23, and the forming-guide moving section 26 are provided next to the wire transferring section 22. The coil forming section 28 is operable to push the wire 1 into a forming guide (see FIG. 7A) selected by the forming-guide selecting section 23 and to draw out a formed helical coil to the coil introducing mechanism 30.

The forming-guide selecting section 23 is operable to select one forming adapter from a plurality of arc-shaped forming adapters #φ8, #φ12, #φ16, #φ20 of a forming guide 28a.

The forming adapter #φ8 is an arc-shaped mold for forming the small-diameter coil having the diameter of 8 mm, the forming adapter #φ12 is an arc-shaped mold for forming the middle-diameter coil having the diameter of 12 mm, the forming adapter #φ16 is an arc-shaped mold for forming the large-diameter coil having the diameter of 16 mm, and the forming adapter #φ20 is an arc-shaped mold for forming the super-large-diameter coil having the diameter of 20 mm. The forming guide 28a defines a coil diameter of the helical coil.

The forming-guide selecting section 23 has a motor 203 that rotates in response to a driving signal S23 to select one of the forming adapters #φ8, #φ12, #φ16, #φ20. In this example, it is possible to form four kinds of coils, that is, the super-large-diameter coil having the diameter of 20 mm, the large-diameter coil having the diameter of 16 mm, the middle-diameter coil having the diameter of 12 mm, and the small-diameter coil having the diameter of 8 mm.

The forming-guide moving section 26 is provided adjacent to the forming-guide selecting section 23. The forming-guide moving section 26 is operable to move the forming-guide selecting section 23 in the entrance direction of the wire 1. The forming-guide moving section 26 has the motor 206. The motor 206 rotates in response to a driving signal S26 and moves the position of the forming-guide selecting section 23 with respect to the entrance direction of the wire 1 when one of the arc-shaped forming adapters #φ8, #φ12, #φ16, #φ20 is selected.

That is, the forming-guide moving section 26 moves the forming-guide selecting section 23 in the direction X shown in FIGS. 4A and 4B from a coil forming position shown in FIGS. 4A and 4B, and then the motor 203 is operated to select one of the four forming adapters #φ8, #φ12, #φ16, #φ20. Next, the forming-guide moving section 26 returns the forming-guide selecting section 23 to the coil forming position.

The pitch formation section 29 is provided on the base 21 so as to be substantially perpendicular to the coil forming section 28. The pitch formation section 29 forms a pitch of helical coil drawn out of the coil forming section 28. The pitch formation section 29 has the motor 204. The motor 204 is attached to the base 21 and rotates in response to a driving signal S24 to finely adjust the pitch of helical coil drawn out of the coil forming section 28.

Here, when a side to which the helical coil is drawn out of the coil forming section 28 is referred to a downstream side and a side of the coil forming section 28 to which the wire 1 is sent is referred to an upstream side, on the upstream side of the coil forming section 28, the wire cutting section 25 is provided. The wire cutting section 25 cuts the helical coil to be in a length consisting of the length of the edge of the paper stack 3 on the side in which punch holes 3a are formed and cut and bent margins of respective end portions of the helical coil (see FIG. 2).

The wire cutting section 25 has the motor 205 attached to the coil forming section 28 and rotates in response to a driving signal S25 to separate the helical coil drawn out of the coil forming section 28 from the wire 1. The motors 201 to 206 may be stepping motors.

According to the coil forming mechanism 20 described above, the forming-guide selecting section 23 selects one of the arc-shaped forming adapters #φ8, #φ12, #φ16, #φ20 of the forming guide 28a, and the coil forming section 28 forms the helical coil by the selected forming adapter and at the same time provides the helical coil to the coil introducing mechanism 30. Thus, it is possible to bind the paper stack 3 with the helical coil selected from four kinds having different coil diameters, that is, the super-large-diameter coil having the diameter of 20 mm, the large-diameter coil having the diameter of 16 mm, the middle-diameter coil having the diameter of 12 mm, and the small-diameter coil having the diameter of 8 mm.

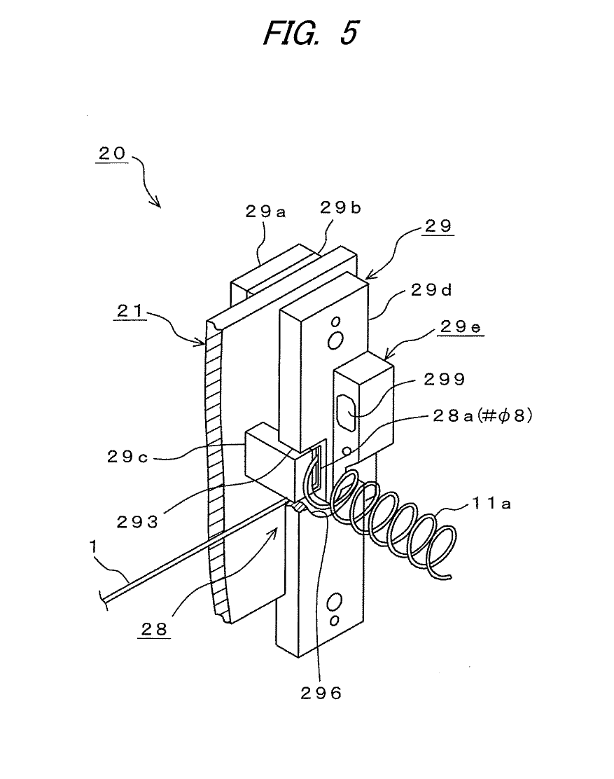

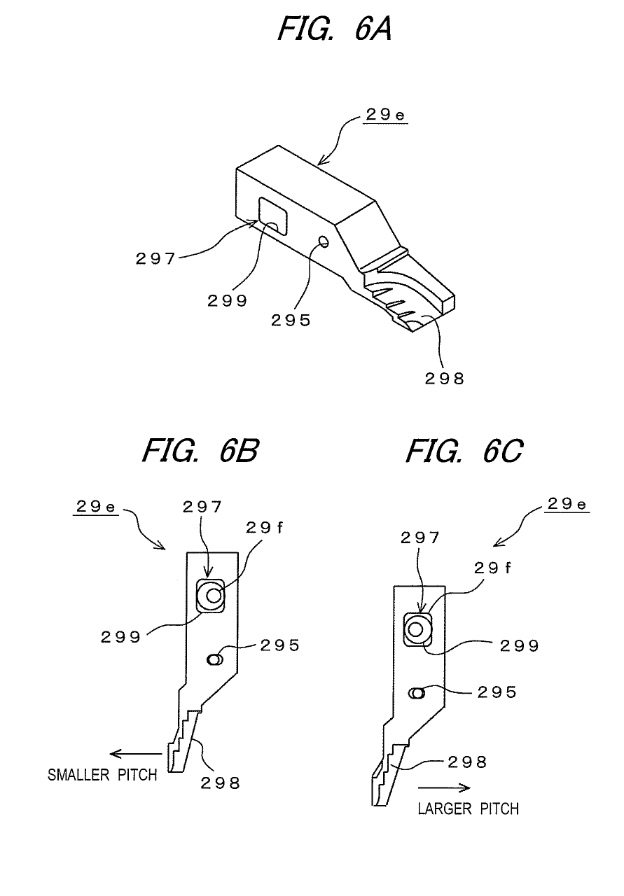

Here, configurations and operations of the pitch formation section 29 and a pitch formation unit 29e will be described with reference to FIGS. 5 to 6C. The pitch formation section 29 shown in FIG. 5 includes a cover plate 29a, a guide plate 29b, a pitch formation block 29c, and a block plate 29d. The cover plate 29a is made of a rectangular metal plate.

The guide plate 29b is made of a rectangular metal plate having the same size and thickness as the cover plate 29a. The guide plate 29b has a rectangular opening 293. The pitch formation block 29c is fitted into the opening 293.

The block plate 29d is made of a rectangular metal plate having almost the same size as the cover plate 29a and the guide plate 29b and a thickness greater than the cover plate 29a and the guide plate 29b. The block plate 29d has a coil outlet 296. The coil outlet 296 has an almost J shape by combining a crescent-shaped opening with a rectangular opening into which the pitch formation block 29c is inserted. In this example, a helical coil having a coil diameter of 8 mm, 12 mm, 16 mm, or 20 mm is drawn out of the coil outlet 296.

The pitch formation block 29c is configured to finely adjust the pitch of the helical coil. The pitch formation block 29c has, for example, a rectangular shape, and is movable between an opening 293 of the guide plate 29b and the coil outlet 296 of the block plate 29d.

A hollow portion (a tunnel) is formed between the opening 293 and the coil outlet 296 so as to enable the pitch formation block 29c to move. The hollow portion is formed to enable the pitch formation block 29c to move forward and backward in the helical coil carrying direction, thereby finely adjusting the coil pitch. Therefore, it is possible to correct the coil pitch of the helical coil, formed by pitch formation section 29, by the pitch formation block 29c in correspondence with the tensile strength of the wire 1.

A stepped pitch formation unit 29e is attached to a portion of the block plate 29d above the J-shaped coil outlet 296. The pitch formation unit 29e is made of the rectangular metal plate and has a delivery guide portion 298 formed at a corner (see FIGS. 6A to 6C). The delivery guide portion 298 has a quarter-arc-shaped step form to which the plurality of helical coils having diameters of 8 mm, 12 mm, 16 mm or 20 mm accord.

Subsequently, a configuration and a operation of the pitch formation unit 29e during coil forming will be described with reference to FIGS. 6A to 6C. The pitch formation unit 29e shown in FIG. 6A has a wedge shape, and includes an eccentric cam structure 297 and the delivery guide portion 298. According to the eccentric cam structure 297, an opening for a cam (hereinafter, a cam opening 299) passing through a side of a main body of the pitch formation unit 29e is formed. The cam opening 299 is formed in a direction perpendicular to the coil forwarding direction. An eccentric cam unit 29f is rotatably disposed in the cam opening 299. The eccentric cam unit 29f is attached to the motor 204 for pitch adjustment shown in FIG. 4A.

Further, the pitch formation unit 29e has a rotation shaft 295 in a direction perpendicular to the coil forwarding direction. The pitch formation unit 29e is attached to the block plate 29d shown in FIG. 5 to be rotatable on the rotation shaft 295. The block plate 29d is fixed to the base 21 by bolts and nuts (not shown).

In this example, when the eccentric cam unit 29f is rotated by the motor 204 shown in FIG. 4A, the main body of the pitch formation unit 29e can move forward and backward along the coil forwarding direction. In a case of making the coil pitch of the helical coil small, the eccentric cam unit 29f rotates to pull the pitch formation unit 29e forward such that the pitch formation unit 29e approaches the block plate 29d (FIG. 6B).

Further, in a case of making the coil pitch of the helical coil large, the eccentric cam unit 29f rotates in the opposite direction to move the pitch formation unit 29e away from the block plate 29d (see FIG. 6C). When a movement amount of the main body of the pitch formation unit in the forth and back directions along the coil forwarding direction is referred to as an eccentric amount, the eccentric amount is, for example, about 1.6 mm. Therefore, the coil pitch of the helical coil drawn out of the coil forming section 28 can be finely adjusted. They form the pitch formation section 29.

Subsequently, an example of the function of the pitch formation section 29 during coil forming will be described. In this example, the coil forming section 28 has the forming guide 28a. The forming guide 28a has four kinds of arc-shaped forming adapters #φ8, #φ12, #φ16, #φ20. Each of the forming adapters #φ8, #φ12, #φ16, #φ20 has a pick-up function when wire enters. An example is shown where an arc-shaped forming adapter (e.g., #φ8) of the forming guide 28a is selected in the coil forming section 28.

The wire 1 pushed out of the wire transferring section 22 shown in FIG. 7A comes into contact with the forming adapter #φ8 of the forming guide 28a shown in FIG. 7A. In this case, the wire 1 comes into contact with a lower end of the forming adapter #φ8 shown in FIG. 7B. This lower end is designed to be a start end when a circle having a diameter of 8 mm is drawn.

Further, when the wire 1 is pushed out from the wire transferring section 22, the wire 1 shown in FIG. 7A moves so as to rotate along the inside of the forming adapter of the forming guide 28a. At this moment, the wire 1 is altered into a helical shape by moving along the arc of the forming adapter as shown in FIG. 7B. The movement direction of the wire 1 at this moment is an almost reverse direction of the insertion direction thereof.

When the wire 1 is pushed out from the wire transferring section 22, the wire 1 rotates along the inside of the forming adapter of the forming guide 28a and then the fore end of the wire 1 altered to the helical shape by the forming adapter is limited by a fore end of the pitch formation block 29c so as to change the movement direction thereof.

In this case, the pitch formation block 29c adjusts a discharge position of the helical coil. In this example, in a case where the wire 1 has a high tensile strength, the pitch formation block 29c is adjusted to correct the coil pitch of the helical coil to be wide. On the contrary, in a case where the wire 1 has s low tensile strength, the coil pitch of the helical coil is corrected to be narrow.

This enables the coil pitch to be finely adjusted. Accordingly, the coil pitch of the helical coil adjusted by the pitch formation section 29 can be corrected in response to the tensile strength of the wire 1 by the pitch formation block 29c. As a result, it is possible to finely adjust the coil pitch of the helical coil.

In the coil forming mechanism 20, the helical coil 11a is discharged to a direction (hereinafter, a coil discharge direction) almost perpendicular to the movement direction (the insertion direction) of the wire 1. Furthermore, when the wire 1 is pushed out from the wire transferring section 22, the wire 1 is discharged to the coil discharge direction from the coil outlet 296 of the block plate 29d while rotating to draw a circle. At this moment, the wire 1 altered to the helical shape becomes the helical coil 11a. The fore end portion thereof moves to the delivery guide portion 298 of the pitch formation unit 29e, whereby the helical coil moves along the quarter-arc-shaped step form of the delivery guide portion 298 for the coil diameter of 8 mm.

Therefore, it is possible to discharge the helical coil having the coil diameter of 8 mm from the coil outlet 296. When a forming adapter #φ12 is selected from the forming guide 28a, the helical coil 11b having the coil diameter of 12 mm can move along the quarter-arc-shaped step form of the delivery guide portion 298 for the coil diameter of 12 mm and be discharged from the coil outlet 296.

Similarly, in a case where a forming adapter #φ16 is selected from the forming guide 28a, the helical coil 11c having the coil diameter of 16 mm can move along the quarter-arc-shaped step form of the delivery guide portion 298 for the coil diameter of 16 mm and be discharged from the coil outlet 296. In a case where the forming adapter #φ20 is selected from the forming guide 28a, the helical coil lid having the coil diameter of 20 mm can move along the quarter-arc-shaped step form of the delivery guide portion 298 for the coil diameter of 20 mm and be discharged from the coil outlet 296. In this way, it is possible to make the coil pitch almost constant.

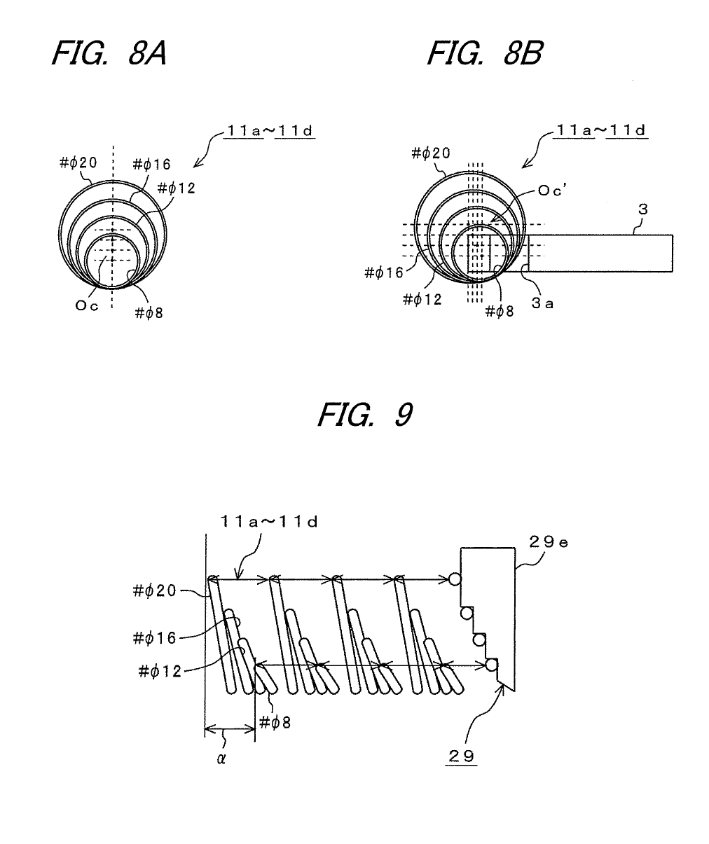

Subsequently, the coil introducing mechanism 30 will be described with reference to FIGS. 8A to 21. Four kinds of helical coils 11a, 11b, 11c, 11d having the diameters of 8 mm (#φ8), 12 mm (#φ12), 16 mm (#φ16), and 20 mm (#φ20), respectively, shown in FIG. 8A are formed by the single coil forming mechanism 20. Thus, coil center axis positions Oc of the helical coils 11a, 11b, 11c, 11d are aligned on a straight line in a direction (a vertical direction) substantially perpendicular to the entrance direction of the wire 1. In FIG. 8A, the respective coil center axis positions Oc are shown by dots where the vertical broken line and the four horizontal broken lines intersect, respectively.

In the binding mechanism 40, in order to smoothly and consistently insert four kinds of helical coils 11a, 11b, 11c, 11d into the punch holes 3a, the coil center axis positions Oc of the respective helical coils 11a, 11b, 11c, 11d are guided to different coil rotation axis positions Oc′, as shown in FIG. 8B. In FIG. 8B, the coil rotation axis positions Oc′ are shown by dots where the four vertical broken lines and the four horizontal broken lines intersect, respectively.

Further, according to a pitch formation example in the pitch formation section 29 shown in FIG. 9, as described with reference to FIGS. 5 to 7B, the coil pitch of the helical coil drawn out of the coil forming section 28 is adjusted by the stepped pitch formation unit 29e. Therefore, a position through which the fore end of the helical coil travels becomes different depending on the coil diameter. A pitch formation amount α shown in FIG. 9 is an adjustment amount of the coil pitch, and is an adjustment amount between the small-diameter coil having the diameter of 8 mm and the super-large-diameter coil having the diameter of 20 mm.

When forming the helical coils having the diameters 8 mm, 12 mm, 16 mm, and 20 mm to have the same coil pitches, the pitch formation amounts differ according to the coil diameters, as the springiness of the respective helical coils are different from each other. In other words, as the coil diameter increases, a larger the pitch formation amount is required. Since the super-large-diameter coil 11d having the diameter of 20 mm has springback larger than the small-diameter coil 11a having the diameter of 8 mm, unless a slightly lager the pitch formation amount is set, the helical coil 11d having the same coil pitch cannot be obtained.

In this example, the position where the wire 1 is fed to the coil forming mechanism 20 is fixed during coil forming. Thus, the coil center axis position Oc of the helical coil 11d is deviated by a difference in the pitch formation amount. Therefore, each of the coil center axis positions Oc of the helical coils 11a, 11b, 11c, 11d is deviated with respect to the respective coil rotation axis positions Oc′ to the punch holes 3a of the paper stack 3.

As a result, for example, a position of a paper stack 3 may need to be adjusted in accordance with the coil diameter with reference to the coil center axis positions Oc of the helical coils 11a, 11b, 11c, 11d. According to an exemplary embodiment of the present disclosure, the coil introducing mechanism 30 is provided between the coil forming mechanism 20 and the binding mechanism 40 to absorb the positional deviation between the coil center axis position Oc in the coil forming mechanism 20 and the coil rotation axis position Oc′ in the binding mechanism 40.

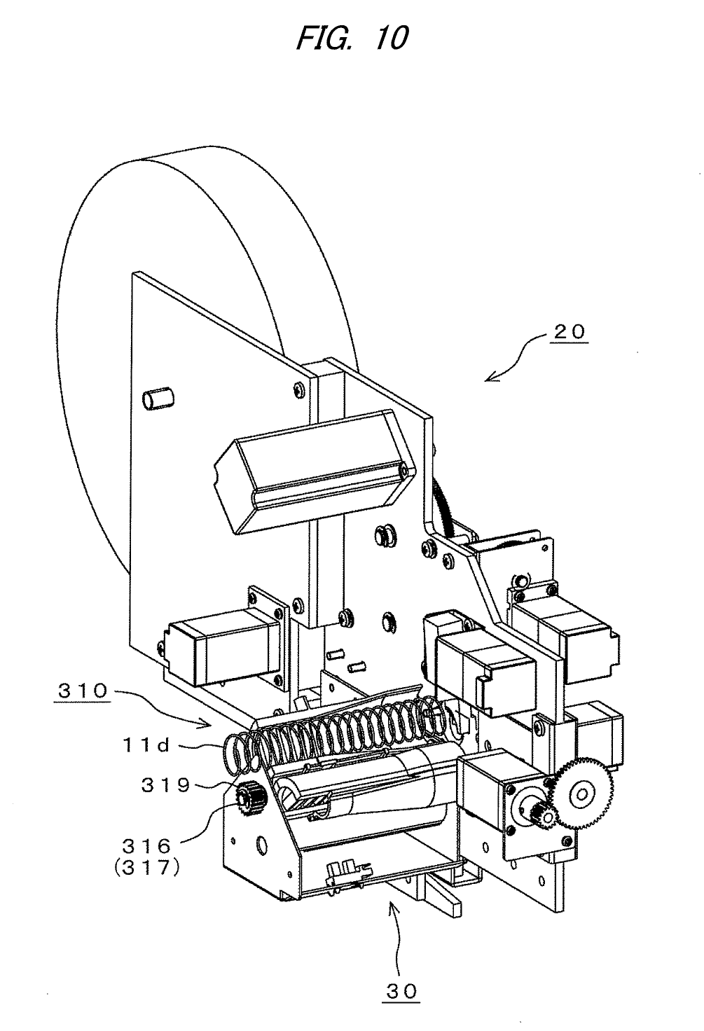

An arrangement of the coil introducing mechanism 30 will be described with reference to FIG. 10. On the downstream side of the coil forming mechanism 20 shown in FIG. 10, the coil introducing mechanism 30 is provided to guide a helical coil having a selected coil diameter to the binding mechanism 40. When the left side of the coil forming mechanism 20, that is, a side to which the helical coil is drawn in FIG. 10 is referred to a downstream side, the coil introducing mechanism 30 is disposed on the downstream side between the coil forming mechanism 20 and the binding mechanism 40 (not shown).

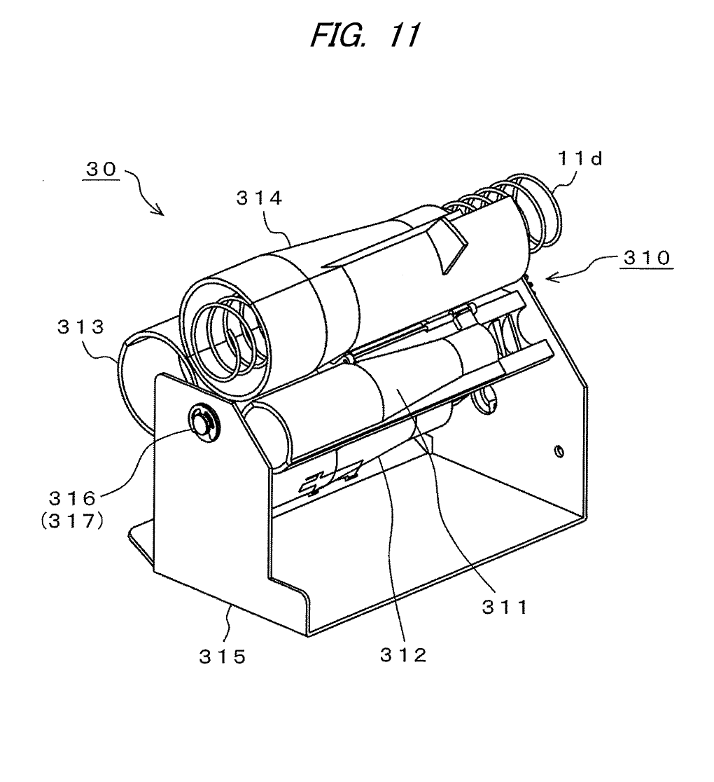

Subsequently, an example of a configuration of the coil introducing mechanism 30 will be described with reference to FIG. 11. The coil introducing mechanism 30 includes a rotary-type center axis shifting unit 310, a holder 315, and a rotation shaft 316 (a rotary base). The coil introducing mechanism 30 absorbs the positional deviation generated between the coil center axis position Oc shown in FIG. 8A and the coil rotation axis position Oc′ shown in FIG. 8B and shifts the coil center axis position Oc to the coil rotation axis position Oc′.

In this example, the center axis shifting unit 310 includes four coil accommodating units 311 to 314, an example of a plurality of tubular bodies (coil receivers). The coil accommodating units 311 to 314 are provided for each of the coil diameters of the helical coils. The center axis shifting unit 310 is operable to select one of the coil accommodating units 311 to 314 corresponding to the coil diameter of the helical coil. The coil accommodating unit has an accommodating portion formed as a space having an area accommodating the helical coil drawn out of the coil forming section 28.

For example, the coil accommodating unit 311 has a center position that coincides with the coil rotation axis position Oc′ of the helical coil 11a in the binding mechanism 40, and functions to receive the helical coil 11a having the diameter of 8 mm drawn out of the coil forming mechanism 20 and to introduce the helical coil 11a to the binding mechanism 40.

Similarly, the coil accommodating unit 312 has a center position that coincides with the coil rotation axis position Oc′ of the helical coil 11b in the binding mechanism 40, and functions to receive the helical coil 11b having the diameter of 12 mm and to introduce the helical coil 11b to the binding mechanism 40.

The coil accommodating unit 313 has a center position that coincides with the coil rotation axis position Oc′ of the helical coil 11c in the binding mechanism 40, and functions to receive the helical coil 11c having the diameter of 16 mm and to introduce the helical coil 11c to the binding mechanism 40. The coil accommodating unit 314 has a center position that coincides with the coil rotation axis position Oc′ of the helical coil 11d in the binding mechanism 40, and functions to receive the helical coil 11d having the diameter of 20 mm and to introduce the helical coil 11d to the binding mechanism 40.

The coil accommodating units 311 to 314 are attached and fixed to the outer circumference of the rotation shaft 316, parallel to the coil forwarding direction. The coil accommodating units 311 to 314 are formed by resin injection molding. In this example, the coil accommodating units 311 to 314 are formed such that an inlet from which the helical coil is introduced is wider than an outlet from which the helical coil is drawn out.

A holder 315 is an example of a support member and is configured by bending a metal plate such as a light metal plate, an iron plate, or the like in a U shape. The holder 315 includes pivot support portions 317 at two side wall, respectively. The holder 315 rotatably holds a rotation shaft 316. The rotation shaft 316 to which the coil accommodating units 311 to 314 are attached bridges the pivot support portions of the holder 315, and is rotatably supported by the pivot support portions 317. The holder 315 is attached to, for example, the left plate 4a of an apparatus main body 101 and is fixed by screws or the like.

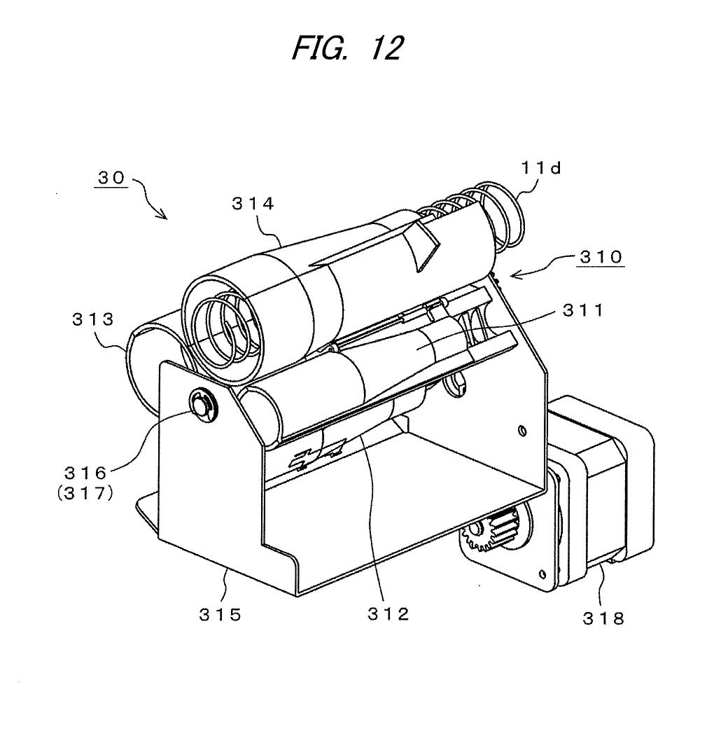

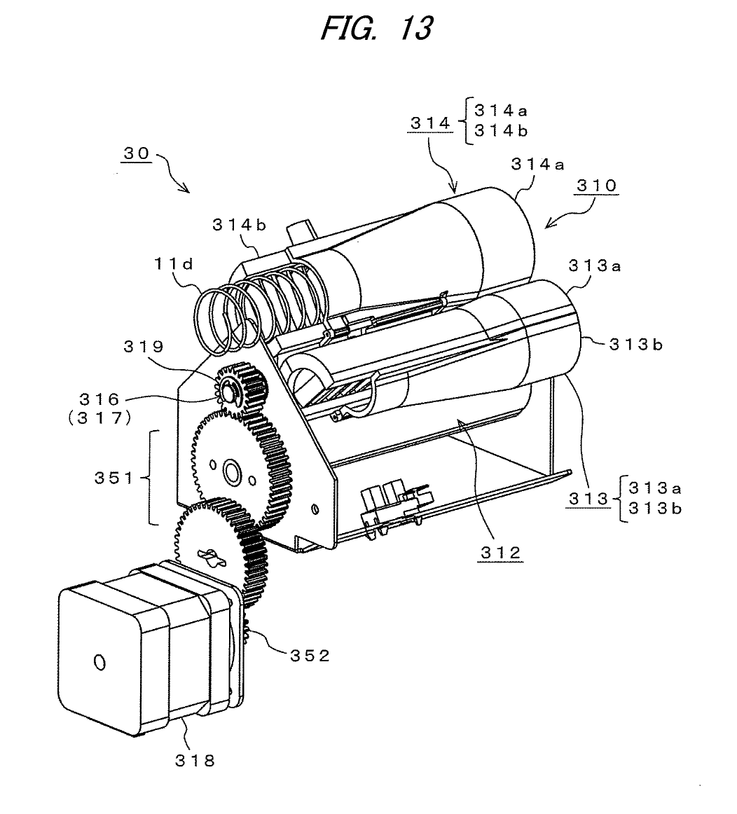

Subsequently, a layout of a driving source of the coil introducing mechanism 30 will be described with reference to FIGS. 12 and 13. The driving source of the coil introducing mechanism 30 shown in FIG. 12 is disposed on the side to which the helical coil is drawn. The coil introducing mechanism 30 has a motor 318 for selecting the coil accommodating unit. The motor 318 may be, for example, a stepping motor.

In a case where the coil introducing mechanism 30 shown in FIG. 12 is seen from the rear surface, as shown in FIG. 13, a small gear 319 is attached to the rotation shaft 316 of the center axis shifting unit 310. The small gear 319 is engaged with a deceleration gear 351. The deceleration gear 351 is engaged with a motor gear 352 attached to a motor shaft.

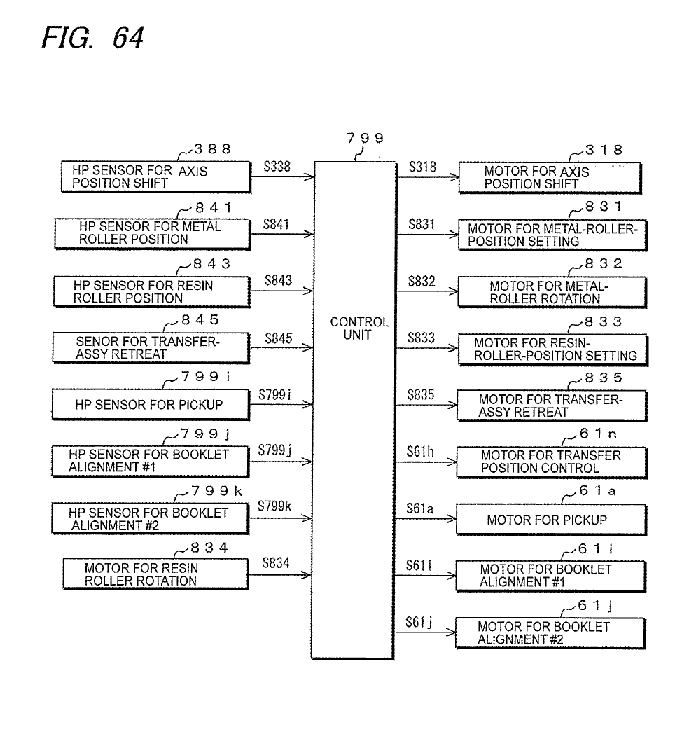

The motor 318 is attached to the base 21, rotates the motor shaft in response to a driving signal S318, and is driven when the coil accommodating unit 311 or the like corresponding to the coil diameter of the helical coil drawn out of the coil forming mechanism 20 is selected (see FIG. 64). Accordingly, for example, the helical coil having the diameter of 8 mm drawn out of the coil forming mechanism 20 may be received by the coil accommodating unit 311 and drawn from the coil accommodating unit 311 to the binding mechanism 40.

The coil accommodating unit 313 shown in FIG. 13 includes a container 313a and a cover 313b. The coil accommodating unit 314 includes a container 314a and a cover 314b. The other coil accommodating units 311, 312 are configured in the same way.

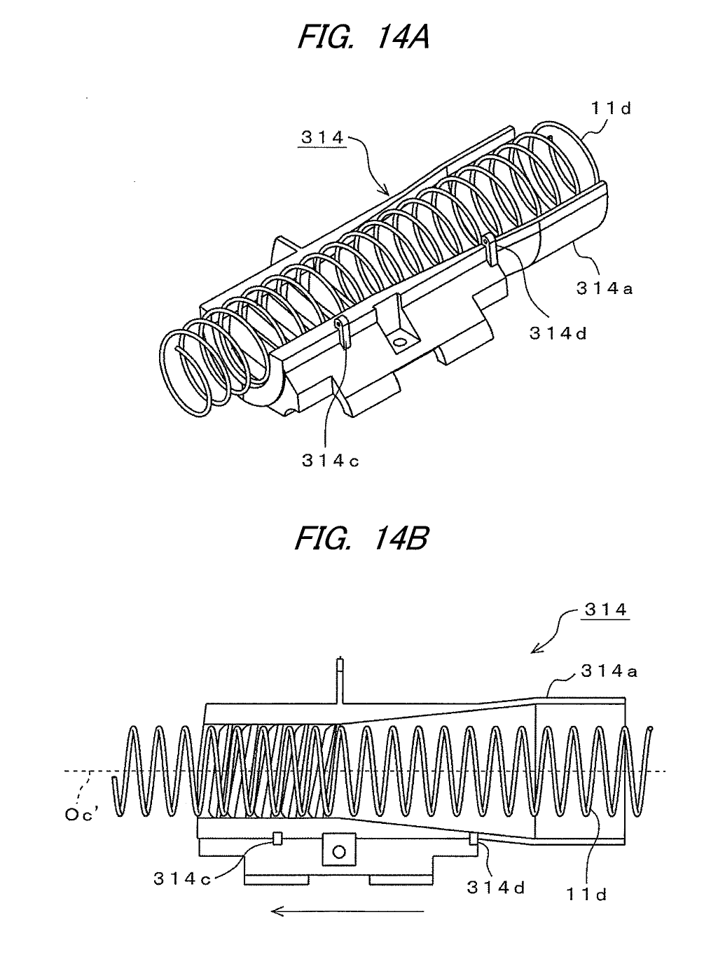

Subsequently, an example of a divided structure of the coil accommodating unit 314 will be described with reference to FIGS. 14A and 14B. A tube body of the coil accommodating unit 314 shown in FIG. 14A is divided into two portions, that is, upper and lower portions on the basis of a longitudinal direction. The coil accommodating unit 314 includes the container 314a shown in FIG. 13 and the cover 314b joined with the container 314a. The container 314a is fixed to the rotation shaft 316, and the cover 314b is joined with the container 314a by hinge structures to be openable. In this example, the container 314a has the hinge pivot support portions 314c, 314d provided on one side thereof. The container 314a is joined with the cover 314b shown in FIG. 13 by hinge pivot support portions 314c, 314d. The other coil accommodating units 311 to 313 have the same divided structure.

The coil accommodating unit 314 has a vertically divided structure such that the cover can be opened from the container 314a when fixing a jam, it is possible to smoothly fix a jam, as compared to the coil accommodating unit which is a simple tube body. Fixing a jam is, for example, a process of removing a helical coil remaining in, the coil accommodating unit 314 from the container 314a.

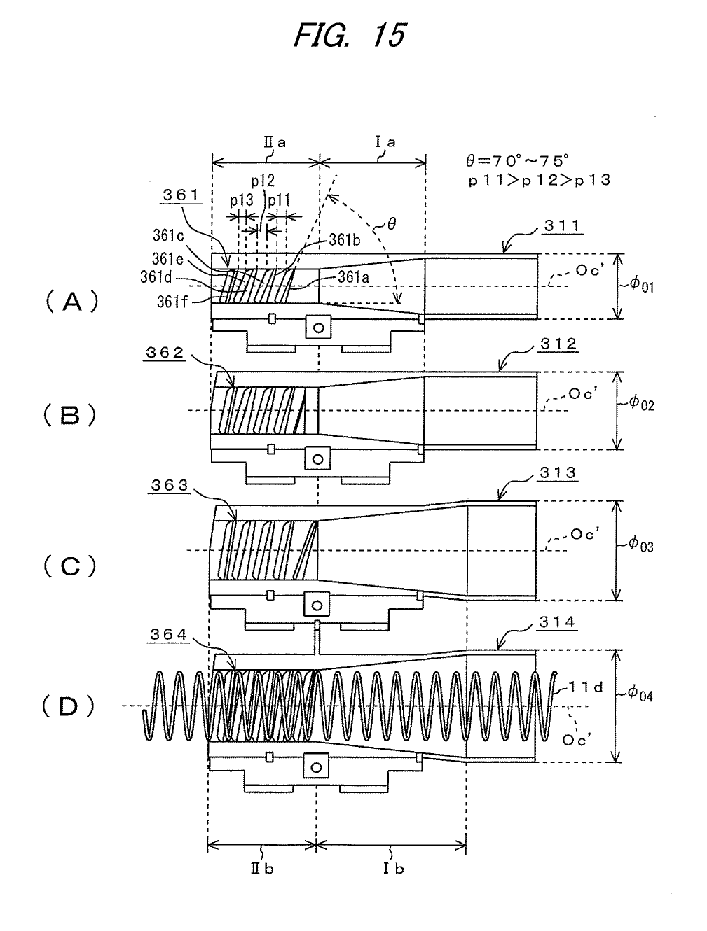

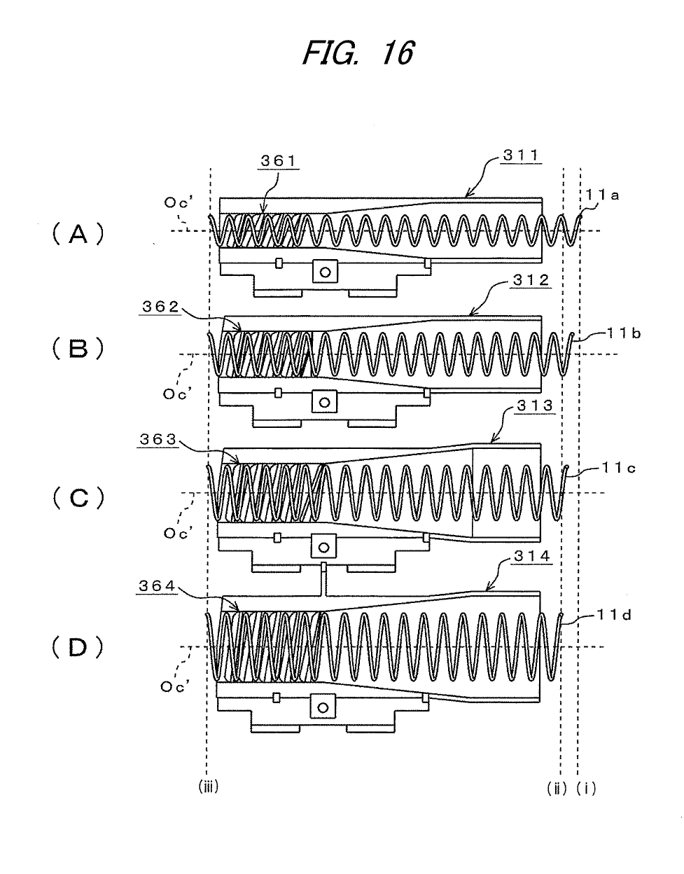

Subsequently, an example of the function of coil accommodating units 311 to 314 will be described with reference to FIGS. 15 and 16. In the coil accommodating unit 311 shown in (a) of FIG. 15, when a diameter on a coil entrance side is denoted by φ₀₁, for example, diameter φ₀₁ is set to about 16 mm, and functions to attract the helical coil 11a having the diameter of 8 mm into the coil accommodating unit 311. Hereinafter, diameter φ₀₁ is referred to as an attraction diameter.

In this example, a first correction section Ia and a second correction section IIa are sequentially set to be adjacent to a tubular portion having attraction diameter φ₀₁ in the coil accommodating unit 311. The correction section Ia (a tapered section) is configured such that the inner diameter gradually decreases from the tubular portion having diameter φ₀₁ toward the coil diameter of 8 mm. In the correction section Ia, in order to adjust the outer diameter of the helical coil 11a having the diameter of 8 mm formed by the coil forming mechanism 20, the helical coil 11a is induced from the correction section Ia to the correction section IIa.

In the correction section IIa of the coil accommodating unit 311, a correction groove 361 is formed to correct a difference of the pitch formation amount α of the small-diameter helical coil 11a having the diameter of 8 mm. The difference of the pitch formation amount α is a difference in the coil pitch between helical coils having different coil diameters such as helical coils 11a and 11b, helical coils 11b and 11c, helical coils 11c and 11d, and helical coils 11a and 11d. In the correction groove 361 of the coil accommodating unit 311, a plurality of inclined rib portions are formed to be arranged in the coil forwarding direction. In this example, the correction groove 361 has four rib portions 361a to 361d. Each of rib portions 361a to 361d has a structure similar to a screw formed by peaks and valleys.

Referring to (A) of FIG. 15, θ is a pick-up angle and is an angle formed between the coil forwarding direction and an extension line of a peak portion of the first rib portion 361a. The pick-up angle θ is an angle regulating the entrance posture of the coil fore-end portion when the helical coil is picked up to the correction section Ia. In this example, the pick-up angle θ is set to about 70° to 75°.

Further, a pick-up groove width p11 is set to a valley portion between the rib portion 361a and the rib portion 361b of the correction groove 361. Furthermore, a correction groove width p12 is set to a valley portion between the rib portion 361c and the rib portion 361d. Moreover, a correction groove width p13 is set to a valley portion between the rib portion 361e and the rib portion 361f. In this example, a relationship of p11>p12>p13 is set among the pick-up groove width p11 and the correction groove widths p12, p13 so as to make it possible to correct the outer diameter of the helical coil 11a entering the coil accommodating unit 311 and function to consistently introduce the helical coil 11a having a different coil diameter to the binding mechanism 40. As described above, the correction groove 361 is set to have a groove width that is gradually narrowed as the helical coil moves, like the correction groove widths p12, p13.

In the coil accommodating unit 312 shown in (B) of FIG. 15, an attraction diameter φ₀₂ is set. Attraction diameter φ₀₂ is set to about 24 mm, and attracts the helical coil 11b having the diameter of 12 mm into the coil accommodating unit 312.

Even in this example, the first correction section Ia and the second correction section IIa are sequentially set to be adjacent to a tubular portion having the attraction diameter φ₀₂ in the coil accommodating unit 312. The correction section Ia is configured such that the inner diameter gradually decreases from the tubular portion having diameter φ₀₂ toward the coil diameter of 12 mm. In the correction section Ia, in order to adjust the outer diameter of the helical coil 11b having the diameter of 12 mm formed by the coil forming mechanism 20, the helical coil 11b is induced from the correction section Ia to the correction section IIa.

In the correction section IIa, like the coil accommodating unit 311, a correction groove 362 is formed to correct a difference of the pitch formation amount α of small-diameter the helical coil 11b having the diameter of 12 mm. The pick-up angle θ and the pick-up groove widths are set in the same manner as the coil accommodating unit 311 and thus a description thereof is omitted (see (A) of FIG. 15).

In the coil accommodating unit 313 shown in (C) of FIG. 15, an attraction diameter φ₀₃ is set. The attraction diameter φ₀₃ is set to about 32 mm, and functions to attract the helical coil 11c having the diameter of 16 mm into the coil accommodating unit 313.

In this example, a first correction section Ib and a second correction section IIb are sequentially set to be adjacent to a tubular portion having the attraction diameter φ₀₃ in the coil accommodating unit 313. The correction section III) has substantially the same length as the correction section IIa in the coil accommodating units 311, 312. In contrast, the correction section Ib is longer than the correction section Ia in the coil accommodating unit 313. This setting is for making it easy to induce the helical coil 11c having a larger diameter than the small-diameter helical coil 11a and the middle-diameter helical coil 11b to the correction section IIb by lengthening the correction section Ib.

Also in this example, the correction section Ib is configured such that the inner diameter gradually decreases from the tubular portion having the diameter φ₀₃ toward the coil diameter of 16 mm. In the correction section Ib, in order to adjust the outer diameter of the helical coil 11c having the diameter of 16 mm formed by the coil forming mechanism 20, the helical coil 11c is induced from the correction section Ib to the correction section IIb.

In the correction section IIb, like the coil accommodating units 311 and 312, a correction groove 363 is formed to correct a difference of the pitch formation amount α of the large-diameter helical coil 11c having the diameter of 16 mm. The pick-up angle θ and the pick-up groove widths are set in the same manner as the coil accommodating units 311 and 312 and thus a description thereof is omitted (see (A) of FIG. 15).

In the coil accommodating unit 314 shown in (D) of FIG. 15, an attraction diameter φ₀₄ is set. The attraction diameter φ₀₄ is set to about 40 mm, and functions to attract the helical coil 11d having the diameter of 20 mm into the coil accommodating unit 314.

Also in this example, a first correction section Ib and a second correction section IIb are sequentially set to be adjacent to a tubular portion having attraction diameter φ₀₄ in the coil accommodating unit 314. The correction section IIb is set to have the same length as the correction section IIa. Further, the correction section Ib is configured such that the inner diameter gradually decreases from the tubular portion having the diameter φ₀₄ toward the coil diameter of 20 mm. In the correction section Ib, in order to adjust the outer diameter of the helical coil 11d having the diameter of 20 mm formed by the coil forming mechanism 20, the helical coil 11d is induced from the correction section Ib to the correction section IIb.

In the correction section IIb, like the coil accommodating units 311 to 313, a correction groove 364 is formed to correct a difference of the pitch formation amount α of the super-large-diameter helical coil 11d having the diameter of 20 mm. The pick-up angle θ and the pick-up groove widths are set in the same manner as the coil accommodating units 311 to 313 and thus a description thereof is omitted (see (A) of FIG. 15).

In this example, in (A) to (D) of FIG. 16, a coil drawing point of the coil forming mechanism 20 is denoted by i, a coil pass point between the coil drawing point to the center axis shifting unit 310 is denoted by ii, and a coil drawing point of the center axis shifting unit 310 is denoted by iii. The coil pitches of the helical coil 11a formed to have the diameter of 8 mm, the helical coil 11b formed to have the diameter of 12 mm, the helical coil 11c formed to have the diameter of 16 mm, and the helical coil 11d formed to have the diameter of 20 mm drawn from the coil drawing point i to the coil introducing mechanism 30 are different from each other. The helical coils 11a, 11b, 11c, 11d observed at coil pass point ii generate positional deviation in each of the coil pitches.

However, the helical coil 11a having the diameter of 8 mm picked up and put into the coil accommodating unit 311 shown in (A) of FIG. 16 is corrected in the coil accommodating unit 311. Similarly, the helical coil 11b having the diameter of 12 mm picked up and put into the coil accommodating unit 312 shown in (B) of FIG. 16 is corrected in the coil accommodating unit 312. The helical coil 11c having the diameter of 16 mm picked up and put into the coil accommodating unit 313 shown in (C) of FIG. 16 is corrected in the coil accommodating unit 313. Similarly, the helical coil 11d having the diameter of 20 mm picked up and put into the coil accommodating unit 314 shown in (D) of FIG. 16 is corrected in the coil accommodating unit 314.

As a result, the differences of the pitch formation amount α of four kinds of helical coils 11a, 11b, 11c, 11d observed at coil drawing point iii of the center axis shifting unit 310 are corrected by the correction groove 361 of the coil accommodating unit 311, the correction groove 362 of the coil accommodating unit 312, the correction groove 363 of the coil accommodating unit 313, and the correction groove 364 of the coil accommodating unit 314, respectively, such that helical coils 11a, 11b, 11c, 11d do not generate a positional deviation in each of the coil pitches. Therefore, the coil pitch is corrected by the center axis shifting unit 310, thereby capable of consistently introducing the helical coil with the aligned coil fore-end portion to the binding mechanism 40.

As described above, according to the coil binding apparatus 100 described above, the coil introducing mechanism 30 is provided. The center axis shifting unit 310 is provided in the coil introducing mechanism 30, and the center axis shifting unit 310 shifts the coil center axis position Oc of the helical coil drawn out of the coil forming mechanism 20 to the coil rotation axis position Oc′ when the binding mechanism 40 rotates and inserts the helical coil into the paper stack 3, by the coil accommodating unit corresponding to the coil diameter.

Therefore, the center axis shifting unit 310 can absorb the positional deviation amount between the coil center axis position Oc of the helical coil drawn out of the coil forming mechanism 20 and the coil rotation axis position Oc′ of the helical coil in the binding mechanism 40 caused by the difference in the pitch formation amount α. Therefore, helical coils having different coil diameters can be consistently introduced into the binding mechanism 40 by the coil accommodating units 311 to 314 of the center axis shifting unit 310 selected in correspondence with the coil diameter.

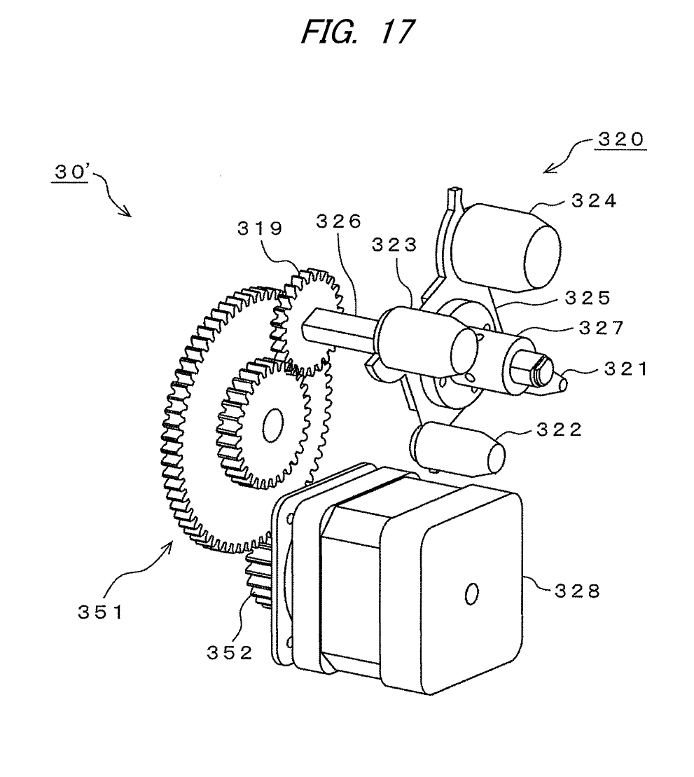

Subsequently, an example of a configuration of a coil introducing mechanism 30′ according to a first modification will be described with reference to FIGS. 17 to 21. Similar to the coil introducing mechanism 30, the coil introducing mechanism 30′ shown in FIG. 17 also absorbs the positional deviation amount generated between the coil center axis position Oc corresponding to each coil diameter shown in FIG. 8A and the coil rotation axis position Oc′ corresponding to each coil diameter shown in FIG. 8B, so as to shift the coil center axis position Oc to the coil rotation axis position Oc′. The coil introducing mechanism 30′ includes the small gear 319, a rotary-type center axis shifting unit 320, the deceleration gear 351, and a motor 328 for revolver selection. The motor 328 is disposed on a helical-coil receiving side. The motor 328 may be a stepping motor.

The center axis shifting unit 320 includes, for example, a rotary plate 325 (a rotary base) having arc-shaped portions on respective corner portions of a rectangle (hereinafter, the shape is referred to as a deformed cross shape), a flange unit 327, and four revolver units 321 to 324, and is operable to select one of the revolver units 321 to 324 having a thickness corresponding to the coil diameter of the helical coil. The four revolver units 321 to 324 are examples of rod-shaped members (coil receivers).

Each of the revolver units 321 to 324 has a thickness designed to externally wind the helical coil drawn out of the coil forming mechanism 20. For example, the revolver unit 321 is set such that the center position of the cross section thereof coincides with the coil rotation axis position Oc′ when the binding mechanism 40 binds the paper stack with the helical coil 11a having the diameter of 8 mm, and functions to receive the helical coil 11a drawn out of the coil forming mechanism 20 and to introduce the helical coil 11a to the binding mechanism 40.

Similarly, the revolver unit 322 is set such that the center position of the cross section thereof coincides with the coil rotation axis position Oc′ when the binding mechanism 40 binds paper stack with the helical coil 11b having the diameter of 12 mm, and functions to receive the helical coil 11b and to introduce the helical coil 11b to the binding mechanism 40.

The revolver unit 323 is set such that the center position of the cross section thereof coincides with the coil rotation axis position Oc′ when the binding mechanism 40 binds paper stack with the helical coil 11c having the diameter of 16 mm, and functions to receive the helical coil 11c and to introduce the helical coil 11c to the binding mechanism 40. The revolver unit 324 is set such that the center position of the cross section thereof coincides with the coil rotation axis position Oc′ when the binding mechanism 40 binds paper stack with the helical coil 11d having the diameter of 20 mm, and functions to receive the helical coil 11d and to introduce the helical coil 11d to the binding mechanism 40.

Each of the revolver units 321 to 324 is attached to the rotary plate 325 on binding mechanism side so as to protrude in a reverse direction to the coil forwarding direction. Each fore end portion of the revolver units 321 to 324 is chamfered like a warhead section. Chamfering is for making it easy to insert helical coils 11a, 11b, 11c, 11d having the predetermined coil diameters into each of the revolver units 321 to 324, respectively.

The rotary plate 325 has a shape obtained by cutting a metal plate such as a light metal plate, an iron plate, or the like into a deformed cross shape. The rotary plate 325 having the revolver units 321 to 324 attached thereto is attached to the flange unit 327. The flange unit 327 is attached and fixed to a rotation shaft 326.

In this example, the rotation shaft 326 having the flange unit 327 attached thereto is rotatably attached to the left plate 4a of the apparatus main body 101 shown in FIG. 1. For example, the small gear 319 is attached to the rotation shaft 326 of the center axis shifting unit 320. The small gear 319 is engaged with the deceleration gear 351. The deceleration gear 351 is engaged with the motor gear 352 attached to a motor shaft. The motor 328 is attached to the left plate 4a of the apparatus main body 101.

The motor 328 rotates around a motor shaft in response to a driving signal S328 and is driven when selecting the revolver unit 321 or the like corresponding to the coil diameter of the helical coil drawn out of the coil forming mechanism 20. Since a block diagram of FIG. 64 shows a case of applying the center axis shifting unit 310, when applying the center axis shifting unit 320, the motor 318 of FIG. 64 can be regarded as the motor 328 and driving signal S318 of FIG. 64 can be regarded as driving signal S328.

Accordingly, for example, the helical coil 11a having the diameter of 8 mm drawn out of the coil forming mechanism 20 is received by the revolver unit 321 and is drawn from the revolver unit 321 to the binding mechanism 40. Guide surfaces 371, 372, 373, 374 are formed in the rotary plate 325 described above.

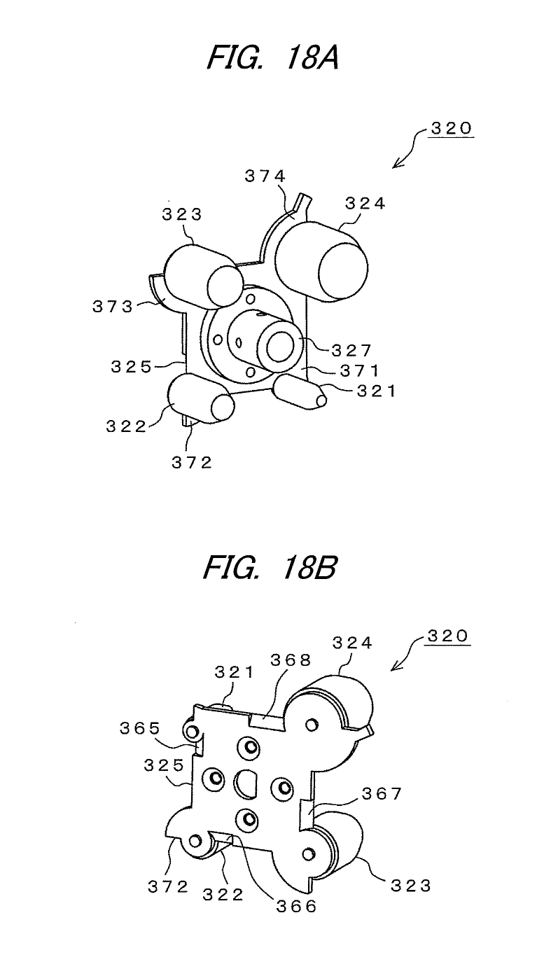

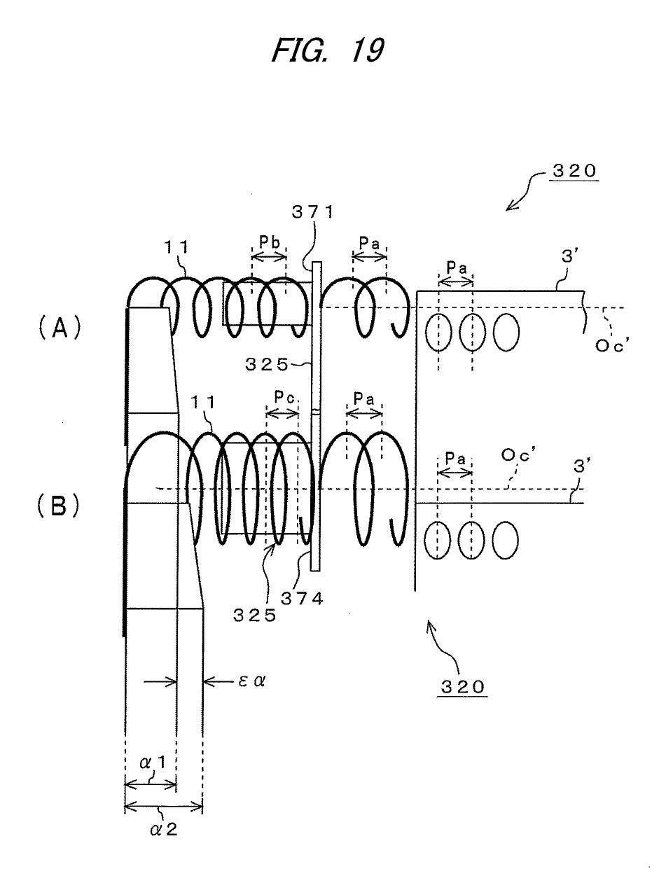

Subsequently, an example of the function of the guide surfaces of the center axis shifting unit 320 will be described with reference to FIGS. 18A, 18B, and 19. The center axis shifting unit 320 shown in FIG. 18A is in a state in which the rotary plate 325 having the revolver units 321 to 324 attached thereto has been removed from the rotation shaft 326 shown in FIG. 17. The rotary plate 325 having the deformed cross shape has four guide surfaces 371, 372, 373, 374 corresponding to four kinds of coil diameters. The guide surface 371 is formed in the revolver unit 321 to correct the difference of the pitch formation amount α.

For example, the guide surface 371 is provided in the rotary plate 325 on the rear side (a downstream side) of the revolver unit 321, and corrects the difference of the pitch formation amount α of the small-diameter helical coil 11a having the diameter of 8 mm. The difference of the pitch formation amount α is a difference in the coil formation position between helical coils having different coil diameters such as helical coils 11a and 11b, helical coils 11b and 11c, helical coils 11c and 11d, and helical coils 11d and 11a. The guide surface 371 has a protrusion portion that becomes an outlet of the helical coil.

This configuration of absorbing the difference of the pitch formation amount α by the guide surface 371 has a function to compress the helical coil 11a to align the helical coil 11a to the passing position. This function makes it possible to performing correction so as to reduce the coil pitch within an elastic deformation range of the helical coil 11a when passing by the guide surface 371, such that the positional relationship between the coil forming mechanism 20 and the binding mechanism 40 can be constantly maintained.

Similarly, the guide surface 372 is provided in the rotary plate 325 on the rear side of the revolver unit 322, and corrects the difference of the pitch formation amount α of the middle-diameter helical coil 11b having the diameter of 12 mm. The guide surface 373 is provided in the rotary plate 325 on the rear side of the revolver unit 323, and corrects the difference of the pitch formation amount α of the large-diameter helical coil 11c having the diameter of 16 mm. The guide surface 374 is provided in the rotary plate 325 on the rear side of the revolver unit 324, and corrects the difference of the pitch formation amount α of the super-large-diameter helical coil 11d having the diameter of 20 mm.

As shown in FIG. 18B, in the rotary plate 325 as seen from the rear side, the shape of the rotary plate 325 on the rear side of the revolver unit 321 has a semi-circular shape. On the opposite side of the rotary plate 325 to the semi-circular portion, a straight-edged inclined portion 365 is formed. The inclined portion 365 constitutes an outlet of the revolver unit 321 and is provided to smoothen the movement of the helical coil 11a having the diameter of 8 mm.

The shape of the rotary plate 325 on the rear side of the revolver unit 322 has a beak shape which is a combination of a semi-circular shape and a 90° (π/2) arc shape. On the opposite side of the rotary plate 325 to the beak-shaped portion, a straight-edged inclined portion 366 is formed. The inclined portion 366 constitutes an outlet of the revolver unit 322 and is provided to smoothen the movement of the helical coil 11b having the diameter of 12 mm.

The shape of the rotary plate 325 on the rear side of the revolver unit 323 has a beak shape which is a combination of a semi-circular shape and a 90° (π/2) arc shape. On the opposite side of the rotary plate 325 to the beak-shaped portion, a straight-edged inclined portion 367 is formed. The inclined portion 367 constitutes an outlet of the revolver unit 323 and is provided to smoothen the movement of the helical coil 11c having the diameter of 16 mm.

The shape of the rotary plate 325 on the rear side of the revolver unit 324 has a beak shape which is a combination of a semi-circular shape and a 90° (m/2) arc shape. On the opposite side of the rotary plate 325 to the beak-shaped portion, a straight-edged inclined portion 368 is formed. The inclined portion 368 constitutes an outlet of the revolver unit 324 and is provided to smoothen the movement of the helical coil 11d having the diameter of 20 mm.

As described above, the guide surface 371 is formed in the revolver unit 321 introducing the small-diameter helical coil 11a having the diameter of 8 mm, the guide surface 372 is formed in the revolver unit 322 introducing the middle-diameter helical coil 11b having the diameter of 12 mm, the guide surface 373 is formed in the revolver unit 323 introducing the large-diameter helical coil 11c having the diameter of 16 mm, and the guide surface 374 is formed in the revolver unit 324 introducing the super-large-diameter helical coil 11d having the diameter of 20 mm. As a result, the coil fore-end portion can pass through the same position after moving beyond the guide surfaces 371, 372, 373, 374, regardless of the coil diameters.

As a result, the helical coil in which the difference of the pitch formation amount α has been corrected by the guide surfaces 371, 372, 373, 374 of the rotary plate 325 of the center axis shifting unit 320 can be consistently introduced to the binding mechanism 40.

In the center axis shifting unit 320 shown in (A) of FIG. 19, the small-diameter helical coil 11a having the diameter of 8 mm is brought into contact with the guide surface 371 (a reference wall surface) and deforms the helical coil 11a within the elastic deformation range. Then, the movement distance of the helical coil 11a in the coil forwarding direction by a received formation torque is adjusted.

Similarly, the super-large-diameter helical coil 11d having the diameter of 20 mm shown in (B) of FIG. 19 is brought into contact with the guide surface 374 (a reference wall surface) and deforms the helical coil 11d within the elastic deformation range. Then, the movement distance of the helical coil 11d in the coil forwarding direction is adjusted.

Here, when an arrangement pitch of the punch holes 3a of the paper stack 3 is denoted by Pa, the coil pitch of the small-diameter helical coil 11a having the diameter of 8 mm is denoted by Pb, and the coil pitch of the super-large-diameter helical coil 11d having the diameter of 20 mm is denoted by Pc, a relationship of Pb<Pa is established between the pitch Pa of the punch holes 3a and the coil pitch Pb. Further, a relationship of Pc<Pa is established between the pitch Pa of punch holes 3a and the coil pitch Pc.

Since the wire 1 is fed to the same position of the coil forming mechanism 20 during coil forming, the coil center axis position Oc of the helical coil 11a having the diameter of 8 mm and the coil center axis position Oc of the helical coil 11d having the diameter of 20 mm are different from each other. Further, the difference of the pitch formation amount α shown in (B) of FIG. 19 is generated. If the difference of the pitch formation amount α is denoted by εα, when the pitch formation amount of the helical coil 11a is denoted by α1 and the pitch formation amount of the helical coil 11d is denoted by α2, difference εα is obtained from the difference α2−α1 between the pitch formation amount α2 and the pitch formation amount α1.

In the first modification of the present disclosure, the coil introducing mechanism 30′ is provided between the coil forming mechanism 20 and the binding mechanism 40 to absorb the positional deviation between the coil center axis position Oc corresponding to each coil diameter in the coil forming mechanism 20 and the coil rotation axis position Oc′ corresponding to each coil diameter in the binding mechanism 40 by the center axis shifting unit 320.

As a result, even when springiness of spring coils 11a, 11b, 11c, 11d having four kinds of diameters of 8 mm, 12 mm, 16 mm, and 20 mm are different from one another, and for example, as shown in (B) of FIG. 19, difference εα of the pitch formation amount α is generated between the pitch formation amount α1 of the helical coil 11a having the diameter of 8 mm and the pitch formation amount α2 of the helical coil 11d having the diameter of 20 mm (when the pitch formation amount differs according to the coil diameter), it is possible to absorb the positional deviation between the coil center axis position Oc in the coil forming mechanism 20 and the coil rotation axis position Oc′ in the binding mechanism 40 by the center axis shifting unit 320, and make the coil pitch Pc equal to the pitch Pa of the paper stack 3 after the outlet of the guide surface 371.

Similarly, with respect to the other guide surfaces 372 to 374, it is possible to absorb the positional deviation between the coil center axis position Oc and the coil rotation axis position Oc′, and make the coil pitch Pc equal to the pitch Pa of the paper stack 3. Therefore, the positional relationship between the coil forming mechanism 20 and the binding mechanism 40 are constantly maintained.

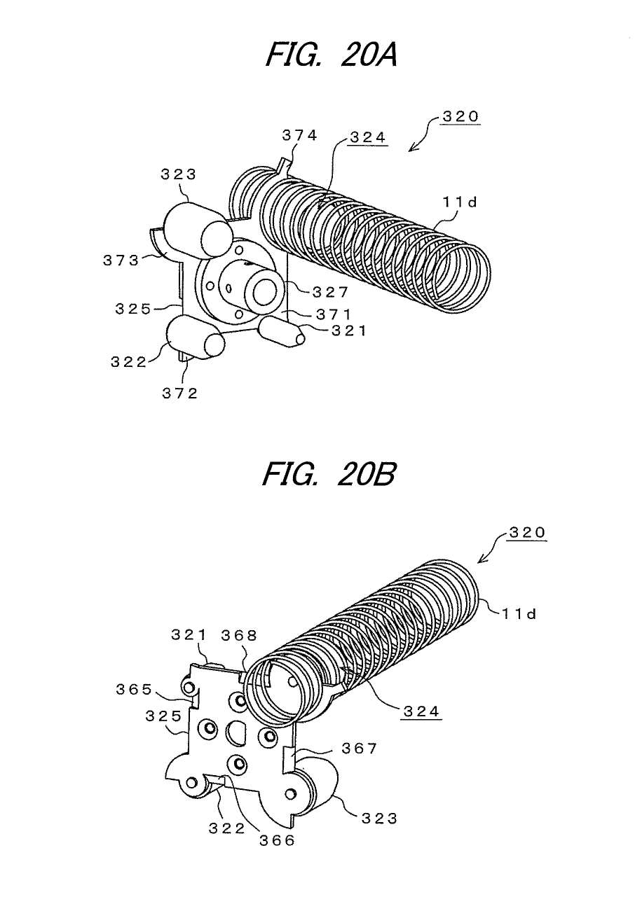

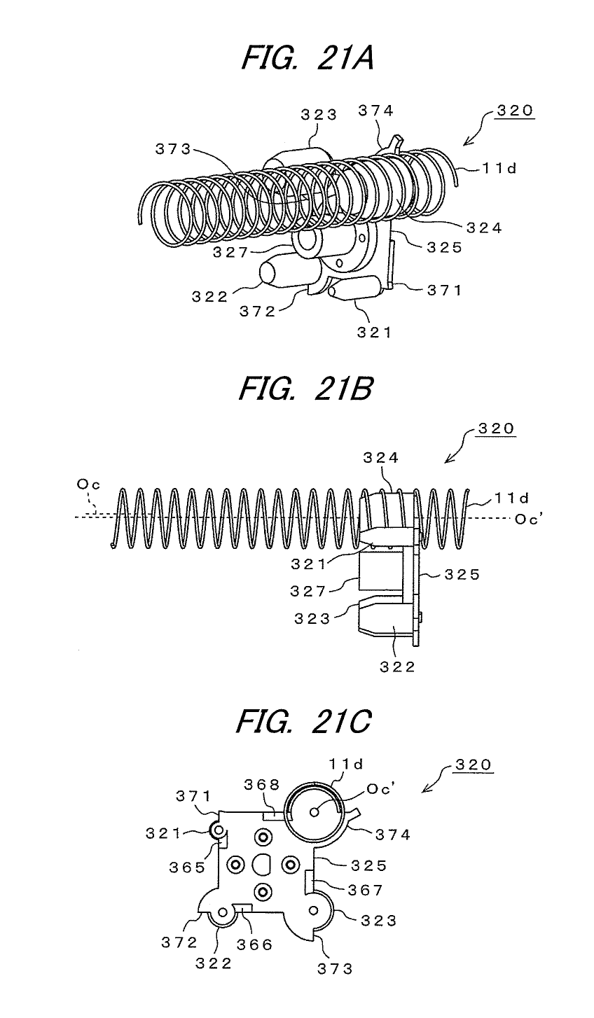

Subsequently, an example of an operation of the center axis shifting unit 320 will be described with reference to FIGS. 20A, 20B, and 21. FIG. 20A shows a case of the center axis shifting unit 320 in which the revolver unit 324 is selected in a state in which the rotary plate 325 having the four revolver units 321 to 324 attached thereto is removed from the rotation shaft 326 shown in FIG. 17. This case represents a state in which the super-large-diameter helical coil 11d having the diameter of 20 mm has passed through the guide surface 374 of the revolver unit 324.

In this case, the guide surface 374 formed in the revolver unit 324 functions to correct difference εα of the pitch formation amount α and draw the helical coil 11d. FIG. 20B shows the center axis shifting unit 320 when the rotary plate 325 is obliquely seen from the rear side. In this case, the helical coil 11d receives a formation torque, and advances while rotating with the guide surface 374 of the revolver unit 324 interposed therein.

FIGS. 21A to 21C are perspective views illustrating an example of an operation of the center axis shifting unit 320 when the coil is introduced and guided as seen from different angles. As shown in FIG. 21A, in a case where the center axis shifting unit 320 is seen from a side, even when a positional deviation is generated between the coil center axis position Oc in the coil forming mechanism 20 and the coil rotation axis position Oc′ in the binding mechanism 40, since the center axis shifting unit 320 of the coil introducing mechanism 30′ provided between the coil forming mechanism 20 and the binding mechanism 40 shifts the coil center axis position Oc shown in FIG. 21B to the coil rotation axis position Oc′, it is possible to absorb the positional deviation between the coil center axis position Oc and the coil rotation axis position Oc′. The coil rotation axis position Oc′ shown in FIG. 21C is set to correspond to the coil rotation axis position Oc′ when the binding mechanism 40 rotates the fore-end portion of the helical coil to insert the fore-end portion of the helical coil into punch holes 3a of the paper stack 3.

As described above, the coil binding apparatus 100 according to the exemplary embodiments of the present disclosure includes the coil introducing mechanism 30 or the coil introducing mechanism 30′. The center axis shifting unit 320 is provided in the coil introducing mechanism 30′, and the center axis shifting unit 320 shifts the coil center axis position Oc of the helical coil drawn out of the coil forming mechanism 20 to the coil rotation axis position Oc′ when the helical coil is rotated and inserted into the paper stack 3 in the binding mechanism 40, by the revolver unit 321 or the like. As a result, it is possible to consistently introduce helical coils having different coil diameters to the binding mechanism 40 by the revolver units 321 to 324 of the center axis shifting unit 320 selected in correspondence with the coil diameters.

Therefore, it is possible to absorb the positional deviation amount between the coil center axis position Oc of the spring coil drawn out of the coil forming mechanism 20 and the coil rotation axis position Oc′ of the spring coil in the binding mechanism 40, caused by difference εα in the pitch formation amount α, by the center axis shifting unit 320. It is possible to consistently introduce the spring coils having different coil diameters to the binding mechanism 40 by the revolver units 321 to 324 of the center axis shifting unit 320 selected in correspondence with the coil diameters.

As a result, it is possible to omit time for moving the binding mechanism 40 with respect to the coil forming mechanism 20 or moving the coil forming mechanism 20 with respect to the binding mechanism 40 to match the coil center axis position Oc of the spring coil drawn out of the coil forming mechanism 20 with the coil center axis position Oc′ of the spring coil in the binding mechanism 40. Therefore, it is possible to compactly adjust difference εα of the pitch formation amount α by the center axis shifting unit 310 or 320, as compared to a case of moving the coil forming mechanism 20 with respect to the binding mechanism 40 to adjust the positional relationship.

Subsequently, a layout of the binding mechanism 40 will be described with reference to FIG. 22. On the downstream side of the coil introducing mechanism 30 shown in FIG. 22, the binding mechanism 40 is provided to receive the helical coil with the predetermined coil diameter formed by the coil forming mechanism 20 through the coil introducing mechanism 30 and bind the paper stack 3 as shown in FIG. 2 with the helical coil.

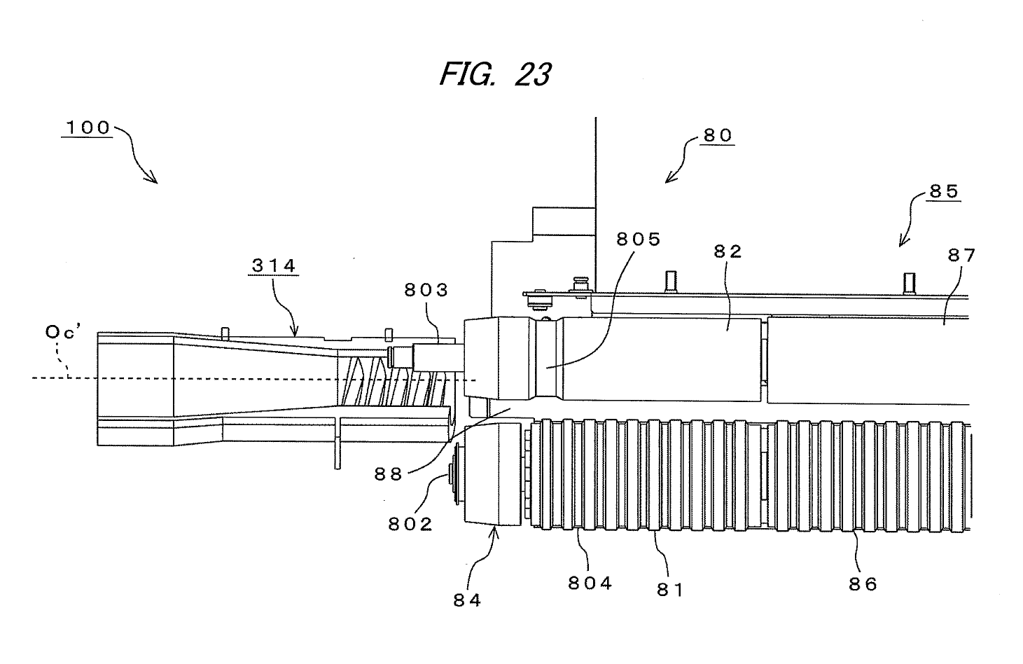

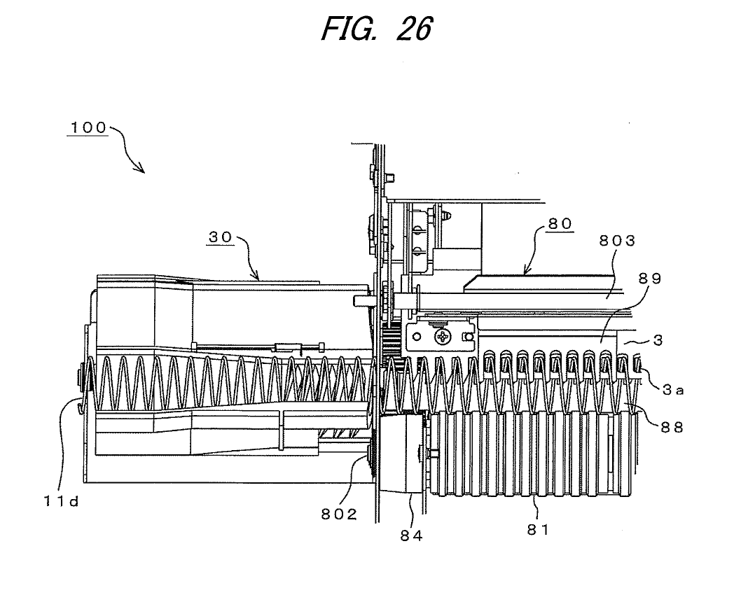

In this example, the binding mechanism 40 includes the coil-fore-end inserting section 80 and the coil transferring section 85. The coil-fore-end inserting section 80 includes at least the metal roller 81, a resin roller 82, and the planar member 88, receives the helical coil drawn out of the coil forming mechanism 20 through the coil introducing mechanism 30, and inserts the fore-end portion of the helical coil into the first punch hole 3a of the paper stack 3 (see FIGS. 23 and 26).

In this example, the coil transferring section 85 is provided in the binding mechanism 40 to be close to the coil-fore-end inserting section 80. The coil transferring section 85 includes a metal roller 86 and a resin roller 87 brought into contact with the outer circumference of the helical coil, and a planar member 88 shared with the coil-fore-end inserting section 80. The metal roller 86 regulates the insertion position of the coil fore-end portion in the movement direction of the helical coil. The resin roller 87 maintains the posture in the movement direction of the helical coil.

The coil transferring section 85 rotatably drives (transfers) the helical coil such that the helical coil is inserted into the first punch hole 3a of the paper stack 3 by the coil-fore-end inserting section 80 and is cut by the coil forming mechanism 20, and the fore-end portion of the helical coil having lost the formation torque is guided up to the last punch hole 3a of the paper stack 3.

Subsequently, an example of a configuration of the coil-fore-end inserting section 80 will be described with reference to FIG. 23. The coil-fore-end inserting section 80 shown in FIG. 23 includes a metal roller 81, a resin roller 82, and the planar member 88. The planar member 88 is commonly used by the coil-fore-end inserting section 80 and the coil transferring section 85.

The metal roller 81 is one of the two roller members, and is brought into contact with the outer circumference of the helical coil to function to restrict the insertion position of the coil fore-end portion of the helical coil into punch holes 3a of the paper stack 3. The metal roller 81 may be a metal roller having a plurality of the grooves 804 in the outer circumference. The metal roller 81 is fit on a shaft unit 802 and rotates freely.

On the upstream side (a coil introducing mechanism side) of the metal roller 81 described above, a guide roller 84 is rotatably joined with the shaft unit 802. The guide roller 84 may be a resin roller. The leading portion of the guide roller 84 has a truncated cone shape. At a position facing the guide roller 84, the resin roller 82 is provided having an almost same truncated cone shape as that of the leading portion of the guide roller 84.

The guide roller 84 is driven to rotate together with the resin roller 82 by the formation torque of the helical coil. In this example, the truncated-cone-shaped leading portion of the guide roller 84 and the truncated-cone-shaped leading portion of the resin roller 82 picks up the fore-end portion of the helical coil with respect to the binding mechanism 40. The resin roller 82 constitutes the other one of the two roller members, and is brought into contact with the outer circumference of the helical coil to function to maintain the insertion posture in the movement direction of the helical coil.

The resin roller 82 has grooves 805 formed in the outer circumference. The resin roller 82 is fit on and rotates freely supported by a shaft unit 803. The grooves 805 are provided to absorb an elasticity which the resin roller 82 receives from the fore-end portion of the helical coil during coil guide.

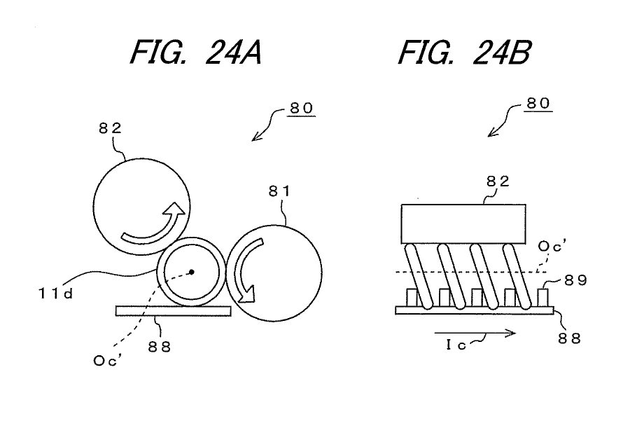

In this example, the metal roller 81 and the resin roller 82 are rotated together by the formation torque of the helical coil as shown in FIG. 24A. The formation torque of the helical coil is generated when the coil forming mechanism 20 forms the wire 1 for a coil and draws the helical coil.

In the binding mechanism 40, in the first half of a binding process, the helical coil is inserted into the paper stack 3 by using the formation torque. In the second half of the binding process, since the helical coil is separated from the wire 1 by the coil forming mechanism 20 to lose the above-mentioned formation torque, the helical coil is inserted into the paper stack 3 by using the coil transferring section 85 shown in FIG. 23.

The planar member 88 supports three points of the helical coil in a coil diameter direction together with the metal roller 81 and the resin roller 82, as shown in FIG. 24A. In this example, when the helical coil moves in a direction from the front surface of the drawing sheet to the back surface thereof, when the helical coil rotates clockwise, the metal roller 81 and the resin roller 82 rotate counterclockwise.

The planar member 88 functions to determine the position of the helical coil and maintain the coil movement posture of the helical coil together with the metal roller 81 and the resin roller 82. On the planar member 88 shown in FIG. 24B, a comb-tooth arrangement unit 89 is provided, such that the resin roller 82 presses the outer circumference of the helical coil into tooth portions of the comb-tooth arrangement unit 89. In FIG. 24B, the helical coil moves from the left to the right. This is represented as a coil forwarding direction Ic in FIG. 24B.

According to this configuration, after the posture of the helical coil is stabilized by the metal roller 81 and the resin roller 82, the metal roller 81 establishes a function of determining the position of the helical coil in the circumferential direction so as to determine the coil center axis position (not shown) of the helical coil to the coil rotation axis position Oc′ as the fore-end portion of the helical coil approaches the first punch hole 3a of the paper stack 3.

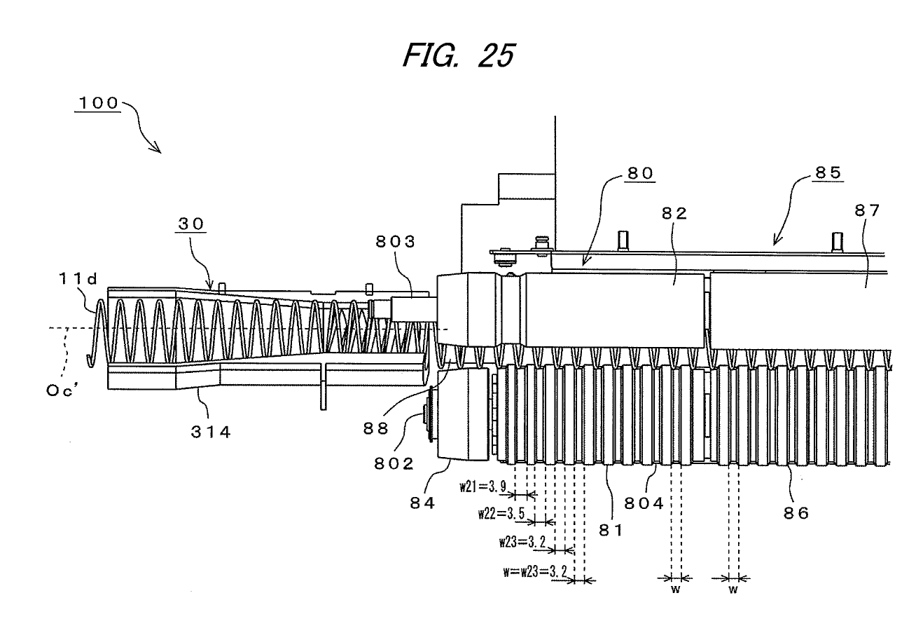

Subsequently, a function of determining the position of the helical coil in a pitch direction by the metal roller 81 will be described with reference to FIGS. 25 and 26. According to an example of the position determining function of the metal roller 81 shown in FIG. 25, at least one of the metal roller 81 and the resin roller 82, the metal roller 81 in this example, has grooves 804 in the outer circumference, and has the function of determining the position of the helical coil in the pitch direction when the fore-end portion of the helical coil as shown in FIG. 26 is inserted into the punch holes 3a (see FIG. 22) of the paper stack 3.

In this example, when the widths of the grooves 804 of the metal roller 81 on a side from which the helical coil is sent to the coil transferring section 85 are denoted by w and the pick-up width of a groove 804 of the metal roller 81 on a side receiving the helical coil from the coil introducing mechanism 30 is denoted by w21, the pick-up width w21 is set to be larger than the width w of the grooves 804 on the helical-coil sending side.

For example, the pick-up width w21 is set to about 3.9 mm, a pick-up width w22 is set to about 3.5 mm, and a pick-up width w23 is set to about 3.2 mm. Widths w of the next the grooves 804 on the side from which the helical coil is sent to the coil transferring section 85 are set to 3.2 mm (=w23). Therefore, the coil fore-end portion of the helical coil can be guided to punch holes 3a of the paper stack 3 such that the pick-up width w21 gradually decreases to be constant the pick-up width w23 on the way.

Further, on the planar member 88 of the coil-fore-end inserting section 80 shown in FIG. 26, the comb-tooth arrangement unit 89, an example of a notch member, is formed. FIG. 26 shows the coil-fore-end inserting section 80 in which the resin roller 82 has been removed from the shaft unit 803.

The comb-tooth arrangement unit 89 is provided at a fore-end portion of the paper holding unit 32. The paper holding unit 32 is formed in the paper stack aligning unit 36 described above, such that the paper stack 3 having aligned punch holes 3a are mounted on the paper holding unit 32. In an edge portion of one side of the comb-tooth arrangement unit 89, a plurality of comb-tooth-type notch portions for coil guide are formed with almost the same layout pitch as the layout pitch of punch holes 3a of the paper stack 3. The comb-tooth arrangement unit 89 is formed by performing a clipping process on an iron plate.

The comb-tooth arrangement unit 89 functions to fix the paper stack 3 from the above when the coil is inserted. For example, in a case where punch holes 3a of the paper stack 3 are aligned by the paper stack aligning unit 36, the comb-tooth arrangement unit 89 is opened, such that the paper stack 3 is free, and the paper stack 3 is temporarily held in the paper holding unit 32.

Next, the paper stack 3 having punch holes 3a aligned to some extent by the paper stack aligning unit 36 is set from the paper holding unit 32 to the binding mechanism 40, punch holes 3a are obliquely aligned by an pin inclination and insertion mechanism (not shown), and then the comb-tooth arrangement unit 89 is operable to pin down the paper stack 3 from the above. Therefore, the helical coil can be stably inserted into punch holes 3a of the paper stack 3.

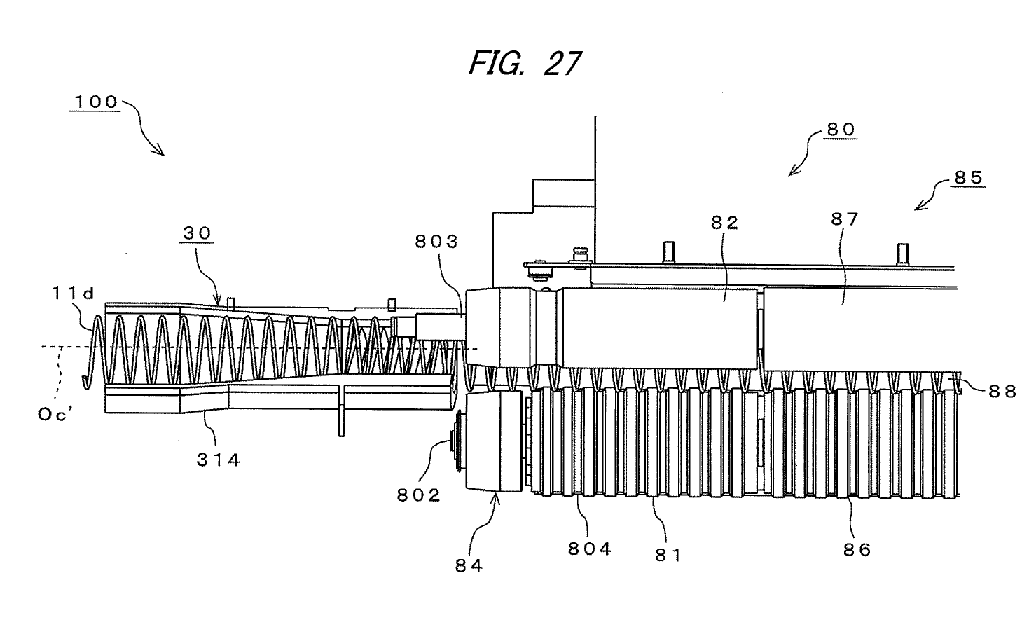

Subsequently, an example of an operation of the coil-fore-end inserting section 80 will be described with reference to FIG. 27. According to the coil-fore-end inserting section 80 shown in FIG. 27, in a state in which the paper stack 3 is pinned down from the above by the comb-tooth arrangement unit 89 shown in FIG. 26, the helical coil drawn out of the coil introducing mechanism 30 enters the coil-fore-end inserting section 80. In the coil-fore-end inserting section 80, the metal roller 81 and the resin roller 82 are driven to rotate together by the formation torque of the helical coil so as to rotate as shown in FIG. 24A.

Further, the metal roller 81 and the comb-tooth arrangement unit 89 guide the coil fore-end portion of the helical coil and insert the coil fore-end portion into the first punch hole 3a of the paper stack 3 in cooperation with each other. Moreover, the coil fore-end portion of the helical coil is continued from the coil-fore-end inserting section 80 to the coil transferring section 85 by the formation torque of the helical coil.

Then, since the helical coil is separated from the wire 1 in the coil forming mechanism 20, such that the above-mentioned helical coil loses the formation torque, in the coil transferring section 85, the metal roller 81 and the resin roller 82 are driven to rotate and operate to insert the fore-end portion of the helical coil into last punch hole 3a of the paper stack 3 in cooperation with the planar member 88.

As described above, the coil-fore-end inserting section 80 according to the exemplary embodiment of the present disclosure has a configuration in which widths w of the grooves 804 of the metal roller 81 gradually decrease like pick-up widths (from w21 to w23) to reach the arrangement pitch of the punch holes 3a of the paper stack 3, such that the coil pitch is matched. According to this configuration, the fore-end portion of the helical coil drawn out of the coil forming mechanism 20 and picked up and put into the coil-fore-end inserting section 80 by the coil introducing mechanism 30 can be consistently inserted into the first punch hole 3a of the paper stack 3.

Accordingly, the fore-end portion of the helical coil inserted into the first punch hole 3a of the paper stack 3 can be smoothly inserted into second and following punch holes 3a of the paper stack 3. Therefore, it is possible to improve insertion stability of the coil fore-end portion when the fore-end portion of the helical coil is inserted into punch holes 3a of the paper stack 3, thereby providing the binding mechanism 40 having high reliability.

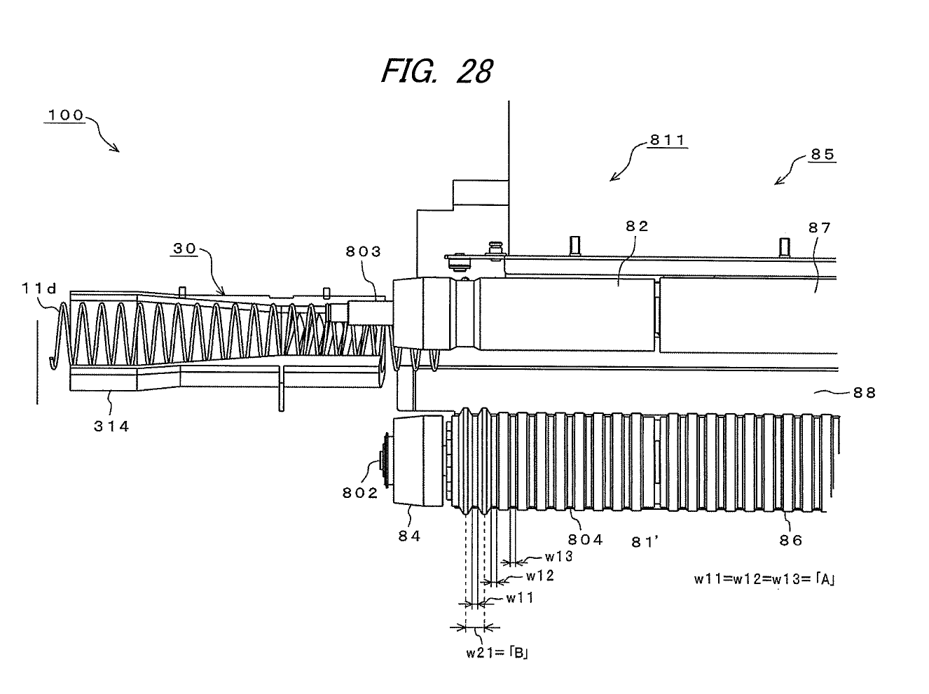

Subsequently, an example of a configuration of a coil-fore-end inserting section 811 according to a second modification will be described with reference to FIG. 28. The coil-fore-end inserting section 811 shown in FIG. 28 includes a metal roller 81′, the resin roller 82, the guide roller 84, and the planar member 88. When the widths (hereinafter, referred to as groove base widths) of bases of the grooves 804 of the metal roller 81′ are denoted by w11, w12, w13, all of the groove base widths w11, w12, w13 are set to a constant value ‘A’.

The metal roller 81′ shown in the coil-fore-end inserting section 811 is open right in front of the resin roller 82 (in a direction in which the paper stack 3 having both edges unprocessed descends). Further, components having the same reference symbols and names as those described with respect to the coil-fore-end inserting section 80 have the same functions as those described with respect to the coil-fore-end inserting section 80, and thus a description thereof is omitted.

In this example, the pick-up width w21 of first the groove 804 of the metal roller 81′ adjacent to the guide roller 84 is set to ‘B’ larger than the pick-up width w21 of the metal roller 81. Further, both peaks defining the groove 804 in the metal roller 81′ are set to be higher than those in the metal roller 81. Setting both peaks of the groove 804 of the metal roller 81′ to be higher is for making it easy to pick up the fore-end portion of the helical coil as compared to the metal roller 81.

In this example, the pick-up width w21 of the groove 804 on the helical-coil receiving side, the pick-up width of the groove 804 on the way, and the width w of groove on the helical-coil sending side are set to the same the pick-up width w21. Further, the layout pitch of the grooves 804 is set to be almost equal to the layout pitch of punch holes 3a of the paper stack 3.

The coil-fore-end inserting section 811 easily receives the helical coil without gradually decreasing pick-up widths w21 and the like as described above with respect to the coil-fore-end inserting section 80. Therefore, in the coil-fore-end inserting section 811, in an early stage, it is possible to determine the position of the fore-end portion of the helical coil from the first punch hole 3a of the paper stack 3 in an early stage.

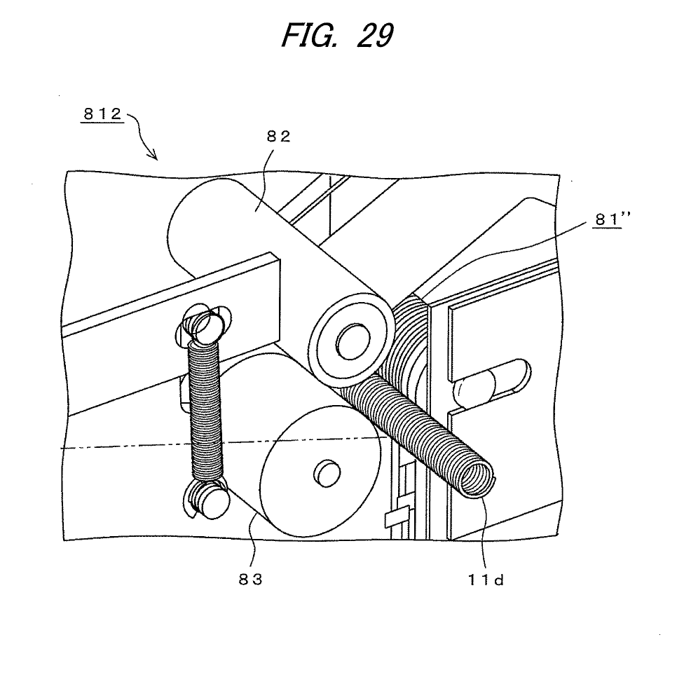

Subsequently, the coil-fore-end inserting section 812 according to a third modification will be described with reference to FIGS. 29 to 31. The coil-fore-end inserting section 812 shown in FIG. 29 includes at least three rollers, for example, a metal roller 81″ having a divided structure, the resin roller 82, and a resin roller 83, and is brought into contact with the outer circumference of the helical coil to maintain the insertion posture in the movement direction of the helical coil.

The resin roller 83 is disposed at a position capable of supporting the helical coil from obliquely below the helical coil, for example, on the inside of the left plate 4a shown in FIG. 1.

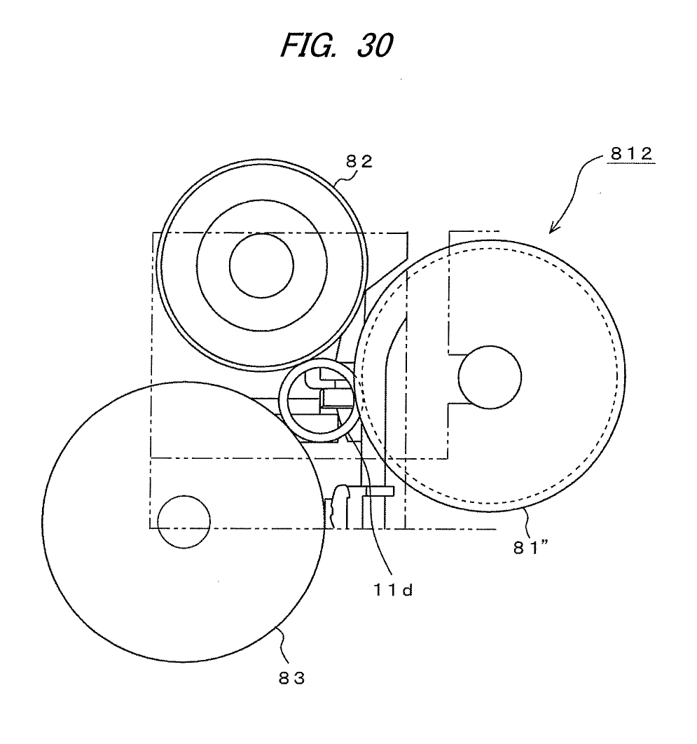

In this example, as shown in FIG. 30, the helical coil are supported at three points by the metal roller 81″, the resin roller 82, and the resin roller 83. For example, the metal roller 81″ horizontally presses the helical coil from the right side. The resin roller 82 presses the helical coil from the upper left side to the lower right side. The resin roller 83 presses the helical coil from the lower left side to the upper right side. As described above, the helical coil is supported at three points, such that the coil movement posture of the helical coil is stabilized.

Also in this example, the metal roller 81″, the resin roller 82, and the resin roller 83 function to be rotated together by the formation torque of the helical coil. The formation torque of the helical coil is generated when the coil forming mechanism 20 forms the wire 1 for a coil and draws the helical coil.

When a distance from an outlet of the coil introducing mechanism 30 shown in FIG. 28 to the first punch hole 3a of the paper stack 3 is set to be long in a design, the helical coil is stably guided and inserted into the first punch hole 3a of the paper stack 3 by three-point support of the roller members.

Therefore, it is possible to accurately determine the position of the helical coil in the circumferential direction by the metal roller 81″, the resin roller 82, and the resin roller 83 without interrupting the movement of the helical coil.

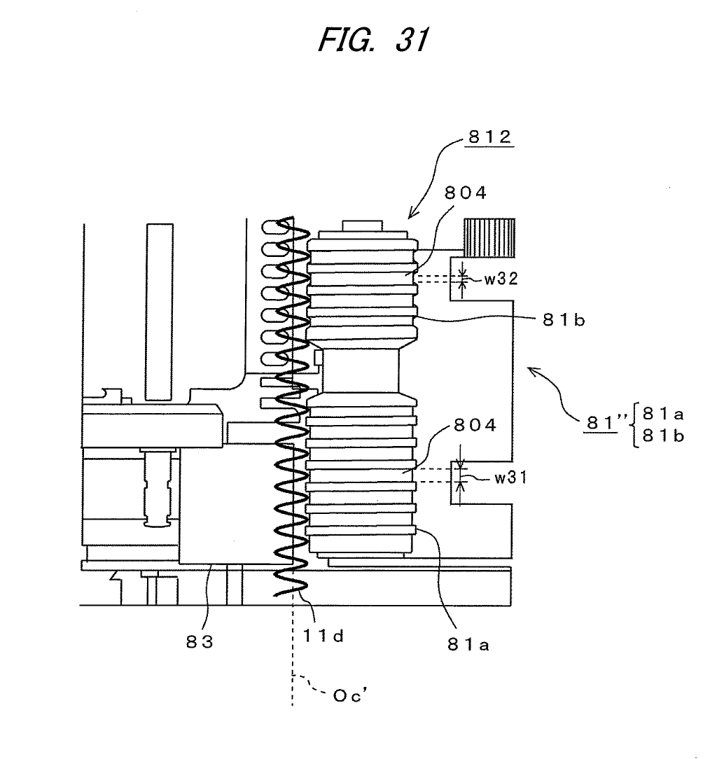

Subsequently, an example of the divided structure of the metal roller 81″ will be described with reference to FIG. 31. The metal roller 81 shown in FIG. 31 is divided into two parts along the shaft unit 802 and has the metal rollers 81a, 81b. Each of the metal rollers 81a, 81b has the grooves 804 in the outer circumference, and has a function of determining the position in the pitch direction when the fore-end portion of the helical coil is inserted into punch holes 3a of the paper stack 3. Each of the metal rollers 81a, 81b is correlatively rotated by the formation torque of the helical coil.

The metal roller 81a is a roller member on the side receiving the helical coil from the coil introducing mechanism 30. The groove width of the grooves 804 of the metal roller 81a is denoted by w31. The metal roller 81b is a roller member on the side sending the helical coil to the coil transferring section 85. The groove width of the grooves 804 of the metal roller 81b is denoted by w32. In order to improve the helical-coil pick-up characteristic, the groove width w31 of the metal roller 81a is set to be larger than groove width w32 of the metal roller 81b. Groove width w32 of the metal roller 81b is set to be small to match with the layout intervals of punch holes 3a of the paper stack 3.

By using the divided structure of the metal roller 81″, it is possible to absorb a rotation error between the metal roller 81a on the helical-coil receiving side and the metal roller 81b on the helical-coil sending side when the metal rollers 81a, 81b rotate together. Even in this example, in the metal roller 81a having a pitch-direction-position determining function, the widths of the grooves 804 on the helical-coil receiving side is set to be gradually decreased and the width of the final groove is set to be almost equal to the width w32 of the grooves 804 on the helical-coil sending side.

When the coil-fore-end inserting section 812 is configured as described above, after the coil center axis position Oc of the helical coil is stabilized by the metal roller 81a, the resin roller 82, and the resin roller 83, the position of the fore-end portion of the helical coil is determined by the pitch-direction-position determining function of the metal roller 81a as the fore-end portion of the helical coil approaches the first punch hole 3a of the paper stack 3. Further, the coil fore-end portion of the helical coil is continued from the metal roller 81b of the coil-fore-end inserting section 812 to the coil transferring section 85 by the formation torque of the helical coil.

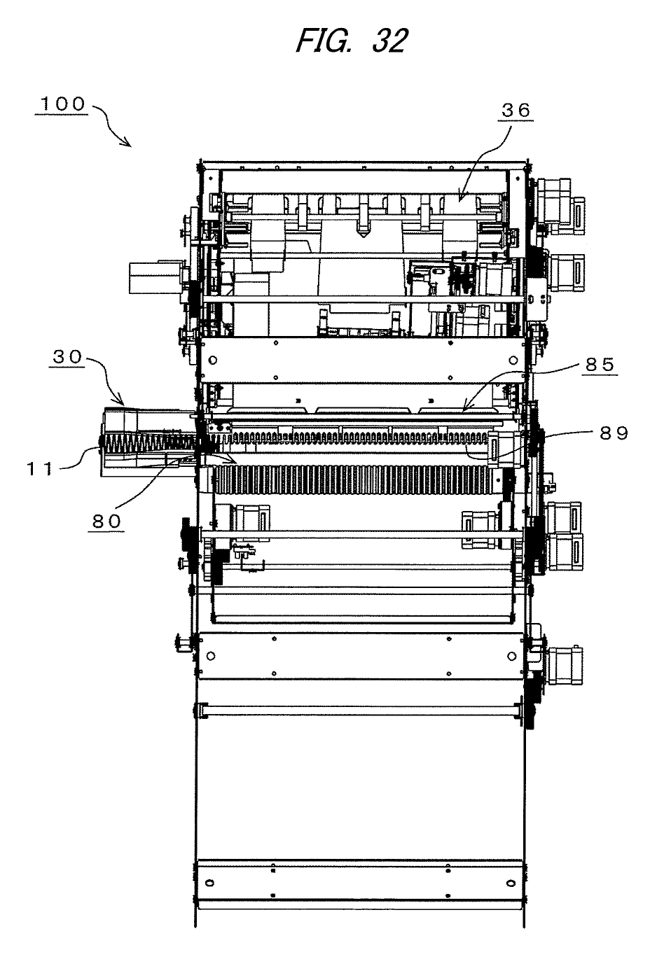

Subsequently, a layout of the binding mechanism 40, an example of a configuration of a driving source thereof, and an example of a function thereof will be described with reference to FIGS. 32 to 34. The binding mechanism 40 shown in FIG. 32 is disposed below the paper stack aligning unit 36. The binding mechanism 40 includes the coil transferring section 85. The coil transferring section 85 shows a state in which the resin roller 82 and the resin roller 87 have been removed from the shaft unit 803. In this state, it can be seen that five comb-tooth arrangement units 89 are disposed on a straight line below the paper stack aligning unit 36.

In this example, on the basis of the total length of the length of the metal roller 81 of the coil-fore-end inserting section 80 plus the length of the metal roller 86 of the coil transferring section 85, the length of the metal roller 86 of the coil transferring section 85 occupies about ¾ of the total length. Similarly, the length of the resin roller 87 also occupies about ¾ of the total length (the length of the resin roller 82 plus the length of the resin roller 87).

In the coil transferring section 85, the metal roller 86 and the resin roller 87 having those lengths can be driven to rotate and insert the coil fore-end portion of the helical coil, separated from the wire 1 by the coil forming mechanism 20 so as to lose the formation torque, up to last punch hole 3a of the paper stack 3 in cooperation with the planar member 88 and comb-tooth arrangement units 89 described above.

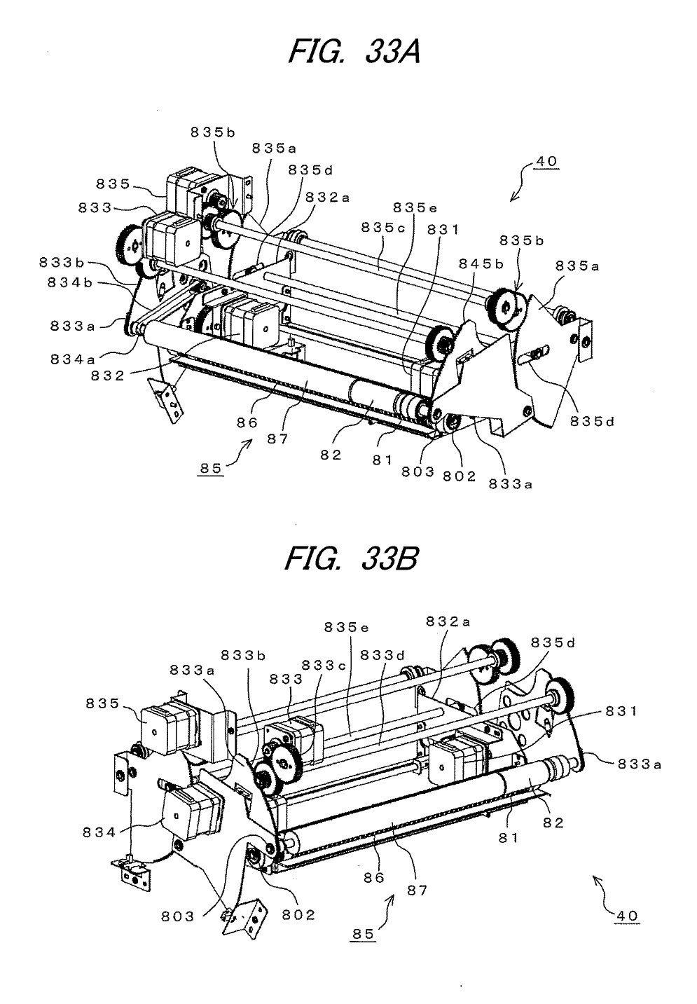

Here, an example of a configuration of the driving source of the binding mechanism 40 will be described with reference to FIGS. 33A and 33B. The binding mechanism 40 shown in FIGS. 33A and 33B are driven by five motors 831 to 835. The motor 831 is attached to first movable plates 832a having metal rollers 81, 86 attached thereto. The motor 831 rotates a motor shaft in response to a driving signal S831 to move the movable plates 832a within a movement allowance range, thereby controlling the positions of the metal rollers 81, 86.

A connecting rod 835e is disposed between the movable plates 832a, such that the movable plates 832a are movably attached to fan-shaped (arc-shaped) movable gears 835a through the connecting rod 835e. Long holes 835d defining the above-mentioned movement allowance range are formed in the movable gears 835a, and the connecting rod 835e described above is movably provided in the long holes 835d. The positions of the metal rollers 81, 86 are controlled by using the long holes 835d of movable gears 835a.

The motor 832 rotating the metal roller 86 of the coil transferring section 85 is attached to the movable plate 832a. The motor 832 rotates a motor shaft in response to a driving signal S832 and is driven when rotating the metal roller 86. A gear (not shown) is attached to an end portion of the metal roller 86 and the torque of the motor 832 is transmitted to the gear through a motor gear.

The motor 833 for controlling the positions of resin rollers 82, 87 is attached to a second movable plate 833a. The motor 833 rotates a motor shaft in response to a driving signal S833 and rotates the resin rollers 82, 87. An arc-shaped gear 833b is mounted on the movable plate 833a. This gear 833b is engaged with a deceleration gear 833c, and the torque of the motor 833 is transmitted to the deceleration gear 833c through a shaft unit 833d.

The motor 834 rotating the resin roller 87 of the coil transferring section 85 is attached to the movable plate 833a. The motor 834 rotates a motor shaft in response to a driving signal S834 and is driven when rotating the resin roller 87. A pulley 834a is attached to an end portion of the resin roller 87 and the torque of the motor 834 is transmitted to pulley 834a through a belt 834b.

In the binding mechanism 40, the motor 835 for a transfer assembly (hereinafter, a transfer ASSY) is attached. The motor 835 rotates a motor shaft in response to a driving signal S835 and is driven when retreating the metal rollers 81, 86 from a binding work area of the paper stack 3 bound with the helical coil.

Regarding the motor 835, each of the movable gears 835a described above is engaged with deceleration gears 835b, and the torque of the motor 835 is transmitted to the deceleration gears 835b through a shaft unit 835c. Fan-shaped movable gears 835a are rotated to retreat the movable plates 832a having the metal rollers 81, 86 attached thereto. Each of the motors 831 to 835 may be a stepping motor. They serve as the driving source of the binding mechanism 40.

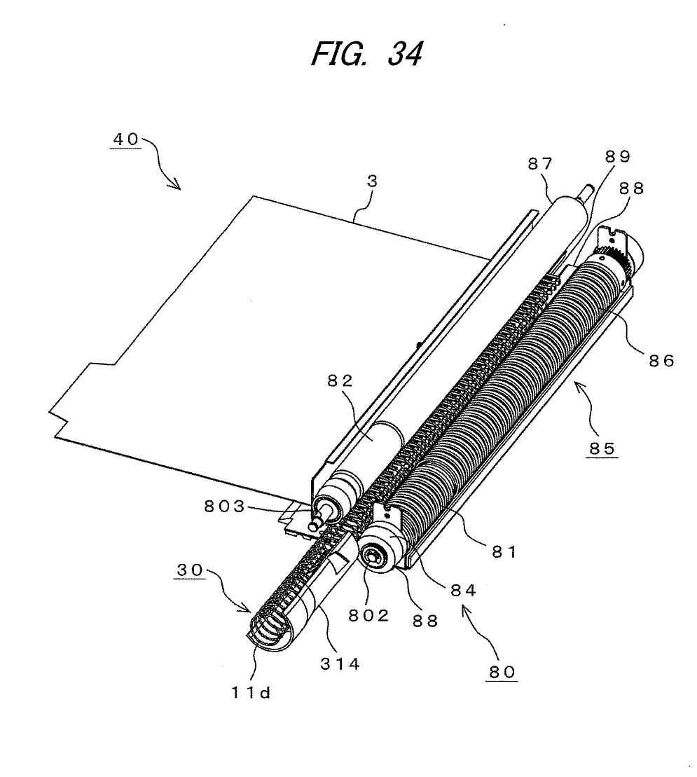

According to the binding mechanism 40 shown in FIG. 34, the coil-fore-end inserting section 80 inserts the helical coil received from the coil introducing mechanism 30 into the first punch hole 3a of the paper stack 3. In this case, the metal roller 81 of the coil-fore-end inserting section 80 has the grooves 804 in the outer circumferential surface and fulfills the pitch-direction-position determining function when inserting the fore-end portion of the helical coil into punch holes 3a of the paper stack 3. For example, since the metal roller 81 and the resin roller 82 are correlatively rotated by the formation torque of the helical coil, the metal roller 81 and the resin roller 82 can determine the position into the first punch hole 3a without resisting the helical coil.

Accordingly, the fore-end portion of the helical coil is inserted into and passes through the first punch hole 3a of the paper stack 3. Next, the coil transferring section 85 receives the helical coil sequentially inserted into punch holes 3a of the paper stack 3 and rotates (transfers) the fore-end portion of the cut helical coil to guide the fore-end portion to last punch hole 3a of the paper stack 3.

If the binding mechanism 40 is configured as described above, the helical coil can be smoothly inserted into second and following punch holes 3a of the paper stack 3 by the metal roller 86, the resin roller 87 of the coil transferring section 85, and one the planar member 88, without interrupting the movement of the helical coil. Therefore, it is possible to consistently and smoothly bind the paper stack 3 with the helical coil.

Further, it is possible to transfer and stop the helical coil at any time by the coil transferring section 85 while maintaining a sliding-resistance reducing measure based on the rotation of the metal roller 86 having the pitch-direction-position determining function. Accordingly, since it is possible to transfer and stop the helical coil at any time, the coil transferring section 85 can stop at end positions of paper stacks 3 having a plurality of paper sizes and thus can deal with booklets having an A4 size, a B4 size, an A5 size, a B5 size, or the like.

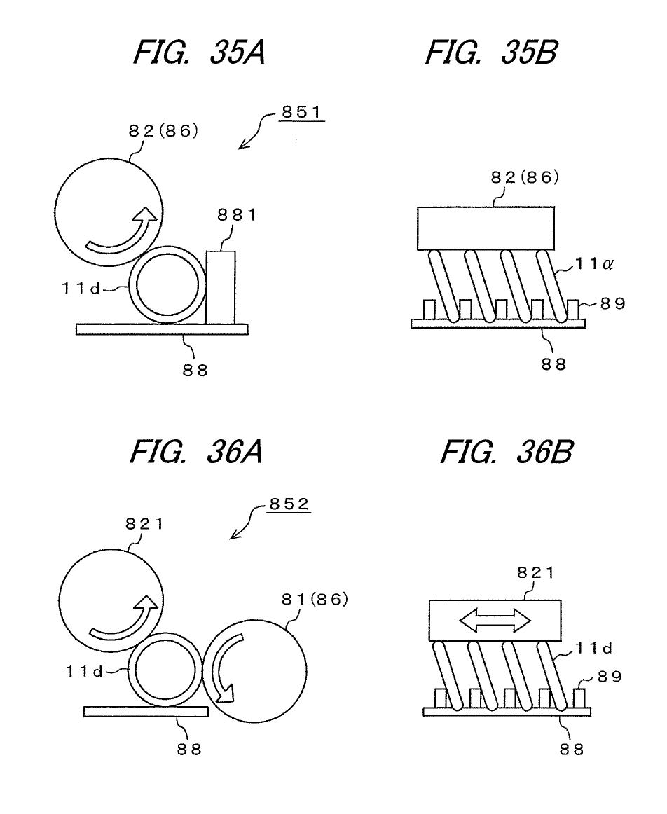

A coil transferring section 851 according to a fourth modification will be described with reference to FIGS. 35A and 35B. The coil transferring section 851 shown in FIGS. 35A and 35B is applicable to the binding mechanism 40, and includes one the resin roller 87 and two planar members 88 and 881 brought into contact with the outer circumference of the helical coil to maintain the insertion posture in the movement direction of the helical coil. The coil transferring section 851 is driven to guide and transfer the fore-end portion of the helical coil inserted into the first punch hole 3a of the paper stack 3 to last punch hole 3a of the paper stack 3.

In this example, the coil transferring section 851 inserts the helical coil into the comb-tooth arrangement unit 89 shown in FIG. 35B, and rotates one the resin roller 87 while supporting the helical coil to be slidably moveable by two planar members 88 and 881, thereby transferring the helical coil.

If the coil transferring section 851 is configured as described above, it is possible to smoothly insert the helical coil into second and following punch holes 3a of the paper stack 3 by one the resin roller 87 and two planar members 88 and 881 without interrupting the movement of the helical coil by the resin roller 87. Therefore, it is possible to perform a binding processing by consistently and smoothly inserting the helical coil into punch holes 3a of the paper stack 3.

Subsequently, the coil transferring section 852 according to a fifth modification will be described with reference to FIGS. 36A and 36B. The coil transferring section 852 shown in FIG. 36A is applicable to the binding mechanism 40, and includes a resin roller 821 having a moving function, and the metal roller 81 and one planar member 88 having position determining and adjusting functions.

The resin roller 821 shown in FIG. 36B is brought into contact with the outer circumference of the helical coil, and moves in the coil forwarding direction along the shaft unit 803 while maintaining the insertion posture in the movement direction of the helical coil. For example, the resin roller 821 uses a screw movement manner in which screw type the groove 804 of the metal roller 86 moves by one pitch when the helical coil rotates once. In the screw movement manner, since the groove 804 rotates, the groove 804 resists the helical coil 11d.

If the coil transferring section 852 is configured as described above, it is possible to insert the fore-end portion of the helical coil inserted into the first punch hole 3a of the paper stack 3 to last punch hole 3a of the paper stack 3 by the resin roller 821, the metal roller 86, and the planar member 88. Therefore, it is possible to perform a binding process by consistently and smoothly inserting the helical coil into punch holes 3a of the paper stack 3.

The resin rollers 82, 83, 87, 821 described above may be rubber rollers using a rubber-based material in consideration of sliding movement, fraction, and the like with the helical coil.

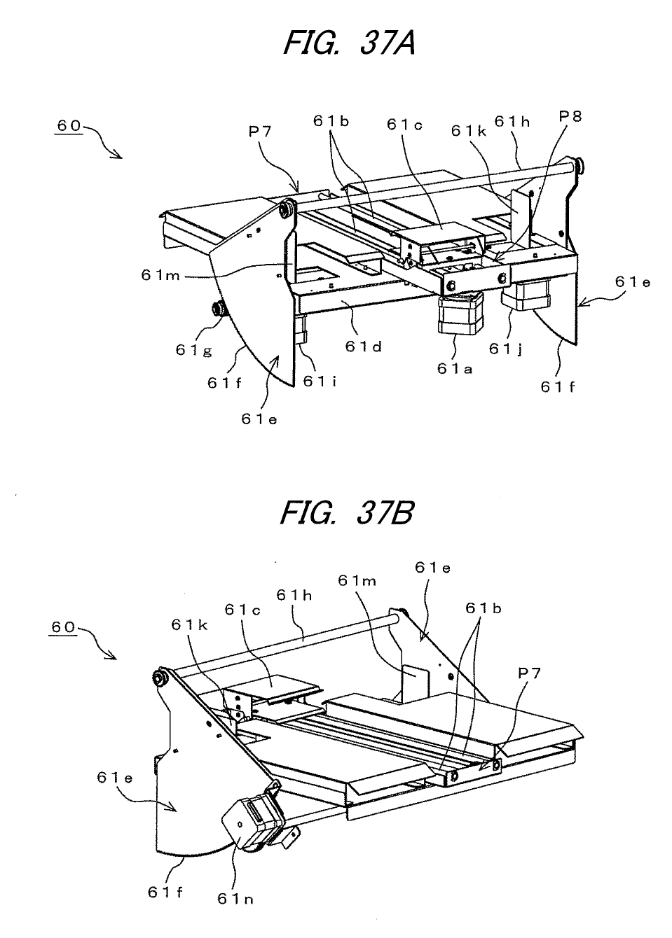

Subsequently, the paper stack transferring mechanism 60 will be described. FIGS. 37A and 37B are perspective views illustrating an example of a configuration of the paper stack transferring mechanism 60. The paper stack transferring mechanism 60 has a pick-up function of receiving the paper stack 3 from the binding mechanism 40 and a paper-sheet aligning function of aligning the paper stack 3. The paper stack transferring mechanism 60 includes a main body 61d for mounting the paper stack 3 and fan plates 61e attached to both sides of the main body 61d and having an almost fan shape. In arc portions of the fan plates 61e, gear cutting portions 61f are formed. The gear cutting portions 61f are engaged with gears 61g. The gears 61g are rotated by a motor 61n for a transfer position control, such that the fan plates 61e and the main body 61d rotates around a shaft 61h serving as a rotating axis.

In order to perform the pick-up function, the paper stack transferring mechanism 60 includes a motor 61a for pick-up, guide rods 61b, and a pickup 61c. The pickup 61c is slidably attached to the guide rods 61b, and is fixed to and driven by a belt (not shown) rotated by the motor 61a. For example, the pickup 61c advances from the lowermost position P8 shown in FIG. 37A and moves to the uppermost position P7. The pickup 61c stands by at uppermost position P7 and grasps the helical coil 11d side (the side where the helical coil 11d has inserted) of the paper stack 3 provided from the binding mechanism 40. After grasping the helical coil 11d side of the paper stack 3, the pickup 61c retreats from uppermost position P7 and moves to lowermost position P8.

In order to perform the paper-sheet aligning function of aligning the paper stack 3, the paper stack transferring mechanism 60 includes a motor 61i for paper-sheet alignment #1HP, a motor 61j for paper-sheet alignment #2HP, and substantially L-shaped plates 61k, 61m. The plate 61k is slidably attached to the main body 61d, and is fixed to and driven by a belt (not shown) rotated by the motor 61j. Further, the plate 61m is slidably attached to the main body 61d, and is fixed to and driven by a belt (not shown) rotated by the motor 61i. In this example, the distance between the plate 61k and the plate 61m is determined based on paper size information. The paper stack 3 sandwiched between the plates 61k, 61m and aligned is provided to the end processing unit 70.

Subsequently, the alignment pin mechanism 50 will be described. FIG. 38 is a front perspective view illustrating an example of a configuration of the alignment pin mechanism 50. FIG. 39 is a rear perspective view illustrating the example of the configuration of the alignment pin mechanism 50. The alignment pin mechanism 50 aligns punch holes 3a of the paper stack 3 in the helical-coil forwarding direction.

The alignment pin mechanism 50 includes two alignment pins 51, a motor 386, and female screw members 58, and vertically moves the alignment pins 51 by the driving force of the motor 386. For example, the alignment pins 51 are movably attached to a front panel 520 by the female screw members 58 and alignment pin sleeves 59 and 501.

A fore-end portion 51a of the alignment pin 51 is formed in an almost cone shape, and the size of a body 51b of the alignment pin 51 is set slightly smaller than the size of punch holes 3a of the paper stack 3. Therefore, when the alignment pin 51 is inserted into and passes through punch holes 3a of the paper stack 3, it is possible to move individual paper sheets of the paper stack 3 according to the alignment pin 51.

The alignment pin 51 is provided with a male screw 57. The male screw 57 is threadably joined with the female screw member 58. Further, a spur gear 56 is fixed to the alignment pin 51. The spur gear 56 is engaged with a cylindrical gear 55, and the cylindrical gear 55 is engaged with a spur gear 54. The spur gear 54 is engaged with a spur gear 53 fixed to a shaft of the motor 386.

According to this configuration, when the motor 386 is driven, the driving force of the motor 386 is transmitted to the alignment pin 51 through the spur gear 53, the spur gear 54, the cylindrical gear 55, and the spur gear 56. Accordingly, the alignment pin 51 rotates and the rotation is converted into a translational motion by the male screw 57 and the female screw member 58, such that the alignment pin 51 is guided to the alignment pin sleeves 501 and 59 and vertically moves.

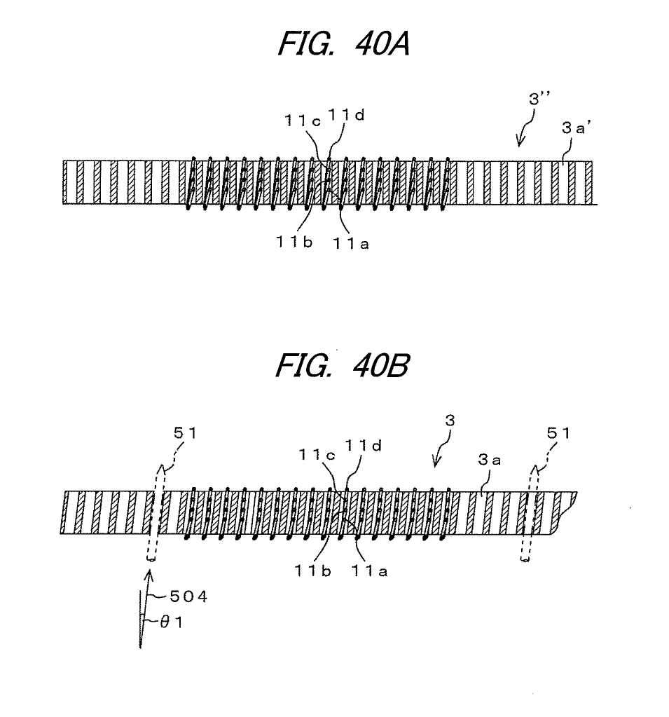

The movement direction of the alignment pin 51 is set to substantially the same direction as the movement direction of the helical coil in punch holes 3a of the paper stack 3. For example, as shown in FIG. 40B, a movement direction 504 of the alignment pin 51 is set such that an angle θ1 with respect to a vertical direction is 6° to 7°.

A range from the lowermost position to which the alignment pin 51 can descend to the uppermost position to which the alignment pin 51 can rise, that is, the operation range of the alignment pin 51 is about 40 mm. At the uppermost position of the alignment pin 51, as shown in FIG. 38, the alignment pin 51 protrudes from a gap in the comb-tooth arrangement unit 89. In this state, the alignment pin 51 passes through the punch holes 3a of the paper stack 3 having the largest thickness. At the lowermost position of the alignment pin 51, the alignment pin 51 is completely out of the gap of the comb-tooth arrangement unit 89. The alignment pins 51 are inserted into and pass through the punch holes 3a on both sides of the paper stack 3.

The alignment pin mechanism 50 first inserts the alignment pins 51 into the punch holes 3a of the paper stack 3 in a state where the paper stack 3 has not been clamped by the clamp moving mechanism 380. Next, the alignment pin mechanism 50 clamps the paper stack 3 by the clamp moving mechanism 380 in a state where the alignment pins 51 has been inserted into and passed through the punch holes 3a of the paper stack 3, and pulls the alignment pins 51 out of the punch holes 3a of the paper stack 3 in a state in which the paper stack 3 having the alignment pins 51 inserted therein has been clamped by the clamp moving mechanism 380.

FIG. 40A is a sectional view illustrating a coil insertion example according to the related art, and FIG. 40B is a sectional view illustrating a coil insertion example according to an exemplary embodiment of the present disclosure. According to the related art, punch holes 3a′ of a paper stack 3″ are aligned in a vertical direction as shown in FIG. 40A. In this example, the paper stack 3″ having the largest thickness is shown. The super-large-diameter helical coil is inserted into punch holes 3a′ of the paper stack 3″. In this example, coils having different diameters, that is, the small-diameter helical coil 11a, the middle-diameter helical coil 11b, and the large-diameter helical coil 11c are also shown at the same time.

Movement direction 504 of the alignment pins 51 shown in FIG. 40B is set such that angle θ1 with respect to a vertical direction is 6° to 7°. The alignment pins 51 are inserted into and pass through punch holes 3a′ of the paper stack 3 shown in FIG. 40A and form punch holes 3a of the paper stack 3 shown in FIG. 40B. Punch holes 3a of the paper stack 3 shown in FIG. 40B are aligned by the alignment pins 51 so as to be inclined at angle θ1 (6° to 7°) with respect to the vertical direction. The angle θ1 is set to be almost the same as the movement direction of the helical coils 11a, 11b, 11c, 11d in punch holes 3a of the paper stack 3. Accordingly, as compared to the paper stack 3″ of FIG. 40A, the paper stack 3 aligned as shown in FIG. 40B may have a wider clearance between the helical coil passing through punch holes 3a and inner walls of punch holes 3a. Therefore, the helical coils 11a, 11b, 11c, 11d passing through punch holes 3a do not come into contact with the inner walls of punch holes 3a and thus it is possible to prevent an insertion defect of helical coils 11a, 11b, 11c, 11d.

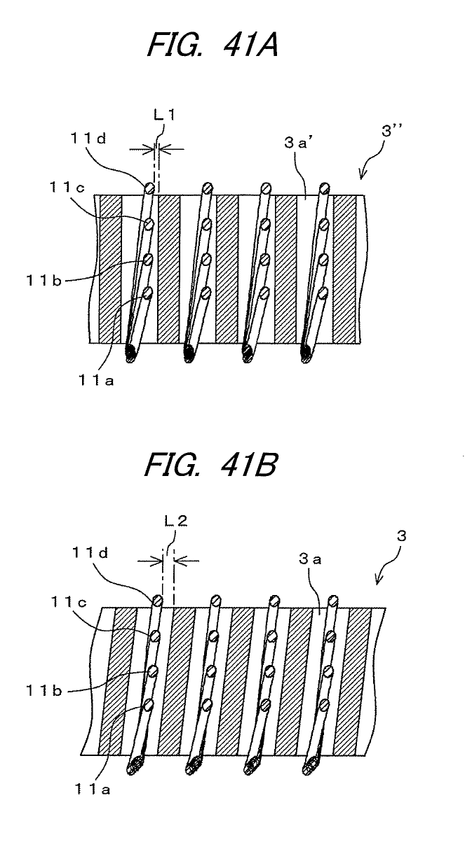

FIG. 41A is a sectional view illustrating an example of a clearance between the helical coils 11a, 11b, 11c, 11d and punch holes 3a′ according to the related art, and FIG. 41B is a sectional view illustrating an example of a clearance between the helical coils 11a, 11b, 11c, 11d and punch holes 3a according to an exemplary embodiment of the present disclosure. The clearance between the helical coils 11a, 11b, 11c, 11d and the punch holes 3a′ in FIG. 41A is a distance L1, and the clearance between the helical coils 11a, 11b, 11c, 11d and punch holes 3a in FIG. 41B is a distance L2. In this case, a relationship of distance L1 <distance L2 is established, and thus the paper stack 3 aligned to be inclined at the angle θ1 (6° to 7°) by the alignment pins 51 (see FIG. 40B) can have a wider clearance between the helical coils 11a, 11b, 11c, 11d and the punch holes 3a.

As described above, according to the alignment pin mechanism 50, at least two alignment pins 51 formed to be movable in almost the same direction as the movement direction of the helical coils 11a, 11b, 11c, 11d in the punch holes 3a of the paper stack 3 are inserted into and pass through the punch holes 3a of the paper stack 3.

According to this configuration, it is possible to automatically and accurately align the punch holes 3a of the paper stack 3 in an oblique direction in which the helical coils 11a, 11b, 11c, 11d moves. Accordingly, it is possible to take a wide clearance between the helical coils 11a, 11b, 11c, 11d passing through the punch holes 3a of the paper stack 3 and the inner walls of the punch holes 3a of the paper stack 3. Therefore, the helical coils 11a, 11b, 11c, 11d do not come into contact with the inner walls of the punch holes 3a and thus it is possible to prevent a defect in inserting the helical coils 11a, 11b, 11c, 11d.

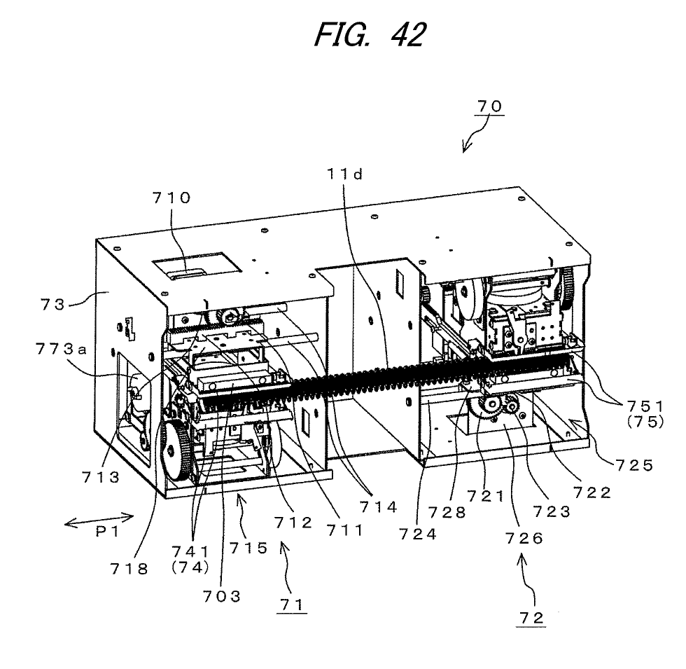

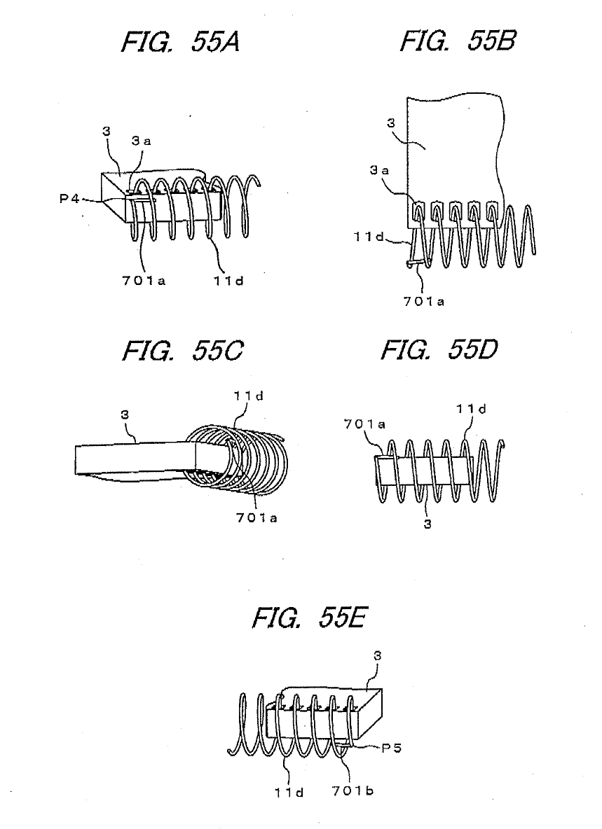

Subsequently, the end processing unit 70 will be described in detail. FIG. 42 is a perspective view illustrating an example of a configuration of the end processing unit 70. The end processing unit 70 shown in FIG. 42 includes an outlet-side end processing unit 71 and an inlet-side end processing unit 72 movably fixed to a case 73. The outlet-side end processing unit 71 and the inlet-side end processing unit 72 have substantially the same configuration. The inlet-side end processing unit 72 is fixed to the case 73 with being upside down with respect to the outlet-side end processing unit 71. This is because each of both end portions of the helical coil needs to be bent toward the inside of the helical coil. That is, the outlet-side end processing unit 71 bends an end portion of the helical coil like an the end portion 701a of a helical coil as shown in FIG. 55A, while the inlet-side end processing unit 72 bends an end portion like an the end portion 701b of a helical coil as shown in FIG. 55E. As described above, since it is possible to make the individual end processing units have substantially the same configuration by devising a method of disposing the outlet-side end processing unit 71 and the inlet-side end processing unit 72, it is possible to simplify machine design and manufacture.

The outlet-side end processing unit 71 and the inlet-side end processing unit 72 are attached in the case 73 to be movable in a direction (the longitudinal direction of the paper stack 3′) shown by an arrow P1, and moves in arrow direction P1 according to the paper size. This is because positions to process end portions of the helical coils 11a, 11b, 11c, 11d differ according to paper sizes.

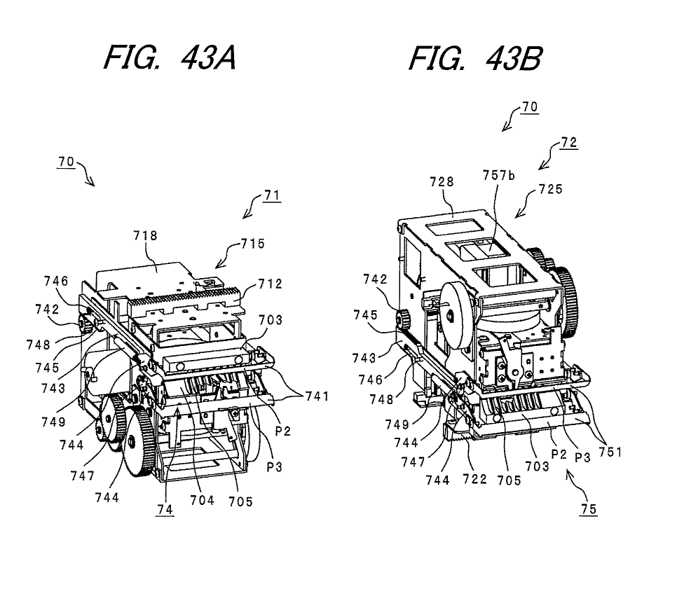

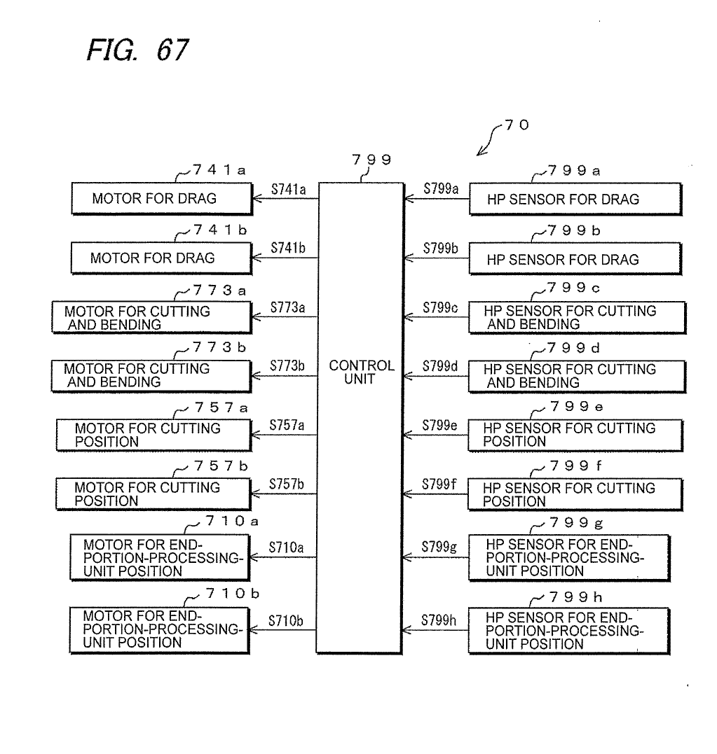

In this example, the outlet-side end processing unit 71 includes a motor 710a for end processing unit positioning (see FIG. 67), a spur gear 711, a rack 712, a motor gear 713, and guide rods 714. The motor 710a, the motor gear 713, and the spur gear 711 are fixed to the case 73. The motor gear 713 is engaged with the spur gear 711, and the spur gear 711 is engaged with the rack 712 in a form of a rack-and-pinion structure (see FIG. 43A).

A main body 715 of the outlet-side end processing unit 71 is movably attached to the guide rods 714. For example, the main body 715 of the outlet-side end processing unit 71 is slidably movable on the guide rods 714 inserted therein. The rack 712 fixed to a chassis 718 of the main body 715 is engaged with the spur gear 711.

According to this configuration, when the motor 710a is driven, the motor gear 713 and the spur gear 711 rotate. As the spur gear 711 rotates, a power is transmitted to the rack 712 engaged with the spur gear 711, such that the main body 715 of the outlet-side end processing unit 71 moves along the guide rods 714 in a left direction or a right direction shown by the arrow P1. Therefore, it is possible to move the outlet-side end processing unit 71 according to paper sizes.

Similarly, the inlet-side end processing unit 72 includes a motor 710b for end processing unit positioning (see FIG. 67), a spur gear 721, a rack 722, a motor gear 723, and a guide rail 724. The motor gear 723 and the spur gear 721 are fixed to a plate 726 of the case 73. The motor gear 723 is engaged with the spur gear 721 and the spur gear 721 is engaged with the rack 722 (see FIG. 43B).

A main body 725 of the inlet-side end processing unit 72 is movably attached to the guide rail 724. For example, the main body 725 of the inlet-side end processing unit 72 is slidably fit into the guide rail 724. The rack 722 fixed to the chassis 728 of the main body 725 is engaged with the spur gear 721.

According to this configuration, when the motor 710b is driven, the motor gear 723 and the spur gear 721 rotate. As the spur gear 721 rotates, a power is transmitted to the rack 722 engaged with the spur gear 721, such that the main body 725 of the inlet-side end processing unit 72 moves along the guide rail 724 in a left direction or a right direction shown by the arrow P1. Therefore, it is possible to move the inlet-side end processing unit 72 according to paper sizes.

The outlet-side end processing unit 71 includes a drag unit 74 closely drawing the helical coil. The drag unit 74 includes drag holding teeth 741. The body on one end side of the helical coil having both end portions unprocessed is inserted between the drag holding teeth 741 and the helical coil is closely drawn. Similarly, the inlet-side end processing unit 72 includes a drag unit 75 closely drawing the helical coil. The drag unit 75 includes drag holding teeth 751. The body on the other end side of the helical coil having both end portions unprocessed is inserted between the drag holding teeth 751 and the helical coil is closely drawn. The motion of the drag unit 74 is synchronized with the motion of the drag unit 75.

Subsequently, the drag units 74, 75 will be described in detail. FIGS. 43A and 43B are views illustrating states in which the case 73 of the end processing unit 70 of FIG. 42 has been removed. The drag unit 74 shown in FIG. 43A includes a motor 741a for dragging (see FIG. 67), a spur gear 742, arms 743, and links 744, in addition to the upper and lower drag holding teeth 741. In this example, both arms 743 have the same configuration and are attached on respective sides of a chassis 718 (see FIG. 43B).

Each of the arms 743 is slidably attached on the chassis 718. For example, a gear cutting portion 745 and a long hole 746 are formed in the arm 743, and the long hole 746 is slidably attached on the chassis 718 by a bolt 748. Another long hole is formed in the arm 743. The gear cutting portion 745 of the arm 743 is engaged with the spur gear 742 in a form of a rack-and-pinion structure. The arm 743 is pulled on the rear side (the long hole 746 side) by a spring 749.

At a fore-end of the arm 743, the links 744 are attached. The upper and lower links 744 have shafts at the rear ends, respectively, and are pulled in directions facing each other by a spring 747. The drag holding teeth 741 are fixed to the links 744. Upper and lower drag holding teeth 741 are formed by bending a linear metal plate in a rectangular shape. The rectangular drag holding teeth 741 have receiving surfaces P2, P3 receiving the helical coil formed to be inclined with respect to the movement direction of the helical coil, respectively. Accordingly, when the helical coil is brought into contact with the receiving surfaces P2, P3 and is pressed down, the upper and lower drag holding teeth 741 rotate in opposite directions to each other.

When the motor 741a (see FIG. 67) is driven, the spur gear 742 rotates and thus the arm 743 engaged with the spur gear 742 moves along the long hole 746. For example, in an advanced state, the drag unit 74 receives the paper stack 3 having the helical coil inserted therein from the paper stack transferring mechanism 60 by the drag holding teeth 741. In this case, the helical coil is pressed down between the receiving surface P2 of upper drag holding tooth 741 and the receiving surface P3 of lower drag holding tooth 741, and the upper and lower drag holding teeth 741 rotate in opposite directions to each other to be opened. Next, when the helical coil is completely pressed between the upper and lower drag holding teeth 741, the drag holding teeth 741 are closely pulled by a tensile force of spring 747 to be closed and insert the helical coil.

The drag unit 74 rotates the spur gear 742 with the helical coil inserted therein so as to retreat the arm 743 engaged with the spur gear 742 along the long hole 746. The helical coil retreated by the drag unit 74 comes into contact with a coil receiving member 703 so as to be positioned as shown in FIG. 42. The coil receiving member 703 is fixed to a chassis 728 and includes a half-pipe unit 704 coming into contact with and receiving the helical coil. In the half-pipe unit 704, a plurality of divider members 705 disposed in correspondence with the pitch of the helical coil are provided, and the helical coil is disposed between the divider member 705 and the other divider member 705. Therefore, it is possible to maintain the position and posture of the helical coil and thus it is possible to smoothly perform the next cutting and bending process.

Since the inlet-side end processing unit 72 has a configuration obtained by simply turning the layout of the outlet-side end processing unit 71 upside down, the drag unit 75 has the same configuration as the drag unit 74 described above. Therefore, a detailed description of the drag unit 75 is omitted.

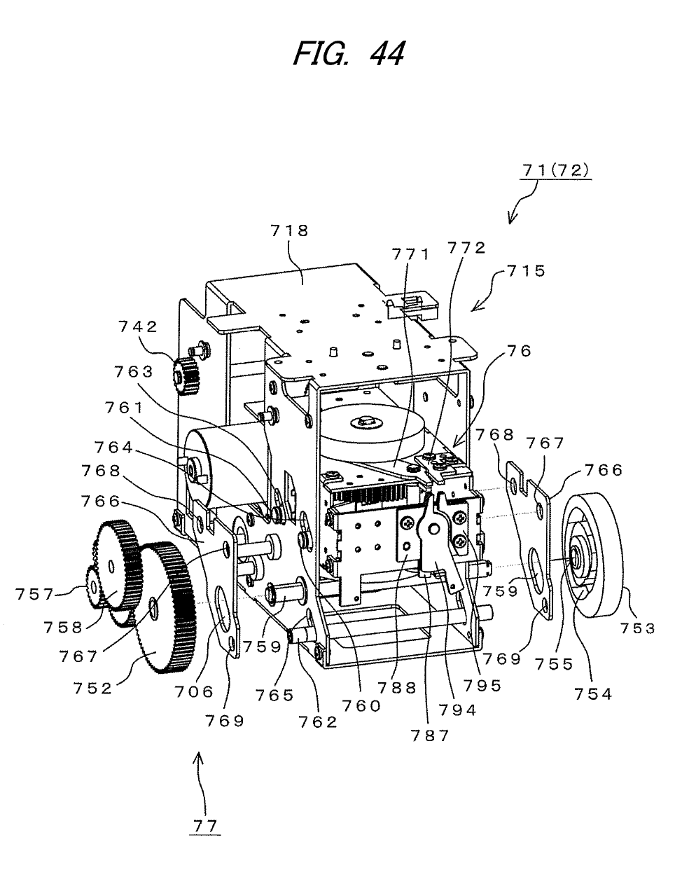

Subsequently, a function of changing a cutting position to cut the helical coil according to the diameter size of the helical coil will be described. FIG. 44 is an exploded perspective view illustrating an example of a configuration of the outlet-side end processing unit 71. The outlet-side end processing unit 71 and the inlet-side end processing unit 72 shown in FIG. 44 include a cutting and bending mechanism 76 cutting and bending the end portion of the helical coil. The cutting and bending mechanism 76 of the outlet-side end processing unit 71 processes one end side of the helical coil inserted into punch holes 3a of the paper stack 3. The cutting and bending mechanism 76 of the inlet-side end processing unit 72 processes the other end side of the helical coil.

In this example, the cutting and bending mechanism 76 is accommodated in the chassis 718 to be obliquely movable, and moves according to the diameter size of the helical coil. The cutting and bending mechanism 76 is disposed to be face the helical coils 11a, 11b, 11c, 11d and is attached to be movable in an oblique direction along the arc portions of the helical coils 11a, 11b, 11c, 11d. The cutting and bending mechanism 76 obliquely moves according to the diameters of the helical coils 11a, 11b, 11c, 11d, such that the cut surfaces of the helical coils 11a, 11b, 11c, 11d become an almost circular shape.

The cutting and bending mechanism 76 is fixed to rods 760, 761. In a side of the chassis 718, inclined holes 763, 764, 765 are formed. The inclined holes 763, 764, 765 are formed to be inclined in the same direction.

A rod 760 is fit into the inclined hole 764 of the chassis 718, a rod 761 is fit into the inclined hole 763, and a rod 762 is fit into the inclined hole 765. Both ends of each of the three rods 760 to 762 are fixed to triangular plates 766. For example, in each of the triangular plates 766, three holes 767 to 769 are formed. The rod 760 is fixed to the holes 767 of the triangular plates 766, the rod 761 is fixed to the holes 768, and the rod 762 is fixed to the holes 769.

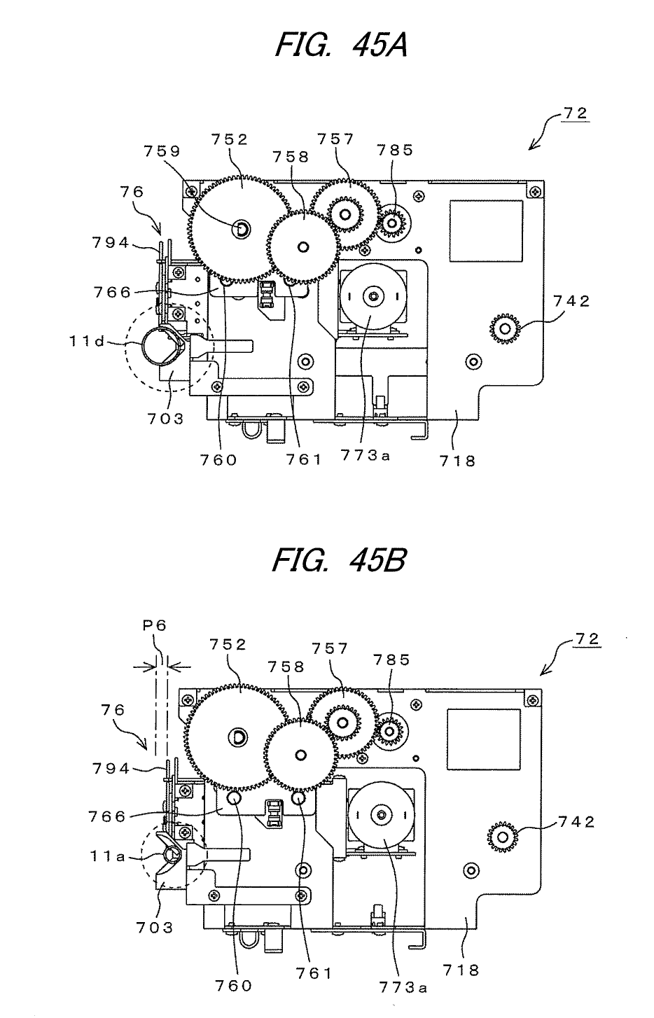

The rod 762 is to be formed longer than the other rods 760, 761, and is joined with planar grooved cams 752, 753. For example, in the planar grooved cams 752, 753, the same cam grooves 754 are formed. Both ends of the rod 762 are fit into the cam grooves 754. The planar grooved cam 752 and the planar grooved cam 753 are connected by a shaft 759. The planer grooved cam 752 functions as a spur gear and is engaged with a spur gear 758, and the spur gear 758 is engaged with a spur gear 757. The spur gear 757 is engaged with a motor gear 785 (see FIG. 45A). The shaft 759 loosely passes through long holes 706 of the triangular plates 766.

According to this configuration, a driving force of a motor 757a for a cut position (see FIG. 67) is transmitted to the planar grooved cam 752 through the spur gear 757 and the spur gear 758, such that the planar grooved cam 752 rotates. Since the planar grooved cam 752 rotates, the planar grooved cam 753 rotates together with the shaft 759 in synchronization with the planar grooved cam 752. The rod 762 fit into the cam grooves 754 moves along the inclined holes 765 by the rotations of the planar grooved cams 752, 753.

As the rod 762 moves along the inclined holes 765, the rods 760, 761 moves along inclined holes 763, 764 together with the triangular plates 766 fixed to both ends of the rod 762, respectively. Accordingly, the cutting and bending mechanism 76 fixed to the rods 760, 761 moves along the inclined holes 763, 764. Therefore, it is possible to change a cutting position of a helical coil according to the diameter of the helical coil, and thus it is possible to make the cut end surface shapes of the helical coils 11a, 11b, 11c, 11d uniform regardless of the diameters of the helical coils 11a, 11b, 11c, 11d.

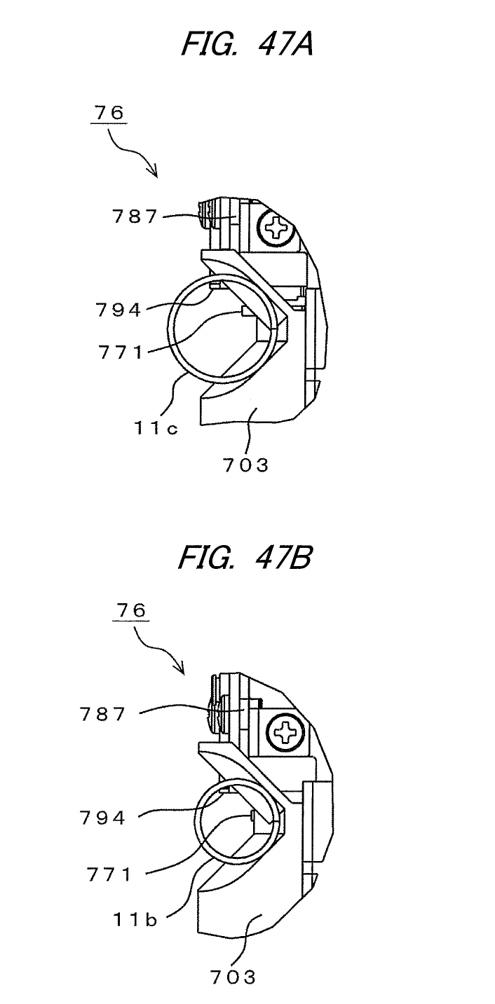

FIG. 45A is a side view illustrating an example of a movement of the cutting and bending mechanism 76. In a coil accommodating unit 703 shown in FIG. 45A, the super-large-diameter helical coil 11d is disposed. The cutting and bending mechanism 76 moves to a position to process the helical coil 11d. For example, a driving force of a motor 757b (see FIG. 67) is transmitted to the planar grooved cam 752 through the motor gear 785, the spur gear 757, and the spur gear 758, such that the planar grooved cams 752, 753 (see FIG. 44) rotate. The cutting and bending mechanism 76 obliquely moves together with the rod 762 fit into the planar grooved cams 752, 753 or the triangular plates 766 along the inclined holes 763, 764 (see FIG. 44). The cutting and bending mechanism 76 shown in FIG. 47A is in a state in which the cutting and bending mechanism 76 has advanced as much as possible.

FIG. 45B is another side view illustrating an example of the movement of the cutting and bending mechanism 76. In the coil accommodating unit 703 shown in FIG. 45B, the small-diameter helical coil 11a is disposed. The cutting and bending mechanism 76 moves to a position to process the helical coil 11a. For example, a driving force of a motor (not shown) is transmitted to the planar grooved cam 752 through the motor gear 785, the spur gear 757, and the spur gear 758, such that the planar grooved cams 752, 753 (see FIG. 44) rotate. The cutting and bending mechanism 76 obliquely moves together with the rod 762 fit into the planar grooved cams 752, 753 or the triangular plates 766 along the inclined holes 763, 764 (see FIG. 44). The cutting and bending mechanism 76 shown in FIG. 45B is in a state in which the cutting and bending mechanism 76 has retreated as much as possible, and has retreated from the position in FIG. 45A by a distance P6.

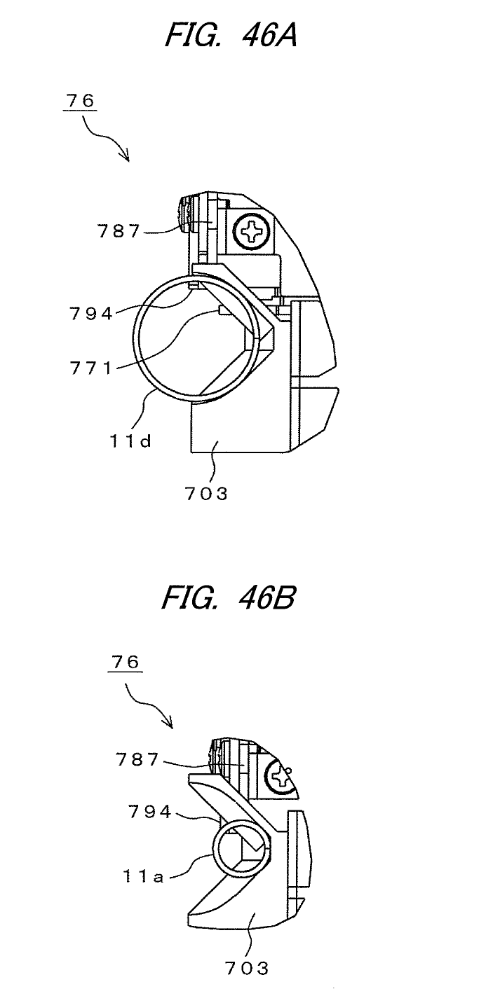

FIG. 46A is an enlarged view of the vicinity of the coil accommodating unit 703 in a broken-line circle of FIG. 45A when the helical coil 11d is processed. A cutter 787 of the cutting and bending mechanism 76 shown in FIG. 46A is disposed almost at the top of the super-large-diameter helical coil 11d. Accordingly, it is possible to perform cutting in a direction almost perpendicular to a tangential direction of a cut position of the super-large-diameter helical coil 11d. Therefore, the cut surface has an almost circular shape, not an elliptical shape, and thus it is possible to prevent the cut end portion of the helical coil 11d from being sharpened.

FIG. 46B is an enlarged view of the vicinity of the coil accommodating unit 703 in a broken-line circle of FIG. 45B when the helical coil 11a is processed. The cutter 787 of the cutting and bending mechanism 76 shown in FIG. 46B is disposed almost at the top of the small-diameter helical coil 11a. Accordingly, it is possible to perform cutting in a direction almost perpendicular to a tangential direction of a cut position of the small-diameter helical coil 11a. Therefore, the cut surface has an almost circular shape, not an elliptical shape, and thus it is possible to prevent the cut end portion of the helical coil 11a from being sharpened.

The cutter 787 of the cutting and bending mechanism 76 shown in FIG. 47A is disposed almost at the top of the large-diameter helical coil 11c. Accordingly, it is possible to perform cutting in a direction almost perpendicular to a tangential direction of a cut position of the large-diameter helical coil 11c. Therefore, the cut surface has an almost circular shape, not an elliptical shape, and thus it is possible to prevent the cut end portion of the helical coil 11c from being sharpened.

The cutter 787 of the cutting and bending mechanism 76 shown in FIG. 47B is disposed almost at the top of the middle-diameter helical coil 11b. Accordingly, it is possible to perform cutting in a direction almost perpendicular to a tangential direction of a cut position of the middle-diameter helical coil 11b. Therefore, the cut surface has an almost circular shape, not an elliptical shape, and thus it is possible to prevent the cut end portion of the helical coil 11b from being sharpened.

As described above, since the position of the cutting and bending mechanism 76 is moved according to the helical coil 11a having the coil diameter of φ8 mm, the helical coil 11b having the coil diameter of φ12 mm, the helical coil 11c having the coil diameter of φ16 mm, and the helical coil 11d having the coil diameter of φ20 mm, it is possible to perform cutting in a direction almost perpendicular to a tangential direction of a cut position of each of the helical coils 11a, 11b, 11c, 11d. Therefore, even when the coil diameter changes, since the cut surface becomes an almost circular shape, not an elliptical shape, it is possible to prevent cut end portions of the helical coils 11a, 11b, 11c, 11d from being sharpened.

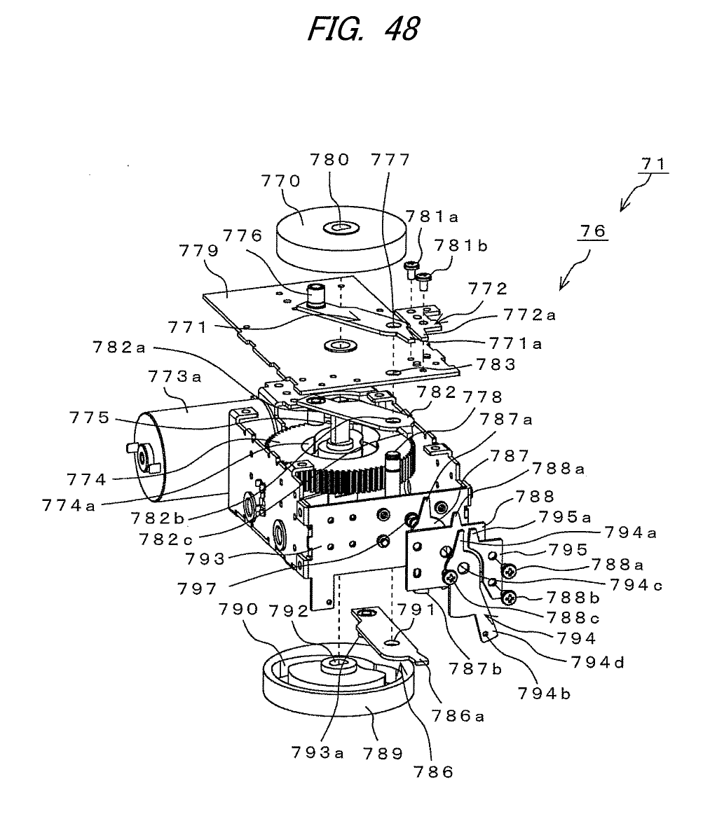

Subsequently, an example of a configuration of the cutting and bending mechanism 76 will be described. FIG. 48 is an exploded perspective view illustrating an example of a configuration of the cutting and bending mechanism 76. The cutting and bending mechanism 76 shown in FIG. 48 has a function of holding bases of end portions of the helical coils 11a, 11b, 11c, 11d, cutting the helical coils, bending the helical coils, and holding offcuts after cutting the helical coils.

For example, in order to implement the function of pinching and holding an end portion of a helical coil, a planar grooved cam 770, a pinching member 771, and a pinch receiving member 772 are provided. The pinching member 771 is movably attached. The pinch receiving member 772 receives the pinching member 771. The end portion of the helical coil is pinched by the pinching member 771 and the pinch receiving member 772. The pinching member 771 and the pinch receiving member 772 are an example of a pinching unit.

For example, the pinch receiving member 772 is fixed to a plate 779 by screws 781a, 781b. The pinching member 771 has a protrusion 776 and a hole 777. The protrusion 776 of the pinching member 771 is fit into a cam groove (not shown) of the planar grooved cam 770, and a rod 778 is rotatably fit into the hole 777 through the plate 779. The rod 778 is fixed to a hole 783 of the plate 779.

A shaft 775 is fit into an almost semi-lunar shaft hole 780 of the planar grooved cam 770. The shaft 775 is fixed to a planar grooved cam 774 for bending. The planar grooved cam 774 functions as a spur gear, and receives a driving force of a motor 773a for cutting and bending so as to rotate. For example, the driving force of the motor 773a is transmitted to the planar grooved cam 774 through a worm gear and a mid gear (not shown).

According to this configuration, when the motor 773a is driven, the shaft 775 rotates together with the planar grooved cam 774. The planar grooved cam 770 rotates by the rotation of the shaft 775, such that the pinching member 771 rotates around the rod 778 as a rotational axis according to the cam groove of the planar grooved cam 770. Therefore, it is possible to pinch and hold the end portion of the helical coil by a fore-end portion 772a of the pinch receiving member 772 and a fore-end portion 771a of the pinching member 771.

In order to implement the function of cutting the helical coil, a planar grooved cam 789, a link 786, the cutter 787, and a cutter receiver 788 are provided. The cutter 787 is movably attached. The cutter receiver 788 receives the cutter 787. The fore-end-portion of the helical coil pinched by the pinching member 771 and the pinch receiving member 772 is cut by the cutter 787 and the cutter receiver 788. The cutter 787 and the cutter receiver 788 are an example of a cutting unit.

For example, the cutter receiver 788 is fixed to a plate 793 by screws 788b, 788c, 788d. The cutter 787 is rotatably attached to a pin 797 fixed to the plate 793 by the cutter receiver 788.

The link 786 has a protrusion 793a and a hole 791. The protrusion 793a of the link 786 is fit into a cam groove 790 of the planar grooved cam 789, and the rod 778 is rotatably fit into the hole 791. A fore-end portion 786a of the link 786 comes into contact with a rear end portion 787b of the cutter 787. The shaft 775 is fit into an almost semi-lunar shaft hole 792 of the planar grooved cam 789.

According to this configuration, when the motor 773a is driven, the shaft 775 rotates together with the planar grooved cam 774. The planar grooved cam 789 rotates by the rotation of the shaft 775, such that the link 786 rotates around the rod 778 as a rotational axis along the cam groove 790 of the planar grooved cam 789. In this case, the fore-end portion 786a of the link 786 manipulates the rear end portion 787b of the cutter 787 to rotate the cutter 787. Therefore, it is possible to pinch and cut the helical coil by the fore-end portion 787a of the cutter 787 and a fore-end portion 788a of the cutter receiver 788. When cutting the helical coil, the end portion of the helical coil is pinched and held by the pinch receiving member 772 and the pinching member 771.

In order to implement a helical-coil bending mechanism, the planar grooved cam 774 and a bending unit 782 are provided. The bending unit 782 is movably attached and bends the end portion of the helical coil cut by the cutter 787. The bending unit 782 has a protrusion 782a and a hole 782b. The protrusion 782a of the bending unit 782 is fit into a cam groove 774a of the planar grooved cam 774, and the rod 778 is rotatably fit into the hole 782b.

According to this configuration, when the motor 773a is driven, the planar grooved cam 774 rotates. The bending unit 782 rotates on the rod 778 along the cam groove 774a of the planar grooved cam 774 by the rotation of the planar grooved cam 774. Therefore, it is possible to bend the helical coil by a fore-end portion 782c of the bending unit 782. When bending the helical coil, the end portion of the helical coil is pinched and held by the pinch receiving member 772 and the pinching member 771.

In order to implement the function of holding offcuts after cutting helical coils, an offcut contact unit 794 and an offcut receiving unit 795 are provided. The offcut contact unit 794 is movably attached. The offcut receiving unit 795 receives the offcut contact unit 794. A coil offcut is pinched and then released by the offcut contact unit 794 and the offcut receiving unit 795. The offcut contact unit 794 and the offcut receiving unit 795 are an example of an offcut pinching unit.

For example, the offcut receiving unit 795 is fixed to the plate 793 by screws 788b, 788d with the cutter 787 and the cutter receiver 788 interposed therebetween. The offcut contact unit 794 is rotatably attached to the pin 797 fixed to the plate 793 to be close to the cutter receiver 788.

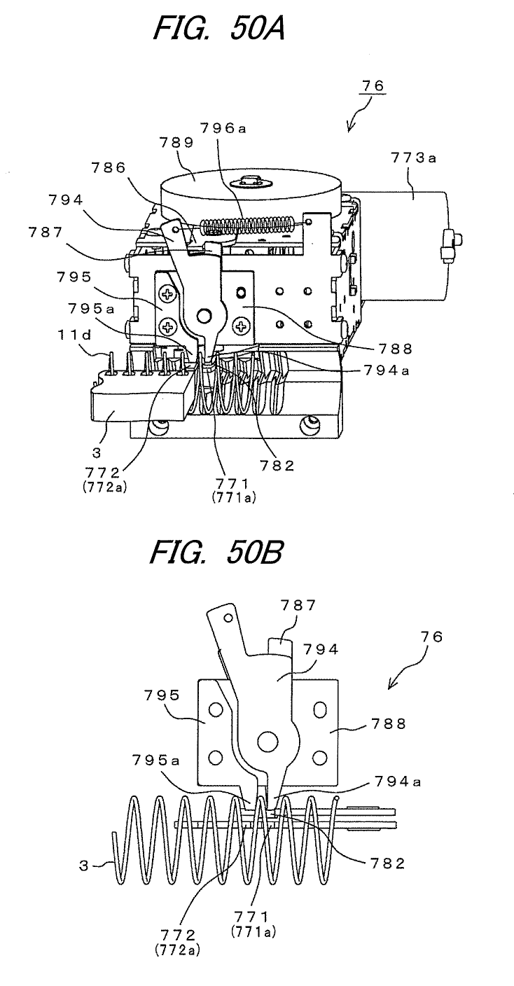

A tensile spring 796a (see FIG. 50) is attached to a hole 794b formed in a rear end portion 794d of the offcut contact unit 794 and applies a force in a direction to close a fore-end portion 794a of the offcut contact unit 794. The fore-end portion 786a of the link 786 described above comes into contact with the rear end portion 794d of the offcut contact unit 794, such that the fore-end portion 786a of the link 786 supports the fore-end portion 794a of the offcut contact unit 794 to be opened when the helical coil is inserted.

According to this configuration, when the motor 773a is driven, the shaft 775 rotates together with the planar grooved cam 774. The planar grooved cam 789 rotates by the rotation of the shaft 775, such that the link 786 rotates on the rod 778 along the cam groove 790 of the planar grooved cam 789. In this case, the fore-end portion 786a of the link 786 operates the rear end portion 794d of the offcut contact unit 794 to rotate the offcut contact unit 794 in a close direction by the tension of the tensile spring 796a. Therefore, the helical coil is pinched by the fore-end portion 794a of the offcut contact unit 794 and the fore-end portion 795a of the offcut receiving unit 795, so as to hold an offcut of the helical coil generated after cutting.

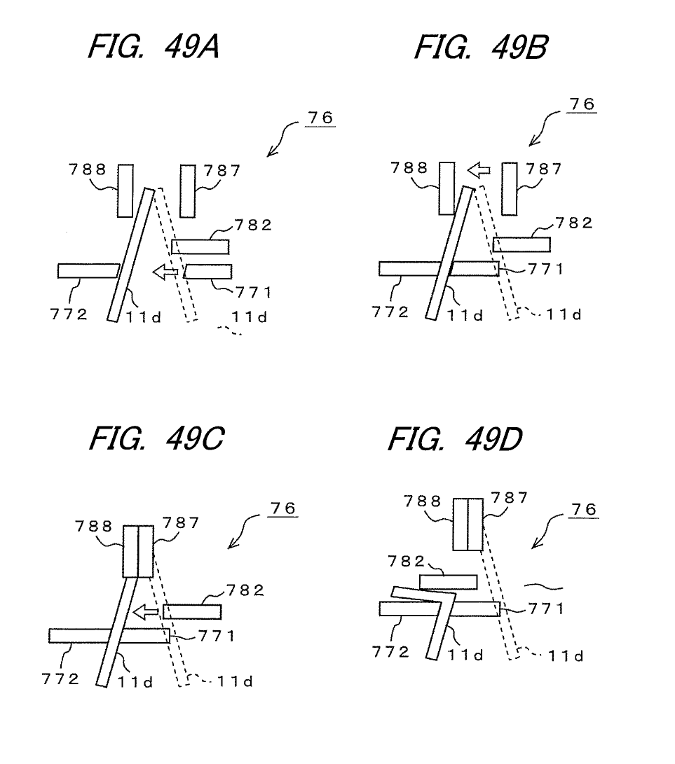

Subsequently, an example of the operation of the cutting and bending mechanism 76 will be described in detail. FIGS. 49A to 49D are schematic diagrams illustrating an example of the operation of the cutting and bending mechanism 76. The cutting and bending mechanism 76 shown in FIG. 49A is in a standby state for receiving the helical coil. In this standby state, the pinching member 771, the cutter 787, and the bending unit 782 which are movable members are located on the right side in the drawing. The helical coil is inserted between the cutter receiver 788 and the cutter 787 at a predetermined interval, and the helical coil is also inserted between the pinch receiving member 772 and the pinching member 771 with a predetermined distance.

The cutting and bending mechanism 76 shown in FIG. 49B is in a state in which the end portion of the helical coil has been interposed and held. In this state, the pinching member 771 moves toward the pinch receiving member 772, such that the end portion of the helical coil is pinched and held by the pinching member 771 and the pinch receiving member 772.

The cutting and bending mechanism 76 shown in FIG. 49C is in a state in which the helical coil has been cut. In this state, the cutter 787 moves toward the cutter receiver 788 in a state in which the pinching member 771 has pinched and held the end portion of the helical coil, and the cutter 787 and the cutter receiver 788 cut the helical coil in cooperation with each other. An offcut of the cut helical coil is pinched and held by the offcut contact unit 794 and the offcut receiving unit 795 shown in FIG. 48.

The cutting and bending mechanism 76 shown in FIG. 49D is in a state in which the end portion of the helical coil has been bent. In this state, the bending unit 782 moves toward the pinch receiving member 772 in a state in which the pinching member 771 has pinched and held the end portion of the helical coil, such that the end portion of the helical coil held by the pinch receiving member 772 and the pinching member 771 is pushed down and bent by the bending unit 782. Accordingly, the helical-coil cutting and bending process is finished. Then, the cutting and bending mechanism 76 returns to the standby state shown in FIG. 49A, and at the same time, the offcut of the helical coil held by the offcut contact unit 794 and the offcut receiving unit 795 is released.

Subsequently, the operation of the cutting and bending mechanism 76 will be described in detail with reference to a perspective view and an enlarged view of the cutting and bending mechanism 76 shown in FIGS. 50A and 50B. FIG. 50A is a perspective view illustrating an example of the operation of the cutting and bending mechanism 76. FIG. 50B is an enlarged view illustrating an example of the operation of the cutting and bending mechanism 76. The cutting and bending mechanism 76 shown in FIGS. 50A and 50B is in a standby state to receive the helical coil. In this standby state, the helical coil is inserted between the fore-end portion 788a of the cutter receiver 788 and a fore-end portion 787a (see FIG. 48) of the cutter 787 at the predetermined interval. The helical coil is also inserted between the fore-end portion 772a of the pinch receiving member 772 and the fore-end portion 771a of the pinching member 771 with the predetermined distance. The helical coil is also inserted between the fore-end portion 794a of the offcut contact unit 794 and a fore-end portion 795a of the offcut receiving unit 795 with a predetermined distance.

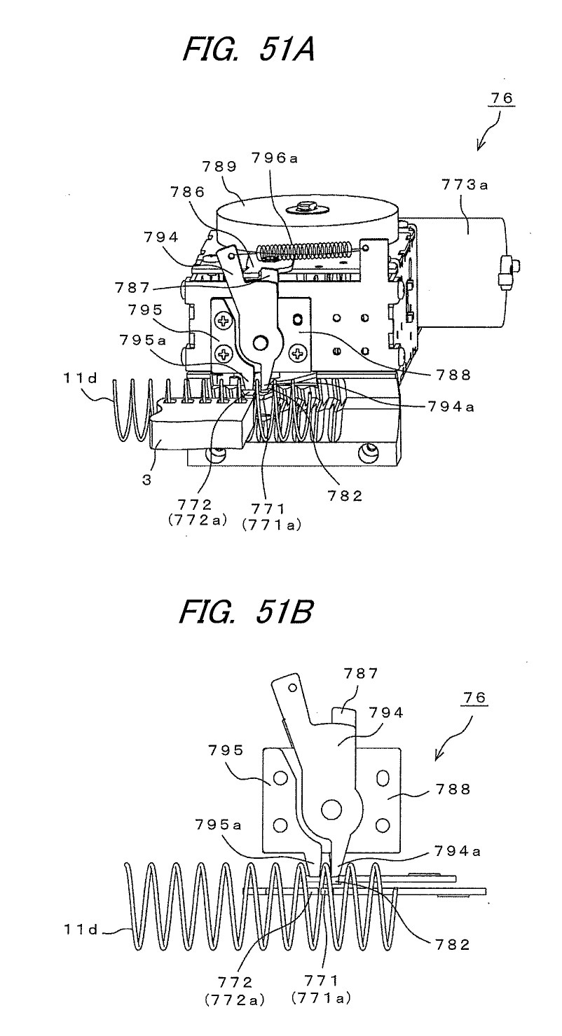

The cutting and bending mechanism 76 shown in FIGS. 51A and 51B is in a state in which the end portion of the helical coil has been interposed and held. For example, the planar grooved cam 770 shown in FIG. 48 rotates by the driving of the motor 773a, such that the pinching member 771 rotates around the rod 778 as a rotational axis along the cam groove of the planar grooved cam 770. Accordingly, the pinching member 771 moves toward the pinch receiving member 772, and the end portion of the helical coil is pinched and held by the fore-end portion 771a of the pinching member 771 and the fore-end portion 772a of the pinch receiving member 772.

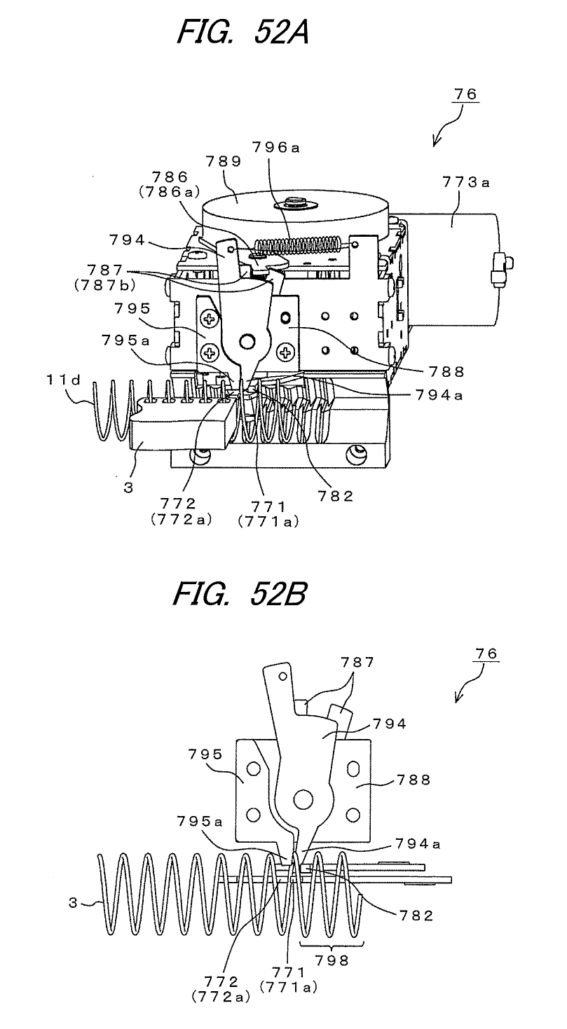

The cutting and bending mechanism 76 shown in FIGS. 52A and 52B is in a state in which the helical coil has been cut. For example, the planar grooved cam 789 rotates by the driving of the motor 773a, such that the link 786 rotates on the rod 778 (see FIG. 48) along the cam groove 790 of the planar grooved cam 789. In this case, the fore-end portion 786a of the link 786 manipulates the rear end portion 787b of the cutter 787 so as to rotate the cutter 787. Accordingly, the helical coil is pinched and cut by the fore-end portion 787a (see FIG. 48) of the cutter 787 and the fore-end portion 788a (see FIG. 48) of the cutter receiver 788. An offcut 798 of the cut helical coil is pinched and held by the fore-end portion 794a of the offcut contact unit 794 to which a force is applied by tensile spring 796, and the fore-end portion 795a of the offcut receiving unit 795.

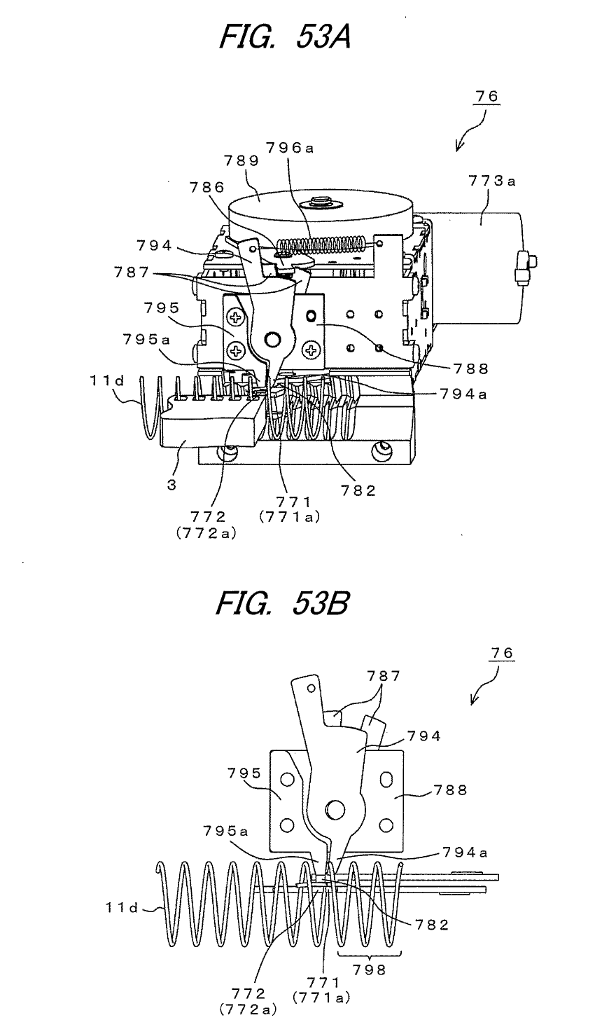

The cutting and bending mechanism 76 shown in FIGS. 53A and 53B is in a state in which the end portion of the helical coil has been bent. For example, the bending unit 782 rotates on rod 788 shown in FIG. 48 along the cam groove 774a of the planar grooved cam 774 by the driving of the motor 773a. Accordingly, in a state in which the pinching member 771 and the pinch receiving member 772 pinch and hold the end portion of the helical coil, the bending unit 782 moves toward the pinch receiving member 772. Therefore, the end portion of the helical coil held by the pinch receiving member 772 and the pinching member 771 can be pushed down and bent by the bending unit 782.

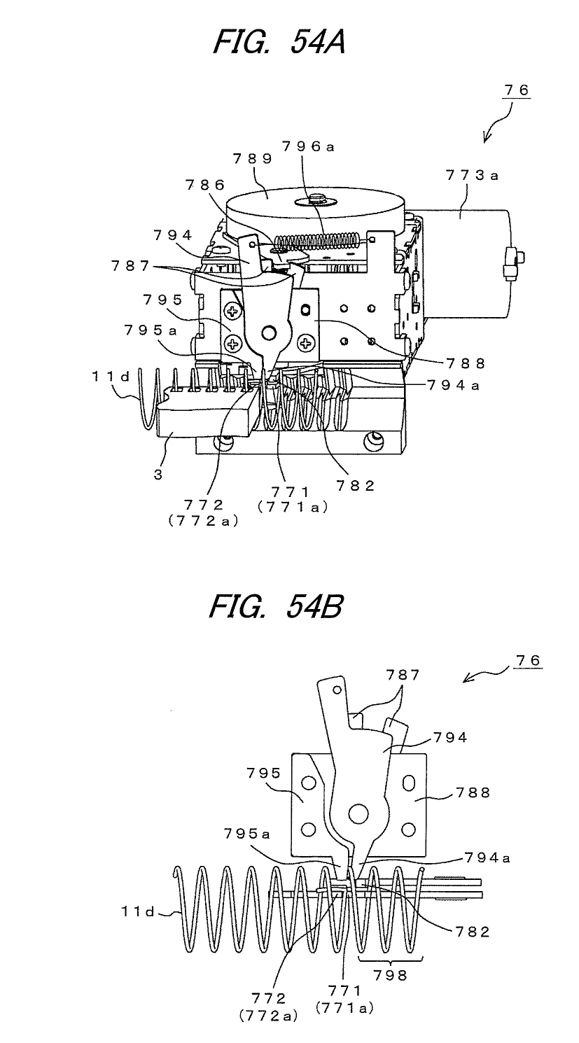

The cutting and bending mechanism 76 shown in FIGS. 54A and 54B is in a state in which the bending unit 782 has retreated from the bent end portion of the helical coil. For example, the bending unit 782 rotates on the rod 778 shown in FIG. 48 along the cam groove 774a of the planar grooved cam 774 by the driving of the motor 773a. Accordingly, the bending unit 782 can move in a direction of being escaped from the pinch receiving member 772, such that the bending unit 782 can retreat from the bent end portion of the helical coil. Then, the cutting and bending mechanism 76 returns to the standby state shown in FIG. 50A, and at the same time, the offcut 798 of the helical coil is released by separating the fore-end portion 794a of the offcut contact unit 794 from the fore-end portion 795a of the offcut receiving unit 795.

As described above, since the offcut 798 is configured to be released after the end portion of the helical coil is cut, it is possible to prevent the offcut 798 from being broken up by an impact during cutting.

FIGS. 55A to 55E are views illustrating formation examples of end portions 701a, 701b of the helical coil. The end portion 701a of the helical coil is formed by the inlet-side end processing unit 72, and the end portion 701b of the helical coil is formed by the outlet-side end processing unit 71. The end portions 701a, 701b of the helical coil are curved at an almost right angle toward the inside of the helical coil. Accordingly, the end portions 701a, 701b get caught by the punch holes 3a of the paper and thus it is possible to prevent the helical coil from falling out of the paper stack 3.

Further, the fore-ends of the end portions 701a, 701b of the helical coil are accommodated inside the helical coil. Accordingly, it is possible to prevent the fore-ends of the end portions 701a, 701b from being hooked into clothes of a user. A bent base position P4 of the end portion 701a and a bent base position P5 of the end portion 701b are set to be the same phase.

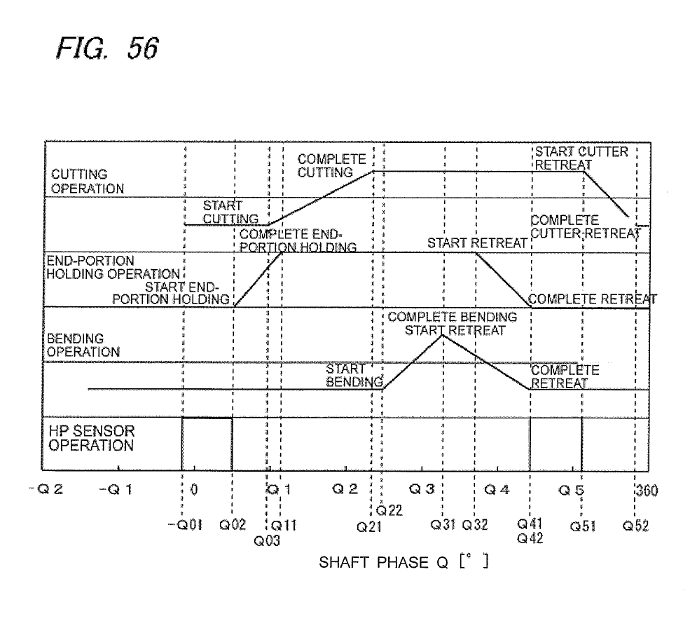

Subsequently, operation timings of the end processing unit 70 will be described. FIG. 56 is a timing chart illustrating an example of the operation of the end processing unit 70. First and second light shielding members are attached to the shaft 775 shown in FIG. 48. Further, a transmissive HP sensor for sensing the light shielding members is attached.

A horizontal axis shown in FIG. 56 represents a phase Q (0° to 360°). In this example, when the phase of the shaft 775 is Q⁰¹, the HP sensor is light-shielded by the first light shielding member and outputs a high-level signal. When the phase of the shaft 775 is Q⁰², the HP sensor passes the first light shielding member and outputs a low-level signal. By this pulse falling, a process of pinching and holding the end portion of the helical coil starts. For example, the pinching member 771 shown in FIG. 51 moves toward the pinch receiving member 772.

When the phase of the shaft 775 is Q⁰³, a cutting process starts. For example, the fore-end portion 786a of the link 786 shown in FIG. 52 manipulates the rear end portion 787b of the cutter 787 to rotate the cutter 787 toward the cutter receiver 788 (see FIG. 48).

When the phase of the shaft 775 is Q¹¹, the process of pinching and holding the end portion is completed. For example, the end portion of the helical coil is pinched and held by the fore-end portion 772a of the pinch receiving member 772 and the fore-end portion 771a of the pinching member 771 shown in FIG. 51.

When the phase of the shaft 775 is Q²¹, the cutting process is completed. For example, as shown in FIG. 52, the helical coil is pinched and cut by the fore-end portion 787a of the cutter 787 and the fore-end portion 788a of the cutter receiver 788 (see FIG. 48).

When the phase of the shaft 775 is Q²², a bending process starts. For example, the end portion of the helical coil held by the pinch receiving member 772 and the pinching member 771 shown in FIG. 53 is pushed down and bent by the bending unit 782.

When the phase of the shaft 775 is Q³¹, the bending process is completed and retreating starts. When the phase of the shaft 775 is Q⁴¹, the retreating is completed. For example, the bending unit 782 shown in FIG. 54 retreats from the bent end portion of the helical coil and returns to a standby position shown in FIG. 50A.

When the phase of the shaft 775 is Q³², releasing of the end-portion holding processing starts, and when the phase of the shaft 775 is Q⁴², the releasing is completed. For example, the pinching member 771 shown in FIGS. 51A and 51B moves away from the pinch receiving member 772 to returns to the standby position shown in FIG. 50A. When the phase of the shaft 775 is Q⁴², the HP sensor outputs the high-level signal, and at this timing, book 90 is discharged from the end processing unit 70. In this case, the offcut 798 is pinched and held by the offcut contact unit 794 and the offcut receiving unit 795.

When the phase of the shaft 775 is Q⁵¹, cutter retreat starts, and when the phase of the shaft 775 Q⁵², the retreat is completed. For example, the cutter 787 shown in FIGS. 52A and 52B moves away from the cutter receiver 788 (see FIG. 48) to return to the standby position shown in FIG. 50A. At those timings, the end processing unit 70 operations. In this case, the holding of the offcut 798 by the offcut contact unit 794 and the offcut receiving unit 795 is released, such that the offcut 798 is discharged. Therefore, it is possible to prevent the offcut 798 from being broken up.

As described above, according to the coil binding apparatus 100 according to the exemplary embodiment of the present disclosure, the cutting and bending mechanism 76 pinches and holds the end portion of the helical coil by the pinching member 771 and the pinch receiving member 772 and cuts the pinched helical coil by the cutter 787 and the cutter receiver 788. The end portion of the cut helical coil is bent by the bending unit 782. Accordingly, it is possible to accurately cut and bend both ends of the helical coil. Further, when the coil is cut, since the offcut 798 is held by the offcut contact unit 794 and the offcut receiving unit 795, it is possible to prevent the offcut 798 from being broken up unexpectedly.

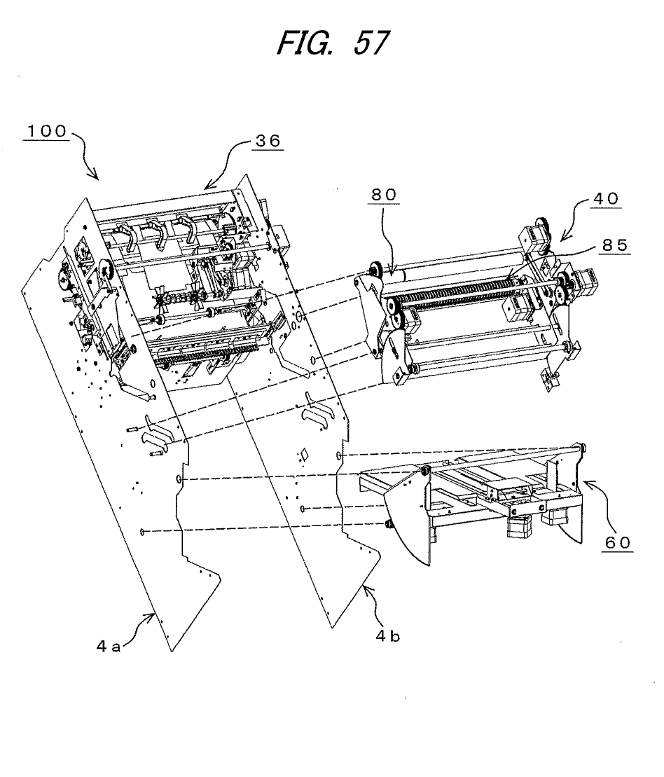

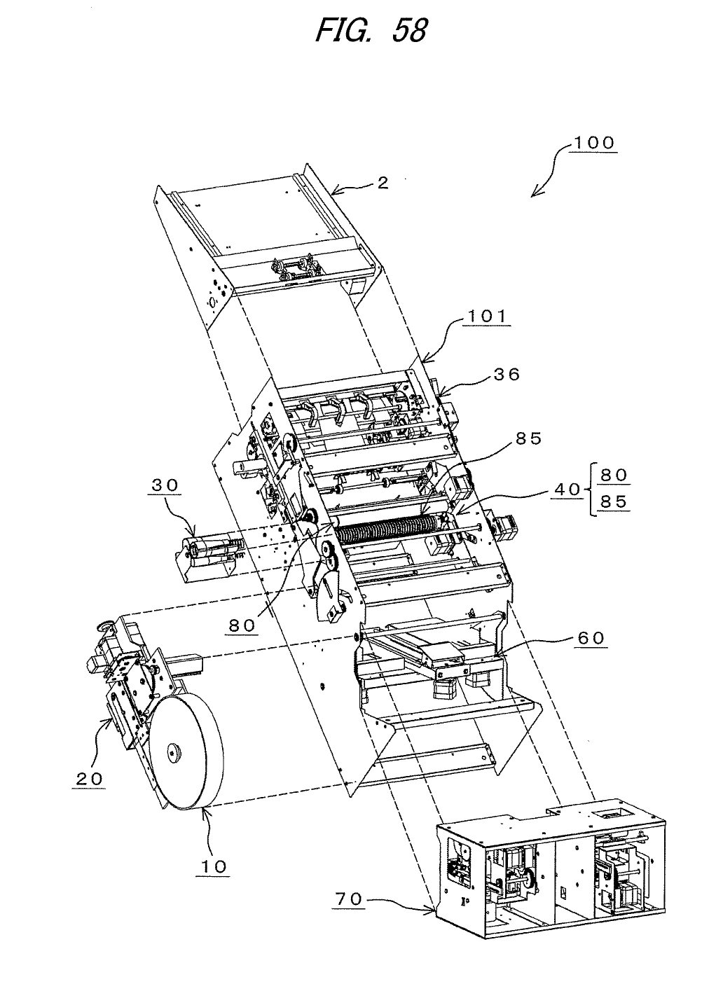

Subsequently, an assembly example of the coil binding apparatus 100 will be described with reference to FIGS. 57 and 58. In the coil binding apparatus 100 shown in FIG. 58, first, the paper stack aligning unit 36 is attached between the left plate 4a and the right plate 4b for component (member) attachment as shown in FIG. 58. In this case, the paper stack aligning unit 36 having the alignment pin mechanism 50 attached thereto is used.

Next, the binding mechanism 40 is attached between the left plate 4a and the right plate 4b having the paper stack aligning unit 36 attached thereto. In this case, the binding mechanism 40 having the coil-fore-end inserting section 80 and the coil transferring section 85 attached thereto is used.

The constitutional element obtained by attaching the binding mechanism 40, the alignment pin mechanism 50, paper stack transferring unit 60, the coil-fore-end inserting section 80, and the coil transferring section 85 between the left plate 4a and the right plate 4b as described above is generally referred to the apparatus main body 101.

In order to attach the individual members between the left plate 4a and the right plate 4b, holes formed in the paper stack aligning unit 36, the binding mechanism 40, the paper stack transferring mechanism 60, the left plate 4a, and the right plate 4b are aligned with respect to the positions, bolts are inserted into and pass through the holes from one side to the other side, and end portions of the bolts exposed to the other side are screwed into female screws to be fixed.

In this example, the paper tray 2, the coil forming mechanism 20, the coil introducing mechanism 30, the paper stack aligning unit 36, and the end processing unit 70 are assembled and put into the apparatus main body 101 shown in FIG. 57. The paper tray 2, the coil forming mechanism 20, the coil introducing mechanism 30, the paper stack aligning unit 36, and the end processing unit 70 are also fixed by screwing bolts into nuts through the holes.

The fixing method between the members is not limited to a bolt and nut fastening method. The paper tray 2, the coil forming mechanism 20, the coil introducing mechanism 30, the paper stack aligning unit 36, and the end processing unit 70 may be fixed to the left plate 4a and the right plate 4b by using sheet metal screws. Next, the wire cartridge 10 is attached to the coil forming mechanism 20. The coil forming mechanism 20 having the wire cartridge 10 attached thereto may be used. Accordingly, the coil binding apparatus 100 as shown in FIG. 1 is completed.

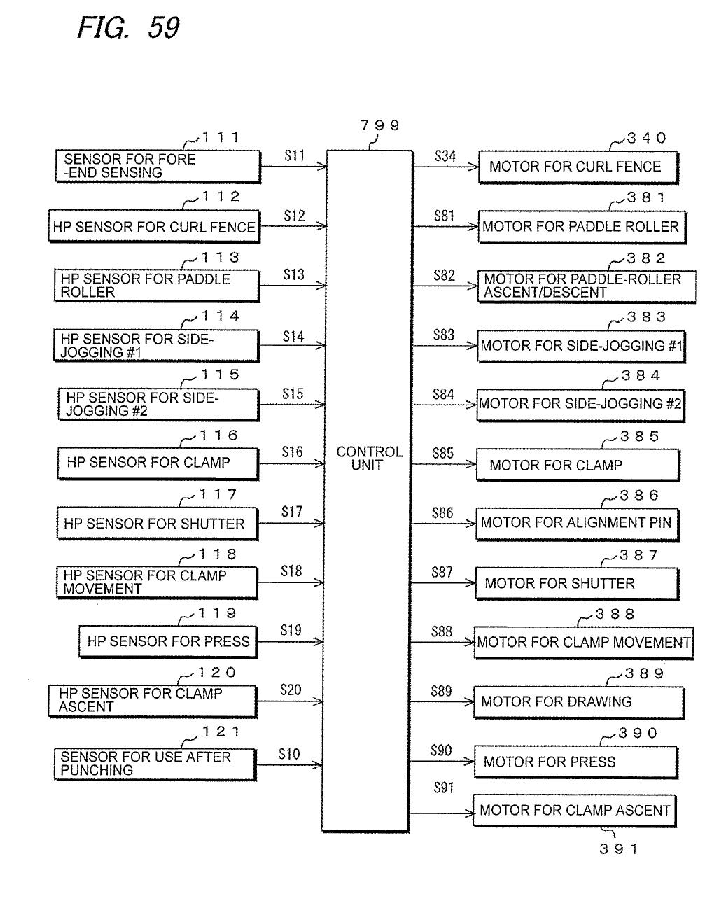

Subsequently, an example of a configuration of a control system of the paper stack aligning unit 36 will be described with reference to FIG. 59. According to a control system of the paper stack aligning unit 36 shown in FIG. 59, a control unit 799 is connected to twelve motors 340 and 381 to 391 and eleven sensors 111 to 121.

The motor 340 rotates in response to a driving signal S34 from the control unit 799, and operates when driving the left and right curl fences 34a, 34b of the paper curl pressing mechanism 331 shown in FIG. 3. The left and right curl fences 34a, 34b is rotated clockwise (CW: a forward rotation). The control unit 799 controls the rotations and stop positions of the left and right curl fences 34a, 34b.

The motor 381 rotates in response to a driving signal S81 from the control unit 799 so as to rotate a paddle. The control unit 799 controls the rotation and the number of times of rotation of the paddle roller 353. The control unit 799 rotates the motor 381 counterclockwise (CCW: a reverse rotation) to drive the paddle roller 353.

The motor 382 rotates in response to a driving signal S82 from the control unit 799 to ascend or descend the paddle roller 353. The control unit 799 controls the ascending, descending, and position of the paddle roller 353. The control unit 799 rotates the motor 382 clockwise to descend the paddle roller 353, and rotates the motor 382 counterclockwise to ascend the paddle roller 353.

The motor 383 rotates in response to a driving signal S83 from the control unit 799 to set the side-jogging #1 of a reference side of the side jogger 370. The control unit 799 controls the position of side-jogging #1 of the reference side of side joggers 370. The control unit 799 rotates the motor 383 clockwise to perform a side-jogging operation, and rotates the motor 383 counterclockwise to perform an opening operation.

The motor 384 rotates in response to a driving signal S84 from the control unit 799 to drive side-jogging #2 of a movable side of side joggers 370. The control unit 799 controls the position of side-jogging #2 of the movable side of side joggers 370. The control unit 799 rotates the motor 384 clockwise to perform a movement control to the side-jogging reference position, and rotates the motor 384 counterclockwise to perform a movement control to the retreat position.

The motor 385 rotates in response to a driving signal S85 from the control unit 799 to drive the clamps 801a, 801b. The control unit 799 drives cams for closing and opening the clamps and controls the open positions of the clamps. The control unit 799 performs a rotation control so as to rotate the motor 385 clockwise to open the clamps 801a, 801b and rotate the motor 385 counterclockwise to close the clamps 801a, 801b.

The motor 386 rotates in response to a driving signal S86 from the control unit 799 to drive the alignment pins 51 of the alignment pin mechanism 50. The control unit 799 controls the alignment pins 51 of the alignment pin mechanism 50 to protrude and retreat. The control unit 799 performs a rotation control so as to rotate the motor 386 clockwise to protrude the alignment pins 51 and rotate the motor 386 counterclockwise to retreat the alignment pins 51.

The motor 387 rotates in response to a driving signal S87 from the control unit 799 to drive the shutter 383′. The control unit 799 performs control to open and close the shutter 383′. The control unit 799 performs rotation control so as to rotate the motor 387 clockwise to open the shutter and rotate the motor 387 counterclockwise to close the shutter.

The motor 388 rotates in response to a driving signal S88 from the control unit 799 to move the clamps 801a, 801b of the clamp moving mechanism 380. The control unit 799 performs control to move the clamps 801a, 801b to paper-sheet pressing positions and coil inserting positions. The control unit 799 performs a rotation control so as to rotate the motor 388 clockwise to move the clamps 801a, 801b to coil inserting positions and rotate the motor 388 counterclockwise to move the clamps 801a, 801b to the alignment positions.

The motor 389 rotates in response to a driving signal S89 from the control unit 799 and operates when rotating a drawing roller. The control unit 799 controls the rotation and the number of times of rotation of the drawing roller. The control unit 799 rotates the motor 389 counterclockwise to control the rotation of the drawing roller.

The motor 390 rotates in response to a driving signal S90 from the control unit 799 to rotate a pressing roller. The control unit 799 controls the ascending and descending of the pressing roller. The control unit 799 performs rotation control so as to rotate the motor 390 clockwise to descend the pressing roller and rotate the motor 390 counterclockwise to ascend the pressing roller.

The motor 391 rotates in response to a driving signal S91 from the control unit 799 to ascend the clamps 801a, 801b. The control unit 799 performs control to open the clamps 801a, 801b during booklet exchange. The control is switched by 180° rotation. Motors 340 and 381 to 391 described above may be stepping motors.

The sensor 111 senses the fore-ends of paper sheets 3′ and outputs a position sense signal S11 to the control unit 799. The control unit 799 performs residual-paper-sheet sensing to sense the presence or absence of residual paper sheets 3′ in the paper holding unit 32. As the sensor 111, a reflective optical sensor is used.

The sensor 112 senses stop positions (home positions HP) of the curl fences 34a, 34b, and outputs a position sense signal S12 to the control unit 799. The sensor 113 senses a stop position (a home position HP) of the paddle roller 353 at a predetermined height, and outputs a position sense signal S13 to the control unit 799.

The sensor 114 senses a predetermined stop position (a home position HP) of side-jogging #1 of the side jogger 370, and outputs a position sense signal S14 to the control unit 799. The sensor 115 senses a predetermined stop position (a home position HP) of side-jogging #2 of the side jogger 370, and outputs a position sense signal S15 to the control unit 799.

The sensor 116 senses predetermined stop positions (home positions HP) of the clamps 801a, 801b, and outputs a position sense signal S16 to the control unit 799. The sensor 117 senses a predetermined stop position (a home position HP) of the shutter 383′, and outputs a position sense signal S17 to the control unit 799.

The sensor 118 senses a predetermined stop position (a home position HP) of the clamp moving mechanism 380, and outputs a position sense signal S18 to the control unit 799. The sensor 119 senses a predetermined stop position (a home position HP) of the press roller 355, and outputs a position sense signal S19 to the control unit 799.

The sensor 120 senses ascending and descending stop positions (home positions HP) of a clamp-up motor, and outputs a position sense signal S20 to the control unit 799. The sensor 121 senses paper sheets 3′ after a punching processing, and outputs a paper-sheet sense signal S10 to the control unit 799. As each of the sensors 112 to 121, a transmissive optical sensor is used.

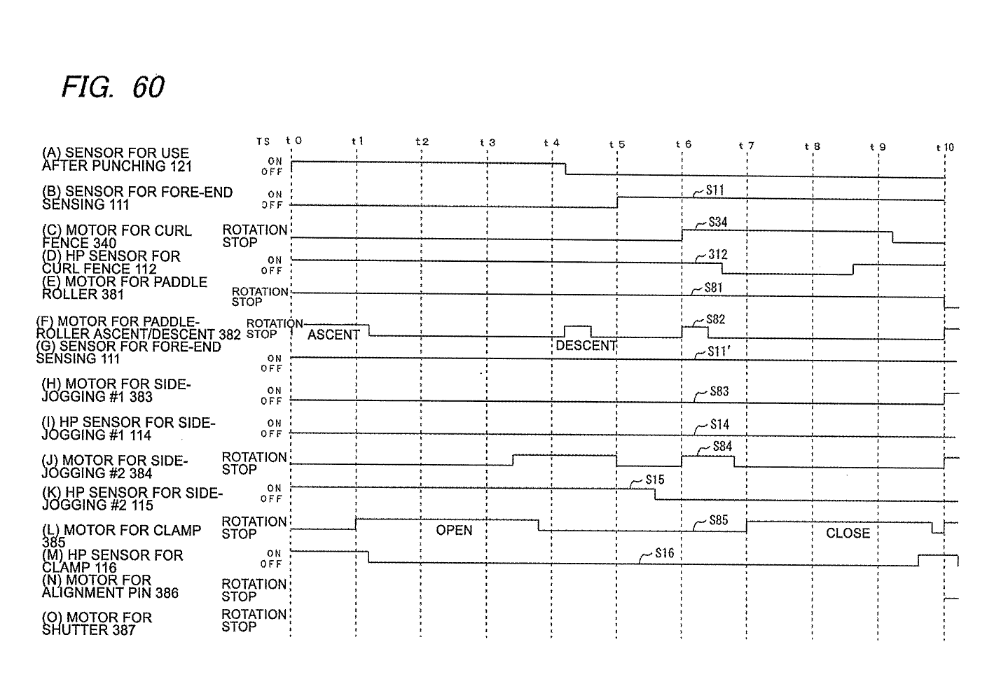

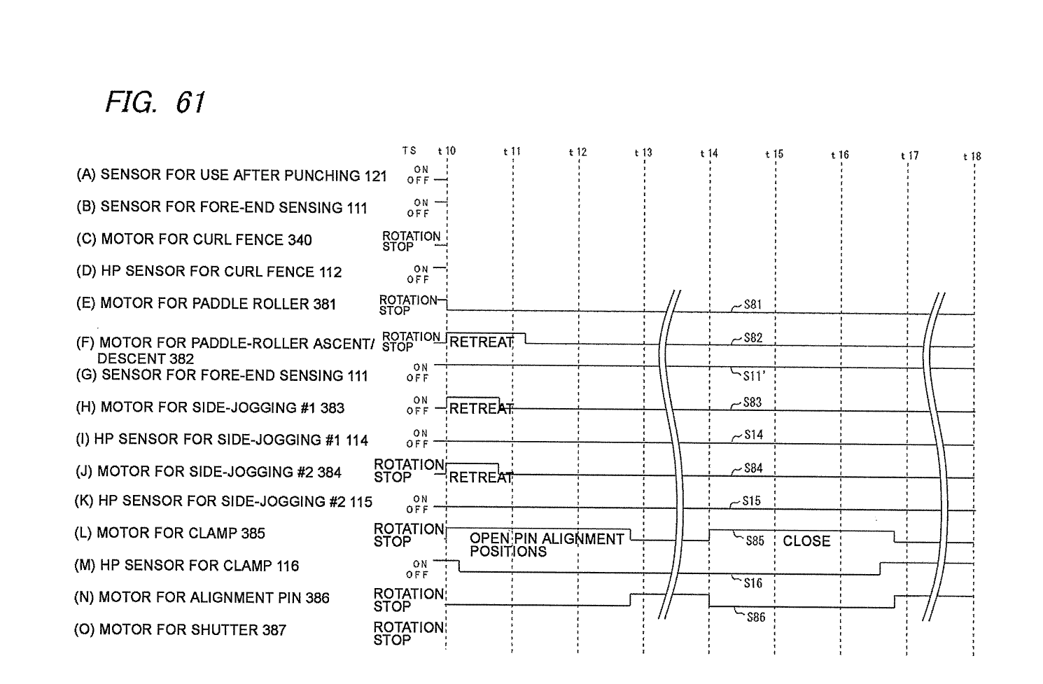

Subsequently, an operation example of the paper stack aligning unit 36 will be described with reference to FIGS. 60 to 62. A reference symbol TS shown in FIG. 60 is a time schedule and represents a time of an operation when the operation start timing is referred to as t0. Time schedule TS is similarly applied to FIGS. 61, 62, 65, 66, and 68.

In this example, a plurality of paper sheets 3′ set with having aligned punch holes 3a in the paper tray 2 are fed and bound to be stacked in a paper stack 3. Punch holes 3a of the paper stack 3 are obliquely aligned to facilitate the insertion of a helical coil. Then, the paper stack 3 having obliquely aligned punch holes 3a is set to a coil insertion operation position. This case is exemplified.

Using them as paper-sheet conditions, in the paper stack aligning unit 36, the control unit 799 as shown in FIG. 59 starts an operation at a timing t0. First, the sensor 121 shown in (A) of FIG. 60 senses feeding of paper sheets 3′, and outputs paper-sheet sense signal S10 to the control unit 799.

The control unit 799 transmits high-level driving signal S85 shown in (L) of FIG. 60 to the motor 385 at the timing t1. On the basis of driving signal S85, the motor 385 drives the clamps 801a, 801b to be opened.

Further, the control unit 799 having started the operation at the timing t0 transmits high-level driving signal S82 shown in (F) of FIG. 60 to the motor 382 after the timing t1. The motor 382 rotates in response to driving signal S82 to ascend the paddle roller 353.

After the timing t1, the sensor 116 for clamp HP shown in (M) of FIG. 60 is turned off and outputs low-level position sense signal S16 to the control unit 799. Then, after the timing t3, the control unit 799 outputs high-level driving signal S833 shown in (J) of FIG. 60 to the motor 383 for side-jogging #1. The motor 383 drives the side jogger 370.

Further, before the timing t4, the control unit 799 activates high-level driving signal S833 shown in (J) of FIG. 60 to drive the motor 384 for side-jogging #2. The motor 384 drives side-jogging #2 of the side jogger 370 (primary side-jogging).

After the timing t4, a sensor shown in (A) of FIG. 60 outputs low-level paper-sheet sense signal S10 to the control unit 799. After the timing t4, the control unit 799 changes driving signal S82 shown in (F) of FIG. 60 to be the high level and then to be the low level to temporarily drive the motor 382. The motor 382 temporarily rotates in response to driving signal S82 to slightly descend the paddle roller 353.

After the timing t5, the sensor 111 shown in (B) of FIG. 60 is turned on and outputs high-level position sense signal S11 to the control unit 799. After the timing t5, the control unit 799 changes driving signal S84 shown in (J) of FIG. 60 to the low level to stop the motor 384. In response to driving signal S84, the motor 384 stops side-jogging #2.

Also, before the timing t5, the sensor 115 for side-jogging #2 shown in (K) of FIG. 60 is turned off and outputs low-level position sense signal S15 to the control unit 799. At the timing t6, the control unit 799 activates driving signal S34 shown in (C) of FIG. 60 to drive the motor 340. In response to driving signal S34, the motor 340 drives the curl fences 34a, 34b.

After the timing t6, the control unit 799 changes driving signal S82 shown in (F) of FIG. 60 to be the high level and then to be the low level to temporarily drive the motor 382. In response to driving signal S82, the motor 382 temporarily rotates to ascend the paddle roller 353.

In this example, after the timing t6, the sensor 112 for curl fence HP shown in (D) of FIG. 60 is turned off and outputs low-level position sense signal S12 to the control unit 799. Before the timing t7, the control unit 799 activates driving signal S84 shown in (J) of FIG. 60 to drive the motor 384. In response to driving signal S84, the motor 384 drives side-jogging #2 of the side jogger 370.

Further, at the timing t7, the control unit 799 transmits high-level driving signal S85 shown in (L) of FIG. 60 to the motor 385. In response to driving signal S835, the motor 835 closes the clamps 801a, 801b.

After the timing t8, the sensor 112 shown in (D) of FIG. 60 is turned on and outputs high-level position sense signal S12 to the control unit 799. After the timing t9, the control unit 799 activates driving signal S34 shown in (C) of FIG. 60 to stop the motor 340. The motor 340 stops and thus the driving of the curl fences 34a, 34b stops.

Further, before the timing t10, the sensor 116 for clamp HP shown in (M) of FIG. 60 is turned on and outputs high-level position sense signal S16 to the control unit 799. Before the timing t10, the control unit 799 transmits driving signal S85 temporarily having the low level shown in (L) of FIG. 60 to the motor 385.

Further, at the timing t10, the control unit 799 changes driving signal S81 shown in (E) of FIG. 61 from the high level to the low level to stop the motor 381. The motor 381 stops and thus the driving of the paddle roller 353 stops.

Also, the control unit 799 changes driving signal S82 shown in (F) of FIG. 61 from the low level to the high level after the timing of t10 to t11. On the basis of driving signal S82, the motor 382 retreats the paddle roller 353.

The control unit 799 changes driving signal S83 shown in (H) of FIG. 61 from the low level to the high level before the timing of t10 to t11. On the basis of driving signal S83, the motor 383 rotates to retreat side-jogging #1.

Also, the control unit 799 changes driving signal S84 shown in (J) of FIG. 61 from the low level to the high level from the timing t10 until before the timing t11. On the basis of driving signal S84, the motor 384 rotates to retreat side-jogging #2.

Further, at the timing t10, the control unit 799 changes driving signal S85 shown in (L) of FIG. 61 from the low level to the high level. On the basis of driving signal S85, the motor 385 rotates to open the clamps 801a, 801b, such that the paper stack 3 is open in the pin alignment position. The clamps 801a, 801b are open only from the timing t10 until before the timing t13.

Also, before the timing t13, the control unit 799 changes driving signal S86 shown in (N) of FIG. 61 from the low level to the high level. On the basis of driving signal S86, the motor 386 rotates to protrude the alignment pins 51 through punch holes 3a of the paper stack 3, thereby obliquely aligning punch holes 3a.

Thereafter, the control unit 799 changes driving signal S85 shown in (L) of FIG. 61 from the low level to the high level from the timing t14 to the timing t17. On the basis of driving signal S85, the motor 385 rotates to close the clamps 801a, 801b. The clamps 801a, 801b are close only from the timing t14 to the timing t17.

At the timing t17, the HP sensor 116 for clamps shown in (M) of FIG. 61 is turned on, and outputs high-level position sense signal S16 to the control unit 799. The control unit 799 changes driving signal S86 shown in (N) of FIG. 61 from the high level to the low level from the timing t14 to the timing t17. The motor 386 stops and thus the operation of the alignment pin mechanism 50 also stops.

The sensor 121 for use after punching shown in (A) of FIG. 61, the sensor 111 for fore-end sensing shown in (B) of FIG. 61, the motor 340 for curl fences shown in (C) of FIG. 61, and the HP sensor 112 for curl fences shown in (D) of FIG. 61 are in an operation stop state. The motor 387 for a shutter shown in (O) of FIG. 61 is in a standby state for paper stack exchange.

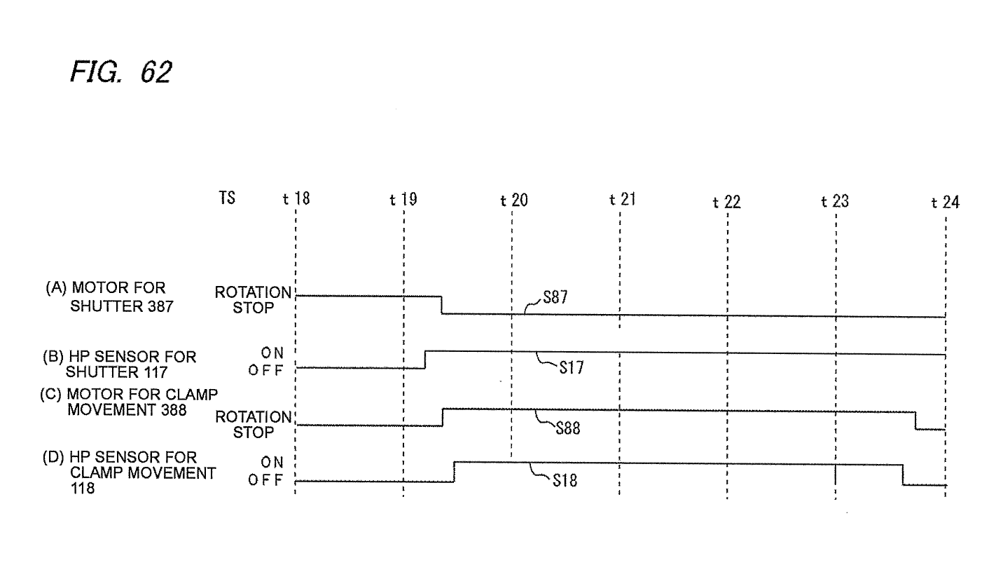

Further, at the timing t18, the control unit 799 changes driving signal S87 shown in (A) of FIG. 62 from the low level to the high level to drive the motor 387. In response to driving signal S87, the motor 387 rotates to descend the shutter 383′. Thereafter, before the timing t19, driving signal S87 changes from the high level to the low level to maintain the open state of the shutter 383′.

The HP sensor 117 for the shutter shown in (B) of FIG. 62, which is already in an off state at the timing t18, is turned on after the timing t18, and outputs high-level position sense signal S17 to the control unit 799.

Thereafter, before the timing t19, the control unit 799 changes driving signal S88 shown in (C) of FIG. 62 from the low level to the high level to drive the motor 388. In response to driving signal S88, the motor 388 rotates to operate the clamp moving mechanism 380. Before the timing t24, driving signal S88 shown in (C) of FIG. 62 changes from the high level to the low level, such that the motor 388 stops the operation of the clamp moving mechanism 380.

Also, the HP sensor 118 for clamp movement shown in (D) of FIG. 62, which is in an off state after the timing t18, is turned on after the timing t19, and outputs high-level position sense signal S18 to the control unit 799. The sensor 118 is turned off after the timing t24, and outputs low-level position sense signal S18 to the control unit 799. The above-mentioned control enables the paper stack aligning unit 36 to give the paper stack transferring mechanism 60 the paper stack 3 bound with the helical coil having both end to be processed.

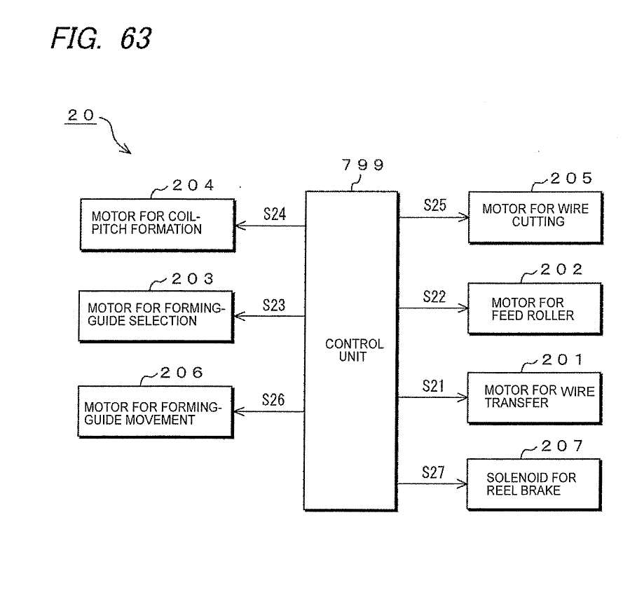

Subsequently, an example of a configuration of a control system of the coil forming mechanism 20 will be described with reference to FIG. 63. According to the control system of the coil forming mechanism 20 shown in FIG. 63, the control unit 799 is connected to six motors 201 to 206 and one solenoid 207. The motor 201 rotates in response to driving signal S21 from the control unit 799 to insert the fore end portion of the wire 1 into the wire transferring section 22. The motor 201 rotates clockwise to insert the fore end portion of the wire 1 into the wire transferring section 22.

The motor 202 rotates feed roller 24a in response to driving signal S22 from the control unit 799, so as to send the wire 1 to the coil forming section 28. For example, the motor 202 rotates clockwise to send the wire 1 to the coil forming section 28.

The motor 203 selects one of the forming adapters of the forming guide 28a in response to driving signal S23 from the control unit 799. In this example, one of the forming adapters #φ8, #φ12, #φ16, and #φ20 corresponding to four kinds of coil diameters is selected.

For example, the control unit 799 may rotate the motor 203 clockwise to select one forming adaptor in order of the forming adapters #φ20, #φ16, #φ12, #φ8. The motor 203 may rotate counterclockwise to select one forming adaptor in order of the forming adapters #φ8, #φ12, #φ16, #φ20.

During coil forming, the motor 204 adjusts the coil pitch in response to driving signal S24 from the control unit 799. After the coil forming, the motor 205 cuts the wire 1 in response to driving signal S25 from the control unit 799.

When the coil diameter is changed, the motor 206 moves the forming guide 28a in response to driving signal S26 from the control unit 799. For example, the control unit 799 rotates the motor 206 counterclockwise to set one of the forming adapters of the forming guide 28a to the coil forming section 28. Further, the control unit 799 rotates the motor 206 clockwise to control the forming guide 28a to retreat from the coil forming section 28.

A solenoid 207 for a reel brake drives a reel brake (not shown) in response to a solenoid driving signal S27 from the control unit 799. Braking is performed to prevent the drum 12 from rotating excessively. The reel brake makes it possible to prevent the wire 1 drawn out of the wire cartridge 10 from being stretched. They constitute the control system of the coil forming mechanism 20.

Subsequently, an example of a configuration of a control system of the coil forming mechanism 20, the binding mechanism 40, and the paper stack transferring mechanism 60, and an example of an operation thereof will be described with reference to FIG. 64. In this example, a case of applying the center axis shifting unit 310 is exemplified. According to the control system of the coil forming mechanism 20, the binding mechanism 40, and the paper stack transferring mechanism 60 shown in FIG. 63, the control unit 799 is connected to ten motors 318, 831 to 835, 61n, 61a, 61i, and 61j, and seven sensors 388, 841, 843, 845, and 799i to 799k.

The motor 318 selects one of coil accommodating units 311 to 314 of the center axis shifting unit 310 in response to driving signal S318. The control unit 799 controls the rotation movement and stop position of the center axis shifting unit 310. The motor 318 rotates the center axis shifting unit 310 counterclockwise.

The motor 831 sets the positions of the metal rollers 81, 86 in response to driving signal S831. The control unit 799 controls the rotation and rotation speeds of the metal rollers 81, 86. The control unit 799 rotates the metal rollers 81, 86 clockwise. The motor 832 rotates the metal roller 86 in response to driving signal S832. The control unit 799 controls the rotation and rotation speeds of the metal rollers 81, 86. The motor 832 rotates the metal rollers 81, 86 clockwise.

The motor 833 sets the positions of the resin rollers 82, 87 in response to driving signal S833. The control unit 799 controls the vertical positions and movement stop positions of the resin rollers 82, 87. The control unit 799 rotates the motor 833 clockwise in correspondence with the coil diameter, thereby performing position control to ascend the resin rollers 82, 87. The control unit 799 rotates the motor 833 counterclockwise, thereby performing position control to descend the resin rollers 82, 87.

The motor 834 rotates the resin roller 87 in response to driving signal S834. The control unit 799 controls the rotation and rotation speeds of the resin rollers 82, 87. The motor 834 rotates the resin rollers 82, 87 counterclockwise.

The motor 835 retreats the transfer ASSY in response to driving signal S835. The control unit 799 performs rotation movement and stop position control for the transfer ASSY retreat. The motor 835 rotates clockwise to move the transfer ASSY to the coil insertion operation position. The motor 835 rotates counterclockwise to retreat the transfer ASSY from the coil insertion operation position.

The sensor 338 senses a predetermined stop position (a home position HP) of the center axis shifting unit 310, and outputs a position sense signal S338 to the control unit 799. For example, the sensor 338 senses any one of the coil accommodating units 311 to 314 of the center axis shifting unit 310 at the HP.

The sensor 841 senses predetermined stop positions (home positions HP) of the metal rollers 81, 86, and outputs a position sense signal S841 to the control unit 799.

The sensor 843 senses predetermined stop positions (home positions HP) of the resin rollers 82, 87, and outputs a position sense signal S843 to the control unit 799.

The sensor 845 senses a retreat position of the transfer ASSY, and outputs a position sense signal S845 to the control unit 799. Each of sensors 338, 841, 843, and 845 described above is, for example, a transmissive optical sensor.

The motor 61n is, for example, a stepping motor, and rotates a transfer position on the basis of a driving signal S61n from the control unit 799. For example, the main body 61d of the paper stack transferring mechanism 60 shown in FIG. 37A rotates on the shaft 61h to head for the binding mechanism 40 shown in FIG. 58.

The sensor 799i is, for example, a transmissive optical sensor, senses the home position of the pickup 61c shown in FIG. 37A, and outputs a sense signal S799i to the control unit 799.

The motor 61a is, for example, a stepping motor, and advances or retreat the pickup 61c shown in FIG. 37A from the home position on the basis of a driving signal S61a from the control unit 799. For example, the pickup 61c of FIG. 37A holds the helical coil 11d side of the paper stack 3 at uppermost position P7 and then retreats from uppermost position P7 to move up to lowermost position P8.

The HP sensor 799j for paper-sheet alignment #1 is, for example, a transmissive optical sensor, senses the home position of plate 61k shown in FIG. 37A, and outputs a sense signal S799j to the control unit 799.

The HP sensor 799k for paper-sheet alignment #2 senses the home position of plate 61m shown in FIG. 37A, and outputs a sense signal S799k to the control unit 799.

The motor 61i for booklet alignment #1 slides plate 61m of FIG. 37A in response to a driving signal S61i. The motor 61j for booklet alignment #2 slides plate 61k of FIG. 37A in response to a driving signal S61j. They constitute the control system of the coil forming mechanism 20, the binding mechanism 40, and the paper stack transferring mechanism 60.

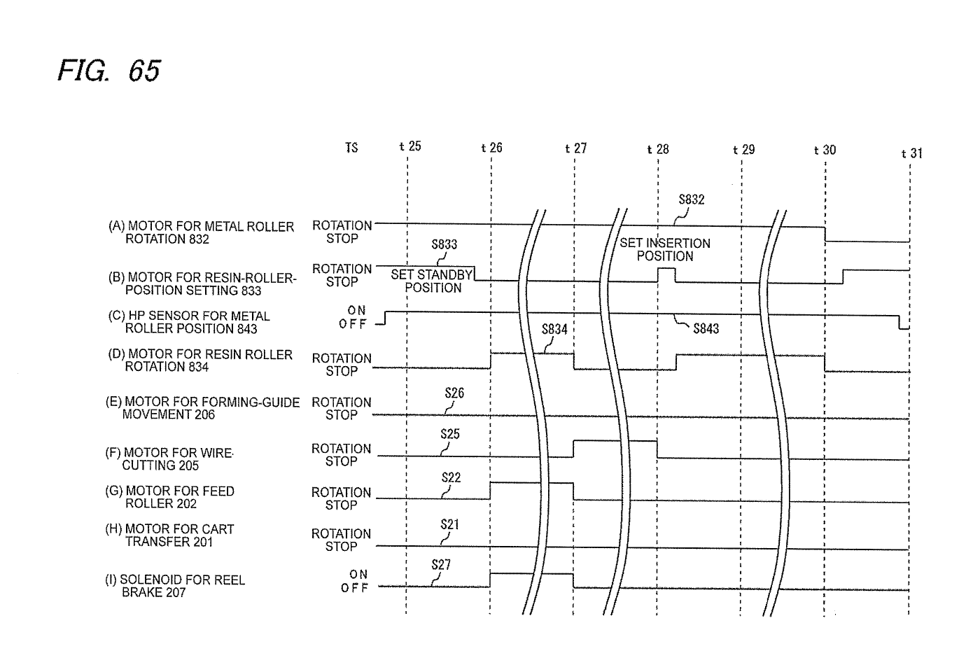

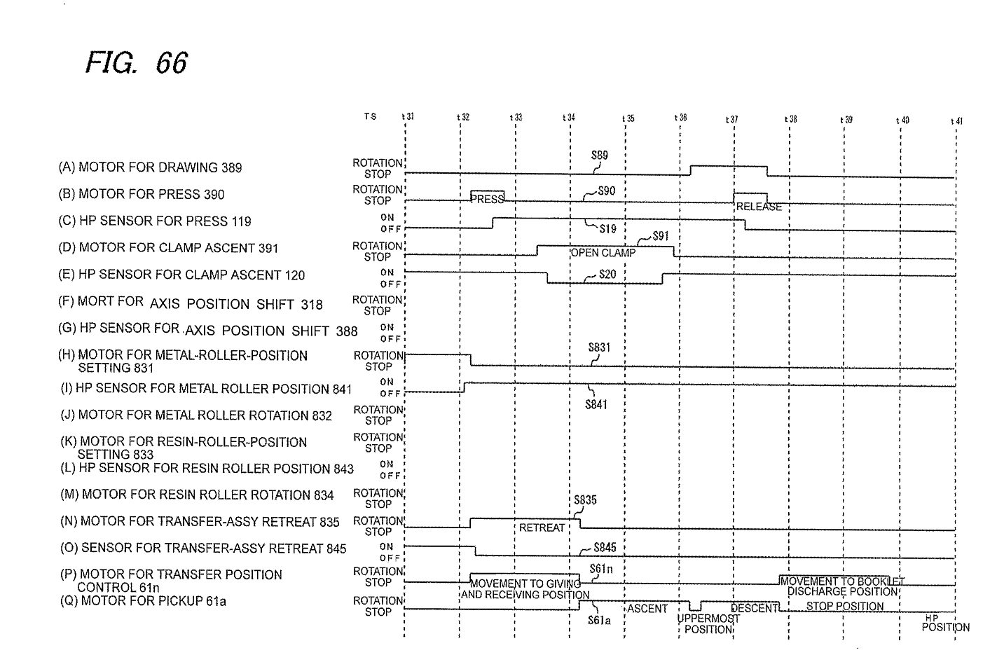

Subsequently, an example of an operation of the coil forming mechanism 20, the binding mechanism 40, and the paper stack transferring mechanism 60 will be described with reference to FIGS. 65 and 66. In this example, a case of forming a helical coil by drawing the wire 1 out of the drum 12, inserting the helical coil into punch holes 3a of the paper stack 3, separating the helical coil from the wire 1, and inserting the helical coil having both ends to be processed into punch holes 3a of the paper stack 3 is exemplified.

Using them as a binding condition, in the binding mechanism 40, the control unit 799 shown in FIG. 64 transmits high-level driving signal S832 shown in (A) of FIG. 65 to the motor 832 after the timing t25. The motor 832 rotates the metal roller 86 on the basis of driving signal S832.

Further, the control unit 799 transmits high-level driving signal S833 shown in (B) of FIG. 65 to the motor 833 from the timing t25 until before the timing t26. The motor 833 sets the resin rollers 82, 87 to standby positions.

Thereafter, the control unit 799 outputs a high-level driving signal S833 to the motor 833 at the timing t28. The motor 833 sets the resin rollers 82, 87 to the coil insertion operation positions on the basis of driving signal S833.

Then, the control unit 799 outputs a high-level driving signal S833 to the motor 833 after the timing t30. The motor 833 escapes the resin rollers 82, 87 from the coil insertion operation positions on the basis of driving signal S833.

The sensor 843 senses the positions of the resin rollers 82, 87 from before the timing t25 until the timing t31, and outputs high-level position sense signal S843 shown in (C) of FIG. 65 to the control unit 799.

Further, the control unit 799 transmits high-level driving signal S834 shown in (D) of FIG. 65 to the motor 834 at the timing t26. The motor 834 rotates the resin roller 87 on the basis of driving signal S834. Thereafter, the control unit 799 changes driving signal S834 shown in (D) of FIG. 65 to the low level at the timing t27 to stop the resin roller 87.

Furthermore, the control unit 799 transmits high-level driving signal S834 shown in (D) of FIG. 65 to the motor 834 at the timing t29. The motor 834 rotates the resin roller 87 on the basis of driving signal S834.

In the coil forming mechanism 20 shown in FIG. 4, the motor 206 shown in (E) of FIG. 65 has already completed forming guide movement at the timing t25. The motor 201 shown in (H) of FIG. 65 has also already completed transfer of the fore end portion of the wire 1 into the coil forming mechanism 20. The motors 201 and 206 are in a de-energized state.

The control unit 799 transmits a high-level solenoid driving signal S27 shown in (I) of FIG. 65 to the solenoid 207 for a reel brake from the timing t26 to the timing t27. The solenoid 207 opens the drum 12 of the wire cartridge 10 on the basis of solenoid driving signal S27. This opening enables the wire 1 to be freely drawn out of the drum 12.

Also, the control unit 799 transmits a high-level driving signal S22 shown in (G) of FIG. 65 to the motor 202 from the timing t26 to the timing t27. The motor 202 rotates feed roller 24a on the basis of the driving signal S22. This rotation enables the wire 1 drawn out of the drum 12 to be fed to the coil forming section 28 (see FIG. 4A).

If the helical coil is formed and the drawing thereof is completed, the control unit 799 transmits a high-level driving signal S25 to the motor 205 from the timing t27 to the timing t28. The motor 205 drives the cutter (not shown) on the basis of the driving signal S25, so as to cut the wire 1 and separate the helical coil 11a from the wire 1.

Thereafter, the control unit 799 changes the driving signal S25 to the low level at the timing t28, to stop the motor 205. Further, the control unit 799 changes the driving signal S832 shown in (A) of FIG. 65 to the low level at the timing t30, to stop the metal roller 86. Similarly, the control unit 799 changes the driving signal S834 shown in (D) of FIG. 65 to the low level at the timing t30, to stop the resin roller 87. In this way, the paper stack 3 has the punch holes 3a having the helical coil inserted thereto, the helical coil having both ends to be processed.

Subsequently, an example of an operation of the paper stack aligning unit 36, the binding mechanism 40 (retreat), and the paper stack transferring mechanism 60 will be described with reference to FIG. 66. In this example, a case of transferring and receiving the paper stack 3 having the helical coil having both ends to be processed to and from the end processing unit 70 is exemplified. The binding mechanism 40 retreats from a binding process area. A case where the paper stack transferring mechanism 60 receives from the paper stack aligning unit 36 the paper stack 3 having the helical coil having both ends to be processed is exemplified.

Using them as binding conditions, in the paper stack aligning unit 36, the control unit 799 shown in FIG. 64 transmits a high-level driving signal S89 shown in (A) of FIG. 66 to the motor 389 after the timing t36. The motor 389 rotates in response to the driving signal S89 to rotate the drawing roller. Thereafter, the control unit 799 changes the driving signal S89 shown in (A) of FIG. 66 to the low level before the timing t38, to stop the motor 389.

The control unit 799 transmits a high-level driving signal S90 shown in (B) of FIG. 66 to the motor 390 after the timing t32. The motor 390 rotates in response to the driving signal S90 to rotate the press roller 355. The press roller 355 presses the paper stack 3. Thereafter, the control unit 799 changes the driving signal S90 shown in (B) of FIG. 66 to the low level before the timing t33, to stop the motor 390.

Further, the control unit 799 transmits a high-level driving signal S90 shown in (B) of FIG. 66 to the motor 390 at the timing t37. The motor 390 rotates in response to the driving signal S90 to rotate the roller for press. The roller for press releases the paper stack 3. The control unit 799 changes the driving signal S90 shown in (B) of FIG. 66 to the low level before the timing t38, to stop the motor 390.

The sensor 119 senses the position of the press roller 355 from the timing t33 until almost the timing t37, and outputs a high-level position sense signal S119 shown in (C) of FIG. 66 to the control unit 799.

Also, the control unit 799 transmits a high-level driving signal S91 shown in (D) of FIG. 66 to the motor 391 before the timing t33. The motor 391 rotates in response to the driving signal S91 to drive the clamps 801a, 801b shown in FIG. 3. The clamps 801a, 801b releases the paper stack 3. Thereafter, the control unit 799 changes the driving signal S91 shown in (D) of FIG. 66 before the timing t36 to the low level, to stop the motor 391.

The sensor 120 senses the positions of the clamps from after the timing t33 until before the timing t36, and outputs a low-level position sense signal S120 shown in (E) of FIG. 66 to the control unit 799.

In the coil introducing mechanism 30 shown in FIG. 10, the motor 318 for center-axis-position shift shown in (F) of FIG. 66 completes an operation to select the coil accommodating unit 311 or the like at the timing t31. The HP sensor 847 for center-axis-position shift shown in (G) of FIG. 66 stops a position sensing operation of the coil accommodating unit 311 or the like at the timing t31.

Further, the control unit 799 changes the driving signal S831, which has the high level at the timing t31 and is shown in (H) of FIG. 66, to the low level after the timing t32, stop the motor 831 for setting the positions of the metal rollers.

The sensor 841 changes the position sense signal S841, which has the low level at the timing t31 and is shown in (I) of FIG. 66, to the high level after the timing t32, stop an operation to sensing the positions of the metal rollers 81, 86.

The motor 832 for rotating the metal rollers shown in (J) of FIG. 66, the motor 833 for setting the positions of the resin rollers shown in (K) of FIG. 66, the HP sensor 843 for resin roller position shown in (L) of FIG. 66, and the motor 834 for rotating the resin rollers shown in (M) of FIG. 66 are in an stop state at the timing t31.

Further, the control unit 799 transmits a high-level driving signal S835 shown in (N) of FIG. 66 to the motor 835 after the timing t33. The motor 835 rotates in response to the driving signal S835 to retreat the transfer ASSY shown in FIG. 33A from the binding process area. Thereafter, the control unit 799 changes the driving signal S835 shown in (N) of FIG. 66 to the low level after the timing t34, to stop the motor 835.

The sensor 845 changes a position sense signal S845 shown (O) of FIG. 66 from the high level to the low level after the timing t32, to stop the sensing of the position of the transfer ASSY.

The control unit 799 changes driving signal S61n from the low level to the high level after the timing t32, to rotate the motor 61n. The motor 61n rotates, such that the main body 61d of the paper stack transferring mechanism 60 shown in FIG. 37A rotates on the shaft 61h to move to a position to receive the paper stack 3 from the binding mechanism 40. After the timing t34, driving signal S61n shown in (P) of FIG. 66 changes from the high level to the low level, to stop the motor 61n, such that the main body 61d of the paper stack transferring mechanism 60 shown in FIG. 37A stops at the position to receive the paper stack 3 from the binding mechanism 40.

The control unit 799 changes driving signal S61a shown in (Q) of FIG. 66 from the low level to the high level after the timing t34, to rotate the motor 61a, such that the pickup 61c shown in FIG. 37A ascends from lowermost position P8 up to uppermost position P7. After the ascent, the motor 61a shown in (Q) of FIG. 66 stops after the timing t36, such that the pickup 61c shown in FIG. 37A stands by at uppermost position P7. In this case, the pickup 61c receives the paper stack 3 from the binding mechanism 40.

After the pickup 61c receives the paper stack 3, the motor 61a shown in (Q) of FIG. 66 reversely rotates after the timing t36 to descend the pickup 61c from uppermost position P7 shown in FIG. 37A, and the motor 61a stops after the timing t37 to stop the pickup 61c. In this case, after the timing t38, the control unit 799 rotates the motor 61n shown in (P) of FIG. 66, such that the main body 61d of the paper stack transferring mechanism 60 shown in FIG. 37A rotates on the shaft 61h and moves to an almost horizontal position to discharge the paper stack 3 to the end processing unit 70 after the timing t40. Further, the control unit 799 reversely rotates the motor 61a shown in (Q) of FIG. 66 before the timing t41, such that the pickup 61c shown in FIG. 37A moves from the above-mentioned stop position so as to reach the lowermost position P8 (a home position) until almost the timing t41. The lowermost position P8 is a position to transfer and receive the paper stack 3 with the coil having both ends to be processed to and from the end processing unit 70.

Subsequently, a control system of the end processing unit 70 will be described. FIG. 67 is a block diagram illustrating an example of a configuration of the control system of the end processing unit 70. The control unit 799 shown in FIG. 67 is connected to HP sensors 799a, 799b and motors 741a, 741b. The HP sensor 799a is, for example, a transmissive optical sensor, senses the home positions of the drag holding teeth 741 shown in FIGS. 43A and 43B, and outputs a sense signal S799a to the control unit 799.

Similarly, the HP sensor 799b senses the home positions of the drag holding teeth 751 shown in FIG. 42, and outputs a sense signal S799b to the control unit 799.

The motor 741a is, for example, a stepping motor, and advances or retreats the drag holding teeth 741 shown in FIGS. 43A and 43B from the home positions on the basis of a driving signal S741a from the control unit 799. For example, the motor 741a advances the drag holding teeth 741 to receive the helical coil 11d side of the paper stack 3 from the pickup 61c of the paper stack transferring mechanism 60 shown in FIG. 37A. Thereafter, the motor 741a retreats the drag holding teeth 741, such that the helical coil is brought into contact with coil accommodating member 703 and is positioned, as shown FIG. 42. Similarly, the motor 741b is, for example, a stepping motor, and advances or retreats the drag holding teeth 751 shown in FIG. 43B on the basis of a driving signal S741b from the control unit 799.

Further, the control unit 799 is connected to HP sensors 799c, 799d and motors 773a, 773b. The HP sensor 799c is, for example, a transmissive optical sensor, senses two light shielding members fixed to the shaft 775 of the motor 773a driving one the cutting and bending mechanism 76 shown in FIG. 48, and outputs a first sense signal S799c to the control unit 799. The first sense signal S799c is a signal representing stop of a cutting process of the cutting and bending mechanism 76 shown in FIG. 52.

Similarly, the HP sensor 799d senses two light shielding members fixed to the shaft 775 of the motor 773a driving the other the cutting and bending mechanism 76, and outputs a second sense signal S799d to the control unit 799. The second sense signal S799d is a signal to stop releasing of a coil offcut held by the cutting and bending mechanism 76.

The motors 773a, 773b are, for example, DC motors, and drive the cutting and bending mechanism 76 to cut and bending both end portions of the helical coil on the basis of control signals S773a and S773b from the control unit 799. For example, the motor 773a stops a cutting process or releasing of a coil offcut on the basis of control signal 773a.

Further, the control unit 799 is connected to HP sensors 799e and 799f and motors 757a and 757b. HP sensor 799e is, for example, a transmissive optical sensor, senses the home position of the cutting and bending mechanism 76 of the outlet-side end processing unit 71 shown in FIG. 44, and outputs a sense signal S799e to the control unit 799.

Similarly, HP sensor 799f senses the home position of the cutting and bending mechanism 76 of the inlet-side end processing unit 72 shown in FIG. 44, and outputs a sense signal S799f to the control unit 799.

Motors 757a and 757b are, for example, stepping motors, and changes the positions of individual cutting and bending mechanisms 76 from the home positions on the basis of control signals S757a, S757b from the control unit 799. For example, as shown in FIG. 45A, the driving force of motor 757b is transmitted to the planar grooved cam 752 through motor gears 785, spur gears 757, and spur gears 758, and the cutting and bending mechanisms 76 obliquely move with the triangular plates 766 along the inclined holes 763, 764 (see FIG. 44).

Also, the control unit 799 is connected to HP sensors 799g, 799h and motors 710a, 710b. The HP sensor 799g is, for example, a transmissive optical sensor, senses the home position of the outlet-side end processing unit 71 shown in FIG. 42, and outputs a sense signal S799g to the control unit 799.

Similarly, the HP sensor 799h senses the home position of the inlet-side end processing unit 72 shown in FIG. 42, and outputs a sense signal S799h to the control unit 799.

The motors 710a, 710b are, for example, stepping motors, and changes the positions of the outlet-side end processing unit 71 and the inlet-side end processing unit 72 from the home positions on the basis of control signals S710a, S710b from the control unit 799 into the arrow (P1) direction of FIG. 42. Accordingly, it is possible to change the positions of the end portions of the helical coils 11a, 11b, 11c, 11d to be processed according to paper sizes.

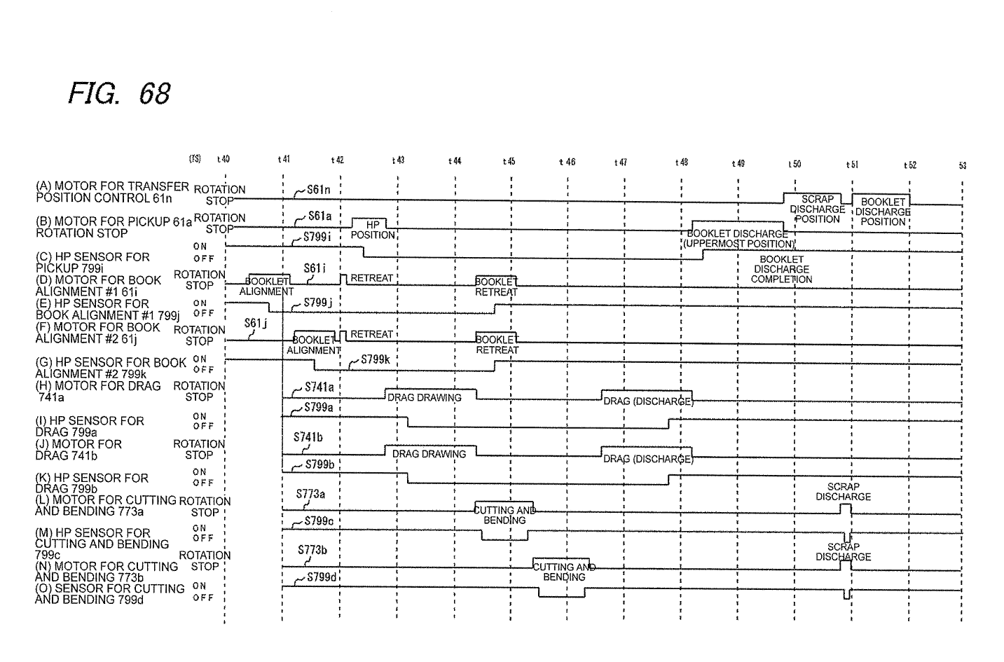

Subsequently, an operation of the end processing unit 70 will be described. FIG. 68 is a timing chart illustrating an example of the operation of the end processing unit 70. In this example, the control unit 799 changes driving signal S61i shown in (D) of FIG. 68 from the low level to the high level after the timing t40, such that the HP the motor 61i for paper-sheet alignment #1 rotates to move plates 61m shown in FIG. 37A in a direction to tuck the paper stack 3. After the timing t41, the control unit 799 changes driving signal S61i shown in (D) of FIG. 68 from the high level to the low level to stop the HP the motor 61i for paper-sheet alignment #1 and stop the movement of the plate 61m shown in FIG. 37A at the same time. Before the timing t41, the HP sensor 799j for paper-sheet alignment #1 shown in (E) of FIG. 68 is in an off state and outputs a low-level sense signal S799j to the control unit 799.

Further, the control unit 799 rotates the HP the motor 61j for paper-sheet alignment #2 shown in (F) of FIG. 68 from after the timing t41 until before the timing t42, to move the plate 61k shown in FIG. 37A in a direction to tuck the paper stack 3. Accordingly, it is possible to align the paper stack 3. Moreover, before the timing t42, the HP sensor 799k for paper-sheet alignment #2 shown in (G) of FIG. 68 is in an off state, and outputs a low-level sense signal S799k to the control unit 799. From the timing t42 until before the timing t43, the control unit 799 reversely rotates the motors 61i, 61j to retreat the plates 61m, 61k from the paper stack 3.

After retreating the plates 61m, 61k from the paper stack 3, the control unit 799 reversely rotates the motor 61a shown in (B) of FIG. 68 from after the timing t42 until before the timing t43, to move the pickup 61c from the stop position up to the lowermost position P8 (home position) shown in FIG. 37A. In this case, the drag units 74, 75 shown in FIG. 44 receive the paper stack 3 from the pickup 61c, such that the helical coil of the paper stack 3 having both ends to be processed is held by drag holding teeth 741, 751. Before the timing t43, the HP sensor 799i for pickup shown in (C) of FIG. 68 is in an off state, and outputs low-level sense signal S799i to the control unit 799.

After the helical coil of the paper stack 3 having both ends to be processed is held by the drag holding teeth 741, 751, the control unit 799 rotates the motors 741a, 741b shown in (H) and (J) of FIG. 68 from before the timing t43 until after the timing t44, to draw the drag holding teeth 741, 751 toward the end processing unit 70. Further, after the timing t43, the HP sensors 799a, 799b for drag shown in (I) and (K) of FIG. 68 are in an off state, and outputs low-level sense signals S799a, S799b to the control unit 799.

After drawing the helical coil toward the end processing unit 70, the control unit 799 rotates the motor 773a shown in (L) of FIG. 68 from after the timing t44 until after the timing t45, such that the outlet-side end processing unit 71 performs a cutting and bending process shown in FIGS. 52 and 53. Before the timing t45, the HP sensor 799c for cutting and bending shown in (M) of FIG. 68 is in an off state, and outputs low-level sense signal S799c to the control unit 799. Further, after the timing t44, the HP sensor 799c for cutting and bending shown in (M) of FIG. 68 is turned on, and outputs high-level sense signal S799c to the control unit 799.

After the process by the outlet-side end processing unit 71, the control unit 799 rotates the motor 773b shown in (N) of FIG. 68 from after the timing t45 until after the timing t46, such that the inlet-side end processing unit 72 performs a cutting and bending process shown in FIGS. 52 and 53. After the timing t45, the HP sensor 799d for cutting and bending shown in (O) of FIG. 68 is turned off, and outputs low-level sense signal S799d to the control unit 799. Further, after the timing t46, the HP sensor 799d for cutting and bending shown in (O) of FIG. 68 is turned on, and outputs high-level sense signal S799d to the control unit 799.

Further, after drawing of the drag holding teeth 741, 751 shown in (H) and (J) of FIG. 68, the control unit 799 reversely rotates the motors 61i, 61j shown in (D) and (F) of FIG. 68 from after the timing t44 until after the timing t45, to move the plates 61m, 61k shown in FIG. 37A to be maximally opened standby state. At the timing t45, the sensors 799j, 799k shown in (E) and (G) of FIG. 68 are in an on state and outputs high-level sense signals S799j, S799k to the control unit 799.

From the timing t43 until after the timing t48, the control unit 799 reversely rotates the motors 741a, 741b shown in (H) and (J) of FIG. 68, such that a booklet 90 with the helical coil having both processed ends is discharged to the paper stack transferring mechanism 60 by the drag holding teeth 741, 751. Before the timing t48, the HP sensors 799a, 799b for drag shown in (I) and (K) of FIG. 68 are turned on and outputs high-level sense signals S799a, S799b to the control unit 799.

From after the timing t48 until before the timing t50, the control unit 799 rotates the motor 61a shown in (B) of FIG. 68, such that the pickup 61c moves from lowermost position P8 to uppermost position P7 shown in FIG. 37A, and the booklet 90 falls by its weight to be discharged. After the timing t48, the HP sensor 799i for pickup shown in (C) of FIG. 68 is turned on, and outputs high-level sense signal S799i to the control unit 799.

After the pickup 61c moves to uppermost position P7, the control unit 799 rotates the motor 61n shown in (A) of FIG. 68 from before the timing t50 until before the timing t51, to rotate the main body 61d of the paper stack transferring mechanism 60 shown in FIG. 37A to an offcut discharge position (inclined direction). After rotating the main body 61d of the paper stack transferring mechanism 60 to the offcut discharge position, the control unit 799 rotates the motors 773a, 773b shown in (L) and (N) of FIG. 68 from before the timing t51 until the timing t51, such that cutting and bending mechanisms 76 return to the standby states shown in FIG. 50A, and at the same time, a helical coil offcut held by the offcut contact unit 794 and the offcut receiving unit 795 is released.

The released helical coil offcut falls into an offcut accommodating container which is provided at lower level to be contact with the main body 61d of the paper stack transferring mechanism 60 set at the offcut discharge position of the inclined direction. Before the timing t51, the HP sensors 799c, 799d for cutting and bending shown in (M) and (O) of FIG. 68 are turned off, and output low-level sense signals S799c, S799d to the control unit 799. Further, at the timing t51, the HP sensors 799c, 799d for cutting and bending shown in (M) and (O) of FIG. 68 are turned on, and output high-level sense signals S799c, S799d to the control unit 799.

After the cutting and bending mechanisms 76 release the helical coil offcuts, the control unit 799 reversely rotates the motor 61n shown in (A) of FIG. 68 from the timing t51 until the timing t52, to rotate the main body 61d of the paper stack transferring mechanism 60 shown in FIG. 37A in almost horizontal state to a booklet discharge position.

The cutting positions of cutting and bending mechanisms 76 shown in FIGS. 45A and 45B and the positions where the end portions of the helical coils 11a, 11b, 11c, 11d are processed by the outlet-side end processing unit 71 and the inlet-side end processing unit 72 shown in FIG. 42 are set at a timing when the coil diameter and the paper size are determined.

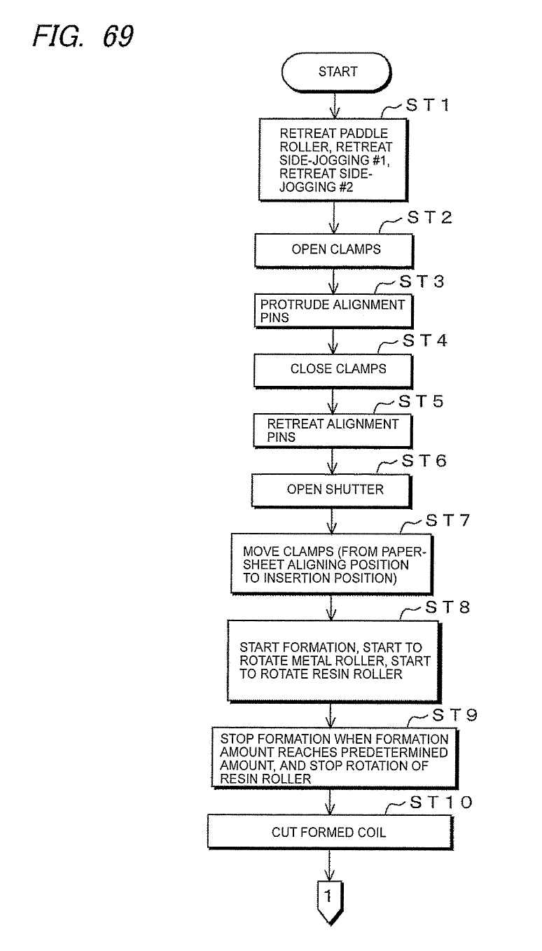

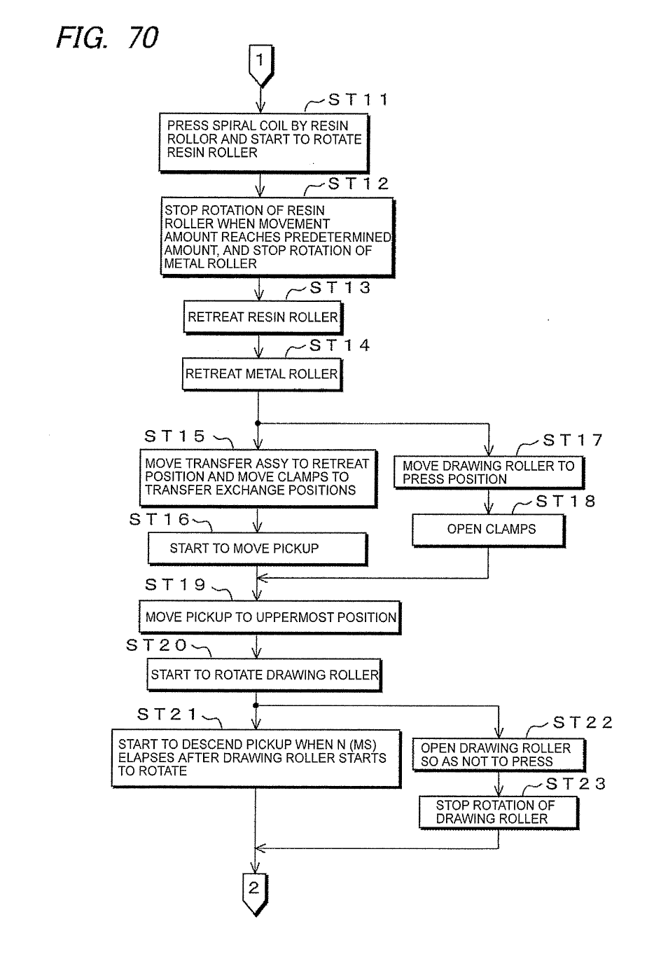

Subsequently, an example of the control in the coil binding apparatus 100 will be described with reference to FIGS. 69 to 71. In this example, the coil diameter is set in advance by selecting any one of four (4) the forming adapters #φ8, #φ12, #φ16, and #φ20 of the forming guide 28a. The pitch formation section 29 forms the pitch of the helical coil drawn out of the coil forming section 28.

In the coil introducing mechanism 30, in correspondence with the coil diameter selected from the forming adapters #φ8, #φ12, #φ16, and #φ20, one the coil accommodating unit 311 or the like is selected from four coil accommodating units 311 to 314 of the center axis shifting unit 310 and is set. In the above-mentioned example, the coil accommodating unit 314 corresponding to the helical coil is automatically set.

Paper sheets 3′ are set on the paper tray 2, and are automatically fed to the paper stack aligning unit 36. In this example, a case where paper sheets 3′ have the A4 size and the forming adapter #φ20 is selected when the super-large-diameter helical coil 11d having the diameter of 20 mm is used for binding the paper stack 3, is exemplified.

Using them as a binding process condition, in step ST1 shown in FIG. 69, the control unit 799 retreats the paddle, side-jogging #1, and side-jogging #2. For example, the sensor 111 senses the fore end of paper sheets 3′ and outputs position sense signal S11 to the control unit 799. The control unit 799 outputs the driving signal S34 to the motor 340 shown in FIG. 59 so as to control the rotations and stop positions of the curl fences 34a, 34b on the basis of position sense signal S11.

The motor 340 drives the left and right curl fences 34a, 34b of the paper curl pressing mechanism 331 shown in FIG. 3. The sensor 112 senses the stop positions of the curl fences 34a, 34b, and outputs position sense signal S12 to the control unit 799. Also, the sensor 113 senses the stop position of the paddle roller 353 at the predetermined height, and outputs position sense signal S13 to the control unit 799.

The control unit 799 transmits the driving signal S81 to the motor 381 so as to control the rotation and the number of times of rotation of the paddle roller 353 on the basis of the position sense signal S13. The motor 381 rotates the paddle roller 353.

In order to perform ascent, descent, and position control of the paddle roller 353, the control unit 799 transmits the driving signal S82 to the motor 382. For example, the control unit 799 rotates the motor 382 clockwise to descend the paddle roller 353, and rotates the motor 382 counterclockwise to ascend the paddle roller 353.

In order to performing position control of side-jogging #1 of the reference side of the side jogger 370, the control unit 799 transmits the driving signal S83 to the motor 383. On the basis of the driving signal S83, the motor 383 sets side-jogging #1 of the reference side of the side jogger 370. For example, the control unit 799 rotates the motor 383 clockwise, to perform a side-jogging operation, and rotates the motor 383 counterclockwise, to perform an opening operation.

Further, in order to perform position control of side-jogging #2 of the movable side of the side jogger 370, the control unit 799 transmits the driving signal S84 to the motor 384. The motor 384 drives side jogging #2 of the movable side of the side jogger 370. In this case, the sensor 114 senses the predetermined stop position of side-jogging #1 of the side jogger 370, and outputs the position sense signal S14 to the control unit 799.

Furthermore, the HP sensor 115 for side-jogging #2 senses the predetermined stop position of side-jogging #2 of the side jogger 370, and outputs the position sense signal S15 to the control unit 799. For example, the control unit 799 rotates the motor 384 clockwise to perform control of movement to a side-jogging reference position, and rotates the motor 384 counterclockwise to perform control of movement to a retreat position.

Next, in step ST2, the control unit 799 opens the clamps 801a, 801b. In this case, in order to perform the driving of the cam for opening and closing the clamps and control of the open positions of the clamps, the control unit 799 transmits the driving signal S85 to the motor 385. On the basis of the driving signal S85, the motor 385 drives the clamps 801a, 801b. For example, the control unit 799 performs rotation control so as to rotate the motor 385 clockwise to open the clamps 801a, 801b.

Next, in step ST3, the control unit 799 obliquely inserts the alignment pins 51 into the punch holes 3a of the paper stack 3. In this case, in order to perform control to protrude and retreat the alignment pins of the alignment pin mechanism 50, the control unit 799 transmits the driving signal S86 to the motor 386. On the basis of the driving signal S86, the motor 386 drives the alignment pins 51 of the alignment pin mechanism 50. For example, the control unit 799 performs rotation control so as to rotate the motor 386 clockwise to protrude the alignment pins 51.

Next, in step ST4, the control unit 799 closes the clamps 801a, 801b. In this case, the control unit 799 performs rotation control so as to rotate the motor 385 counterclockwise to close the clamps 801a, 801b. The sensor 116 senses the predetermined stop positions of the clamps 801a, 801b, and outputs the position sense signal S16 to the control unit 799.

Subsequently, in step ST5, the control unit 799 pulls the alignment pins 51 out of punch holes 3a of the paper stack 3. In this case, the control unit 799 performs rotation control so as to rotate the motor 386 counterclockwise to retreat the alignment pins 51.

Next, in step ST6, the control unit 799 opens the shutter 383′. In this case, in order to perform control to open and close the shutter 383′, the control unit 799 transmits the driving signal S87 to the motor 387. On the basis of the driving signal S87, the motor 387 drives the shutter 383′.

For example, the control unit 799 performs rotation control so as to rotate the motor 387 clockwise to open the shutter and so as to rotate the motor 387 counterclockwise to close the shutter. The sensor 117 senses the predetermined stop position of the shutter 383′, and outputs the position sense signal S17 to the control unit 799.

Next, in step ST7, the control unit 799 moves the clamps 801a, 801b from paper stack aligning unit 36 to the coil insertion operation positions. In this case, in order to perform control to move the clamps 801a, 801b to the paper-sheet pressing positions and the coil insertion positions, the control unit 799 transmits the driving signal S88 to the motor 388. On the basis of the driving signal S88, the motor 388 moves the clamps 801a, 801b of the clamp moving mechanism 380.

For example, the control unit 799 performs rotation control so as to rotate the motor 388 clockwise to move the clamps 801a, 801b to the coil insertion positions and so as to rotate the motor 388 counterclockwise to move the clamps 801a, 801b to the alignment positions. The sensor 118 senses the predetermined stop position of the clamp moving mechanism 380, and outputs the position sense signal S18 to the control unit 799.

Further, in order to control the rotation and the number of times of rotation of the drawing roller (not shown), the control unit 799 transmits the driving signal S89 to the motor 389. On the basis of the driving signal S89, the motor 389 rotates the drawing roller (not shown). For example, the control unit 799 rotates the motor 389 counterclockwise to control the rotation of the drawing roller.

Furthermore, in order to perform rotation control to ascend the press roller 355, the control unit 799 transmits the driving signal S90 to the motor 390. On the basis of driving signal S90, the motor 390 rotates the press roller 355. In order to control ascent and descent of the press roller 355, the control unit 799 rotates the motor 390 clockwise to descend the press roller 355, and rotates the motor 390 counterclockwise to ascend the press roller 355. The sensor 119 senses the predetermined stop position of the press roller 355, and outputs the position sense signal S19 to the control unit 799.

Also, the control unit 799 transmits the driving signal S91 to the motor 391. On the basis of the driving signal S91, the motor 391 ascends the clamps 801a, 801b. The control unit 799 performs control to open the clamps 801a, 801b when giving and receiving a booklet. The sensor 120 senses the ascent and descent stop positions of the clamp-up motor, and outputs the position sense signal S20 to the control unit 799.

Next, in step ST8, the control unit 799 starts forming the helical coil. In this case, in the coil forming mechanism 20 shown in FIG. 63, the driving signal S22 is transmitted from the control unit 799 to the motor 202. On the basis of the driving signal S22, the motor 202 rotates feed roller 24a. For example, the motor 202 rotates clockwise to send the wire 1 into the coil forming section 28. The coil forming section 28 forms the super-large-diameter helical coil 11d having the diameter of 20 mm.

In this case, in order to perform position setting control on the metal rollers 81, 86, the control unit 799 transmits the driving signal S831 to the motor 831. On the basis of the driving signal S831, the motor 831 sets the positions of the metal rollers 81, 86. The sensor 841 senses the predetermined stop positions of the metal rollers 81, 86, and outputs the position sense signal S841 to the control unit 799.

At the same time, in order to control the vertical positions and movement stop positions of the resin rollers 82, 87, the control unit 799 transmits the driving signal S833 to the motor 833. On the basis of the driving signal S833, the motor 833 sets the positions of the resin rollers 82, 87. For example, the control unit 799 rotates the motor 833 clockwise in correspondence with the coil diameter to perform position control for ascending the resin rollers 82, 87. The sensor 843 senses the predetermined stop positions of the resin rollers 82, 87, and outputs the position sense signal S843 to the control unit 799.

Then, in order to control the rotation and rotation speeds of the metal rollers 81, 86, the control unit 799 transmits the driving signal S832 to the motor 832. On the basis of the driving signal S832, the motor 832 rotates the metal roller 86. In this example, the motor 832 rotates the metal rollers 81, 86 clockwise.

At the same time, in order to control the rotation and rotation speeds of the resin rollers 82, 87, the control unit 799 transmits the driving signal S834 to the motor 834. On the basis of the driving signal S834, the motor 834 rotates the resin roller 87. For example, the motor 834 rotates the resin rollers 82, 87 counterclockwise. Accordingly, the rotation of the resin roller 87 starts at the same time with start of the rotation of the metal roller 86.

Subsequently, in step ST9, the control unit 799 stops formation of the helical coil 11d when the formation amount reaches a predetermined amount. If the paper size is set in advance, the formation amount is set to a coil length inserted into all of punch holes 3a formed on one side of paper sheets 3′. For example, in a case where paper sheets having the A4 size and the super-large-diameter helical coil 11d having the diameter of 20 mm are used, the formation amount of the helical coil 11d is set to a total length of a coil length of a portion to be inserted into the paper stack 3 and coil lengths of portions to be cut and bent at both end portions of the paper stack 3.

In this case, the control unit 799 stops only the rotation of the resin roller 82. At this time, the control unit 799 rotates the motor 833 counterclockwise to perform position control for descending the resin rollers 82, 87. Continuing the rotation of the metal roller 86 is for preventing the groove 804 of the metal roller 86 from resisting the coil forwarding direction when the helical coil 11d loses the formation torque.

Next, in step ST10, the control unit 799 cuts the wire 1 in the vicinity of a wire inlet of the coil forming section 28, to separate the helical coil 11d from the wire 1. Since the wire 1 being entering formation adapter #φ20 is already helical, the wire 1 is cut at a portion on the outside of the forming adapter #φ20.

Further, the coil introducing mechanism 30 may correct the coil pitch by the center axis shifting unit 310, and consistently introduce the helical coil 11d having the aligned coil fore-end portion to the binding mechanism 40. In the coil-fore-end inserting section 80, the metal roller 81 and the resin roller 82 rotates together by the formation torque of the helical coil 11d. Further, the coil-fore-end inserting section 80 transfers and receives the helical coil 11d to and from the coil transferring section 85.

Next, in step ST11, the control unit 799 controls the resin roller 87 to rotate while pressing the helical coil 11d. In this case, the control unit 799 transmits driving signal S834 to the motor 834. On the basis of driving signal S834, the motor 834 rotates the resin roller 87.

Next, in step ST12, the control unit 799 stops the movement of the helical coil 11d when the movement amount reaches a predetermined amount. In this example, the control unit 799 stops the rotations of the metal roller 86 and the resin roller 87 when the fore end portion of the helical coil 11d reaches last punch hole 3a of the paper stack 3 and values of portions to be cut and bent are secured.

Next, in step ST13, the control unit 799 retreats the resin rollers 82, 87. In this case, the control unit 799 transmits driving signal S833 to the motor 833. On the basis of driving signal S833, the motor 833 sets the positions of the resin rollers 82, 87. For example, the control unit 799 rotates the motor 833 counterclockwise so as to control the resin rollers 82, 87 to descend.

Further, in step ST14, the control unit 799 retreats the metal rollers 81, 86. In this case, the control unit 799 transmits driving signal S831 to the motor 831. On the basis of driving signal S831, the motor 831 sets the retreat positions of the metal rollers 81, 86. The control unit 799 rotates the metal rollers 81, 86 clockwise. The rotation of the motor 831 retreats the metal rollers 81, 86.

Next, in step ST15, the control unit 799 moves the transfer ASSY to the retreat position. The clamps 801a, 801b move to transfer exchange positions. In this case, in order to control the rotation movement and stop position of the transfer ASSY for retreat, the control unit 799 transmits driving signal S835 to the motor 835.

On the basis of the driving signal S835, the motor 835 is operable to retreat the transfer ASSY. For example, the motor 835 rotates clockwise to move the transfer ASSY to the coil insertion operation position. The motor 835 rotates counterclockwise to retreat the transfer ASSY from the coil insertion operation position. The sensor 845 senses the retreat position of the transfer ASSY and outputs the position sense signal S845 to the control unit 799.

Next, in step ST16, the control unit 799 starts pickup movement. For example, the control unit 799 drives the motor 61a to advance the pickup 61c shown in FIG. 37A from lowermost position P8.

At the same time, in step ST17, the control unit 799 moves the drawing roller (not shown) to a press position. Then, in step ST18, the control unit 799 releases a clamp member including clamp 801a which is the upper arm of the movable side of the clamp moving mechanism 380 and clamp 801b which is the lower arm of the fixed side of the clamp moving mechanism 380.

Then, in step ST19, the control unit 799 moves the pickup 61c shown in FIG. 37A from lowermost position P8 up to uppermost position P7. Next, in step ST20, the control unit 799 starts to rotate the drawing roller.

In step ST21, the control unit 799 starts to descend the pickup 61c when a predetermine time (ms) elapses after the drawing roller starts to rotate. For example, the pickup 61c shown in FIG. 37A stands by at uppermost position P7, and holds the helical coil 11d side inserted into the paper stack 3 provided from the binding mechanism 40. After holding the helical coil 11d side of the paper stack 3, the pickup 61c retreats from uppermost position P7 up to lowermost position P8. At the same time, in step ST22, the control unit 799 opens the drawing roller and the press roller 355. Then, in step ST23, the control unit 799 stops the rotation of the drawing roller.

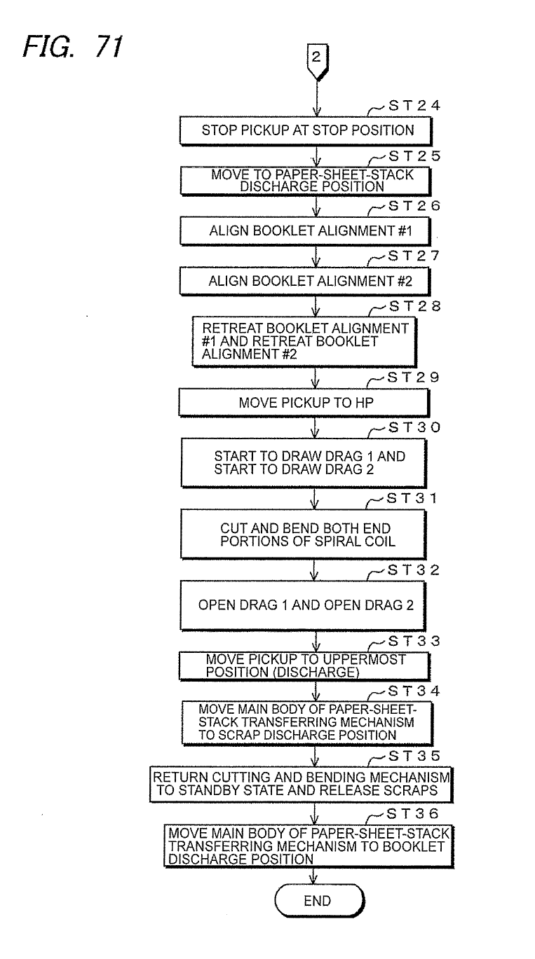

In step ST24 shown in FIG. 71, the control unit 799 stops the motor 61a to stop the pickup 61c in front of lowermost position P8 of FIG. 37A, and proceeds to step ST25.

In step ST25, the control unit 799 moves the paper stack transferring mechanism 60 to the discharge position of the paper stack 3. For example, the control unit 799 drives the motor 61n, such that the main body 61d of the paper stack transferring mechanism 60 shown in FIG. 37A rotates on the shaft 61h to move to the almost horizontal position to discharge the paper stack 3 to the end processing unit 70. Subsequently, the control unit 799 proceeds to step ST26.

In steps ST26 and ST27, the control unit 799 aligns the paper stack 3 transferred by the pickup 61c. For example, the control unit 799 drives first HP the motor 61i for paper-sheet alignment #1 and second HP the motor 61j for paper-sheet alignment #2 to move the plates 61m, 61k shown in FIG. 37A, such that the paper stack 3 is tucked from both sides to be aligned. Subsequently, the control unit 799 proceeds to step ST28.

In step ST28, the control unit 799 drives motors 61i and 61j to retreat plate 61m and plate 61k from the paper stack 3. Then, the control unit 799 proceeds to step ST29.

In step ST29, the control unit 799 moves the pickup 61c, having stopped in front of lowermost position P8 of FIG. 37A in step ST24 described above, up to the lowermost position P8 (a home position). Subsequently, the control unit 799 proceeds to step ST30.

In step ST30, the control unit 799 drives motors 741a, 741b, such that the drag units 74, 75 shown in FIGS. 43A and 43B receive the paper stack 3 from the pickup 61c, and hold and draw the helical coil 11d of the paper stack 3 toward the end processing unit 70 by the drag holding teeth 741, 751. Subsequently, the control unit 799 proceeds to step ST31.

In step ST31, the control unit 799 drives motors 773a, 773b to perform the cutting and bending process on both ends of the helical coil 11d by the outlet-side end processing unit 71 and the inlet-side end processing unit 72, as shown in FIGS. 54 and 55, and proceeds to step ST32.

In step ST32, the control unit 799 drives motors 741a, 741b, such that the paper stack 3 with the helical coil 11d having both processed ends is discharged to the paper stack transferring mechanism 60 by the drag holding teeth 741, 751, and proceeds to step ST33.

In step ST33, the control unit 799 drives the motor 61a to move the pickup 61c from the lowermost position P8 up to uppermost position P7 shown in FIG. 37A, such that the paper stack 3 falls by its weight to be discharged. Subsequently, the control unit 799 proceeds to step ST34.

In step ST34, the control unit 799 drives the motor 61n to rotate the main body 61d of the paper stack transferring mechanism 60 shown in FIG. 37A to the offcut discharge position (an inclined direction), and proceeds to step ST35.

In step ST35, the control unit 799 drives motors 773a, 773b to return cutting and bending mechanisms 76 to the standby states shown in FIG. 50A and releases the offcuts of the helical coil 11d held by the offcut contact unit 794 and the offcut receiving unit 795 at the same time. The released offcuts of the helical coil 11d fall and are accommodated into the offcut accommodating container which is provided at lower level to be contact with the main body 61d of the paper stack transferring mechanism 60 set at the offcut discharge position of the inclined direction. Subsequently, the control unit 799 proceeds to step ST36.

In step ST36, the control unit 799 drives the motor 61n to rotate the main body 61d of the paper stack transferring mechanism 60 shown in FIG. 37A to the booklet discharge position. Accordingly, the process in which the coil binding apparatus 100 makes booklet 90 by inserting the helical coil into punch holes 3a of the paper stack 3 finishes.

The present disclosure is suitable to be applied to a paper-sheet processing apparatus, a stand-alone apparatus, and the like for forming a helical coil from a wire and binding a paper stack output from a copy machine, a printer, or the like with the coil.

What is claimed is:

1. A coil binding apparatus comprising:
a coil forming mechanism configured to form a helical coil in different diameters from a wire;
a binding mechanism configured to bind a punched portion of a paper stack with the helical coil drawn out of the coil forming mechanism; and
a coil introducing mechanism disposed between the coil forming mechanism and the binding mechanism to receive the helical coil drawn out of the coil forming mechanism and to introduce the helical coil to the binding mechanism,
wherein the coil introducing mechanism comprises a center axis shifting unit configured to shift a coil center axis position to a coil rotation axis position,
the coil center axis position is a position of a center axis of the helical coil drawn out of the coil forming mechanism, and
the coil rotation axis position is a position of a rotation axis of the helical coil when the binding mechanism rotates the helical coil to insert the helical coil into the paper stack.

2. The coil binding apparatus according to claim 1, wherein the coil introducing mechanism comprises:
a plurality of coil receivers extending along a coil forwarding direction in which the helical coil is received from the coil forming mechanism and introduced to the binding mechanism; and
a rotary base to which the plurality of coil receivers are mounted,
wherein each of the coil receivers has a size corresponding to an associated one of the diameters, and
wherein the rotary base rotates to select one of the coil receivers in accordance with the diameter of the helical coil formed by the coil forming mechanism.

3. The coil binding apparatus according to claim 2, wherein a center position of each of the coil receivers coincides with the coil rotation axis position when introducing the helical coil of the associated one of the diameters to the binding mechanism.

4. The coil binding apparatus according to claim 2, wherein each of the coil receivers comprises a tapered section along which the helical coil of the associated one of the diameters is received.

5. The coil binding apparatus according to claim 2, wherein each of the coil receivers comprises a tubular body configured to accommodate the helical coil of the associated one of the diameters inside the tubular body.

6. The coil binding apparatus according to claim 5, wherein an inner surface of the tubular body is formed with a plurality of grooves arranged along the coil forwarding direction, each of the grooves being inclined with respect to the coil forwarding direction.

7. The coil binding apparatus according to claim 6, wherein a width of one of the grooves is narrower than a width of an adjacent one of the grooves, wherein the one of the grooves is arranged downstream of the adjacent one of the grooves in the coil forwarding direction.

8. The coil binding apparatus according to claim 2, wherein each of the coil receivers comprises a rod-shaped member on which the helical coil of the associated one of the diameters is fitted.

9. The coil binding apparatus according to claim 8, wherein the rotary base comprises a guide surface arranged downstream of the rod-shaped member in the coil forwarding direction, wherein the guide surface causes the helical coil to contact the guide surface such that the helical coil is sent out from an outlet position on the rotary base.
